(19) United States
(12) Patent Application Publication
(10) Pub. No.: US 2024/0334538 A1
(43) Pub. Date: Oct. 3, 2024

(54) Network Energy Saving for Wireless Communications Management

(71) Applicant: Comcast Cable Communications, LLC, Philadelphia, PA (US)

(72) Inventors: Hua Zhou, Vienna, VA (US); Ali Cagatay Cirik, Chantilly, VA (US); Esmael Hejazi Dinan, McLean, VA (US); Gautham Prasad, Herndon, VA (US); Hyoungsuk Jeon, Centreville, VA (US); Kyungmin Park, Vienna, VA (US); Taehun Kim, Fairfax, VA (US)

(21) Appl. No.: 18/621,363

(22) Filed: Mar. 29, 2024

Related U.S. Application Data
(60) Provisional application No. 63/455,864, filed on Mar. 30, 2023.

(51) Int. Cl. H04W 76/28; H04W 72/21

(52) U.S. Cl. CPC H04W 76/28; H04W 72/21

(57) ABSTRACT

Wireless devices may communicate with a base station via cells. A wireless device may notify the base station whether the wireless device supports a power saving operation. The wireless device, based on the notification, may be enabled or activated for the power saving operation.

### CROSS-REFERENCE TO RELATED APPLICATIONS

This application claims the benefit of U.S. Provisional Application No. 63/455,864 filed on Mar. 30, 2023. The above referenced application is hereby incorporated by reference in its entirety.

### BACKGROUND

Wireless devices communicate with a base station via cells. The base station configures a wireless devices for various modes of operation.

### SUMMARY

The following summary presents a simplified summary of certain features. The summary is not an extensive overview and is not intended to identify key or critical elements.

Wireless device capability, such as for one or more power saving operation(s), may be indicated in one or more parameters. For example, a first parameter may indicate whether a wireless device supports a cell discontinuous transmission configuration by radio resource messaging, a second parameter may indicate whether the wireless device supports an activation of cell discontinuous transmission by downlink control information, and/or any other parameter may indicate whether the wireless device supports any other configuration associated with power saving. Based on the indicated wireless device capability, the wireless device may be configured and/or activated for one or more power saving operations.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1A and FIG. 1B show example communication networks.

FIG. 2A shows an example user plane.

FIG. 2B shows an example control plane configuration.

FIG. 3 shows example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein.

FIG. 16A, FIG. 16B, FIG. 16C, and FIG. 16D show examples of uplink and downlink signal transmission.

FIG. 17A, FIG. 17B, and FIG. 17C show example MAC subheaders.

FIG. 18A and FIG. 18B show example MAC PDUs.

FIG. 19 shows example logical channel identifier (LCID) values.

FIG. 20 shows example LCID values.

FIG. 21A and FIG. 21B show example secondary cell (SCell) Activation/Deactivation MAC control elements (CEs).

FIG. 22 shows an example of BWP activation/deactivation.

FIG. 23 shows examples of various downlink control information (DCI) formats.

FIG. 24A shows an example master information block (MIB) message.

FIG. 24B shows an example configuration of a CORESET.

FIG. 24C shows an example of configuration of a search space.

FIG. 25 shows an example of a system information block (SIB).

FIG. 26 shows example RRC configuration parameters.

FIG. 27 shows an example configuration of a search space.

FIG. 28 shows an example of synchronization signal block (SSB) configurations.

FIG. 29 shows an example of SSB transmissions of a base station.

FIG. 30 shows an example of discontinuous reception (DRX) operation for a wireless device.

FIG. 31 shows an example of DRX operation for a wireless device.

FIG. 32A and FIG. 32B show examples of power saving operations of a wireless device.

FIG. 33A and FIG. 33B show examples of multiple TRPs configuration.

FIG. 34 shows an example of layer 3 based handover procedure.

FIG. 35 shows an example of radio resource control (RRC) message for layer 3 based handover.

FIG. 36 shows an example of an RRC message for layer 3 based handover.

FIG. 37 shows an example of layer 3 based conditional handover procedure.

FIG. 38 shows an example of an RRC message for layer based conditional handover procedure.

FIG. 39 shows an example of layer 1 or layer 2 based handover.

FIG. 40 shows an example of inter-cell beam management.

FIG. 41 shows an example of a layer 1 or layer 2 triggered mobility with early CSI reporting.

FIG. 42 shows an example RRC message for CSI reporting.

FIG. 43 shows an example RRC message for CSI reporting.

FIG. 44 shows an example RRC message for CSI reporting.

FIG. 45 shows an example of cell discontinuous transmission (C-DTX) operation and user-equipment discontinuous reception (U-DRX) operation.

FIG. 46 shows an example of C-DTX and U-DRX configurations.

FIG. 47 shows an example of C-DTX and U-DRX configurations.

FIG. 48 shows an example of C-DTX and U-DRX configurations.

FIG. 49A and FIG. 49B show examples of C-DTX enabling/disabling commands.

FIG. 50 shows example issues of network energy saving with mobility management.

FIG. 51 shows an example of network energy saving with mobility management.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems.

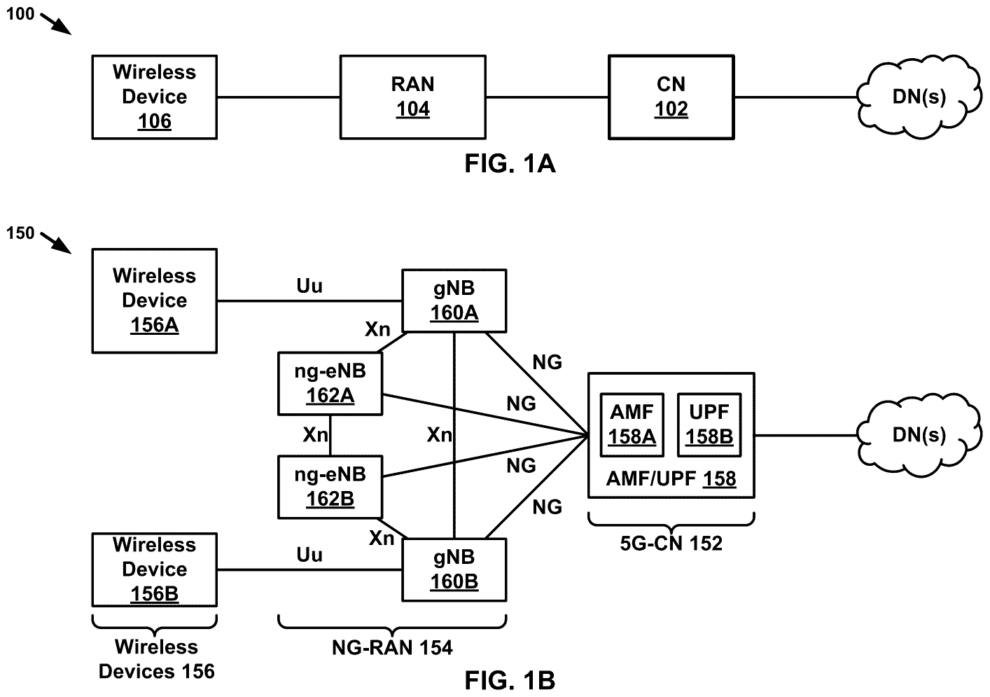

FIG. 1A shows an example communication network 100. The communication network 100 may comprise a mobile communication network. The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with the one or more DNs 108, such as public DNS (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over/via an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IoT) device, a hotspot, a cellular repeater, a vehicle road side unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (eNB), a Generation Node B (base station/gNB), an Next Generation Evolved Node B (ng-eNB), a relay node (e.g., an integrated access and backhaul (IAB) node), a donor node (e.g., a donor eNB, a donor base station/gNB, etc.), an access point (AP) (e.g., a Wi-Fi access point), a transmission and reception point (TRP), a computing device, a device capable of wirelessly communicating, or any other device capable of sending and/or receiving signals. A base station may comprise one or more of the elements listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an eNB (e.g., associated with Evolved-Universal Terrestrial Radio Access (E-UTRA) and/or fourth-generation (4G) standards), a remote radio head (RRH), a baseband processing unit coupled to one or more RRHs, a repeater node or relay node used to extend the coverage area of a donor node, a ng-eNB, a base station/gNB (e.g., associated with New Radio (NR) and/or fifth-generation (5G) standards), an AP (e.g., associated with, for example, Wi-Fi or any other suitable wireless communication standard), any other generation base station, and/or any combination thereof. A base station may comprise one or more devices, such as at least one base station central device (e.g., a base station/gNB Central Unit (gNB-CU)) and at least one base station distributed device (e.g., a base station/gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an AP, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to the one or more DNs 170. The wireless device(s) 156 may communicate with the one or more DNs 170, such as public DNS (e.g., the Internet), private DNs, and/or intra-operator DNs. As part of the interface functionality, the CN 152 (e.g., 5G-CN) may set up end-to-end connections between the wireless device(s) 156 and the one or more DNs 170, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G-CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between the RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QOS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs 170, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode UE reachability for control and execution of paging retransmission), registration area management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., base stations/gNBs comprising a base station/gNB 160A and a base station/gNB 160B (collectively base stations/gNBs 160)) and/or one or more second-type base stations (e.g., ng-eNBs comprising an ng-eNB 162A and an ng-eNB 162B (collectively ng-eNBs 162)). The RAN 154 may comprise one or more of any quantity of types of base station. The base stations/gNBs 160 and/or ng-eNBs 162 may be referred to as base stations. The base stations (e.g., the gNBs 160 and/or ng-eNBs 162) may comprise one or more sets of antennas for communicating with the wireless device(s) 156 wirelessly (e.g., an over an air interface). One or more base stations (e.g., the gNBs 160 and/or the ng-eNBs 162) may comprise multiple sets of antennas to respectively control multiple cells (or sectors). The cells of the base stations (e.g., the gNBs 160 and/or the ng-eNBs 162) may provide a radio coverage to the wireless device(s) 156 over a wide geographic area to support wireless device mobility.

The base stations (e.g., the gNBs 160 and/or the ng-eNBs 162) may be connected to the CN 152 (e.g., 5G-CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the gNBs 160 and/or the ng-eNBs 162) may communicate with the wireless device(s) 156 via a third interface (e.g., a Uu interface). A base station (e.g., the gNB 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the gNBs 160 and/or the ng-eNBs 162) may communicate with one or more AMF/UPF devices, such as the AMF/UPF 158, via one or more interfaces (e.g., NG interfaces). A base station (e.g., the gNB 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the gNB 160A) and a UPF device (e.g., the UPF 158B). The base station (e.g., the gNB 160A) may be in communication with, and/or connected to, an AMF device (e.g., the AMF 158A) via an NG-Control plane (NG-C) interface. The NG-C interface may provide/perform, for example, NG interface management, wireless device context management (e.g., UE context management), wireless device mobility management (e.g., UE mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., gNBs 160) may provide user plane and control plane protocol terminations towards the wireless device(s) 156 via the Uu interface. A base station (e.g., the gNB 160A) may provide user plane and control plane protocol terminations toward the wireless device 156A over a Uu interface associated with a first protocol stack. A base station (e.g., the ng-eNBs 162) may provide E-UTRA user plane and control plane protocol terminations towards the wireless device(s) 156 via a Uu interface (e.g., where E-UTRA may refer to the 3GPP 4G radio-access technology). A base station (e.g., the ng-eNB 162B) may provide E-UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more gNBs and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, IoT devices, hotspots, cellular repeaters, computing devices, and/or, more generally, UE. Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise an LTE network, a 5G network, a 6G network, a satellite network, and/or any other network for wireless communications (e.g., any 3GPP network and/or any non-3GPP network). Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network.

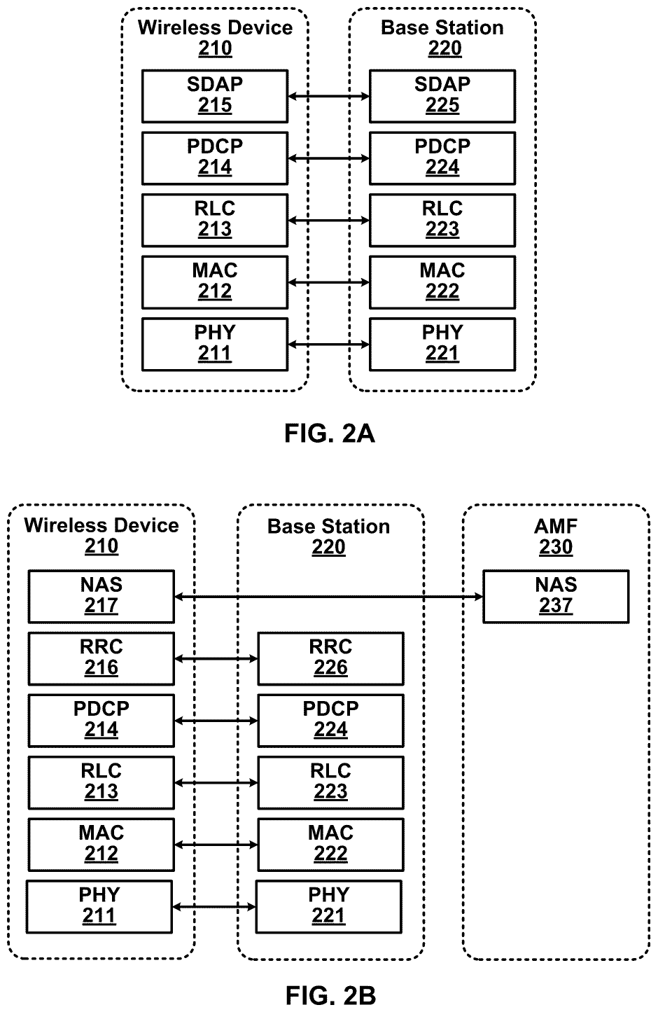

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configurations and/or the control plane configurations may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

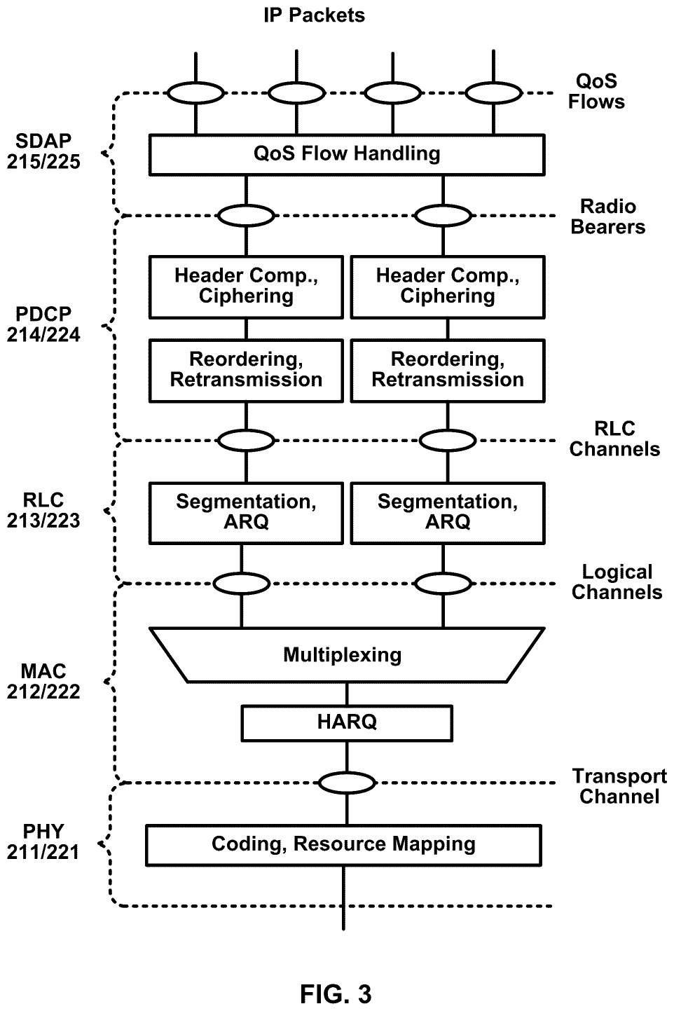

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform QoS flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows 310 of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be transmitted (e.g., sent) over the air interface, ciphering/deciphering to prevent unauthorized decoding of data transmitted (e.g., sent) over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-gNB handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity scenario/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers (e.g., RLCs 213 and 223) may perform one or more of the noted functions, for example, based on the transmission mode the RLC layer (e.g., RLCs 213 and 223) is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels 330 as a service to the PDCP layers (e.g., PDCPs 214 and 224, respectively), such as shown in FIG. 3.

The MAC layers (e.g., MACs 212 and 222) may perform multiplexing/demultiplexing of logical channels 340 and/or mapping between logical channels 340 and transport channels 350. The multiplexing/demultiplexing may comprise multiplexing/demultiplexing of data units/data portions, belonging to the one or more logical channels 340, into/from Transport Blocks (TBs) delivered to/from PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels 340 of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels 350 to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

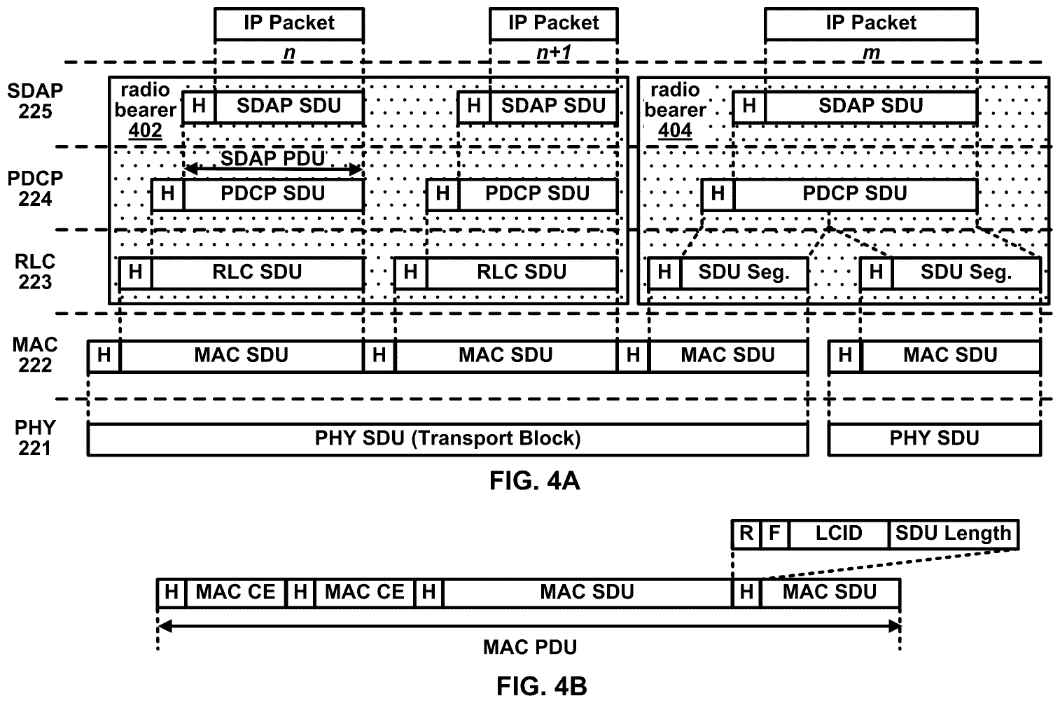

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a number of RLC PDUs (MAC SDUS). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 212 or MAC 222. As shown in FIG. 4B, two MAC CEs may be inserted into/added to the MAC PDU. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

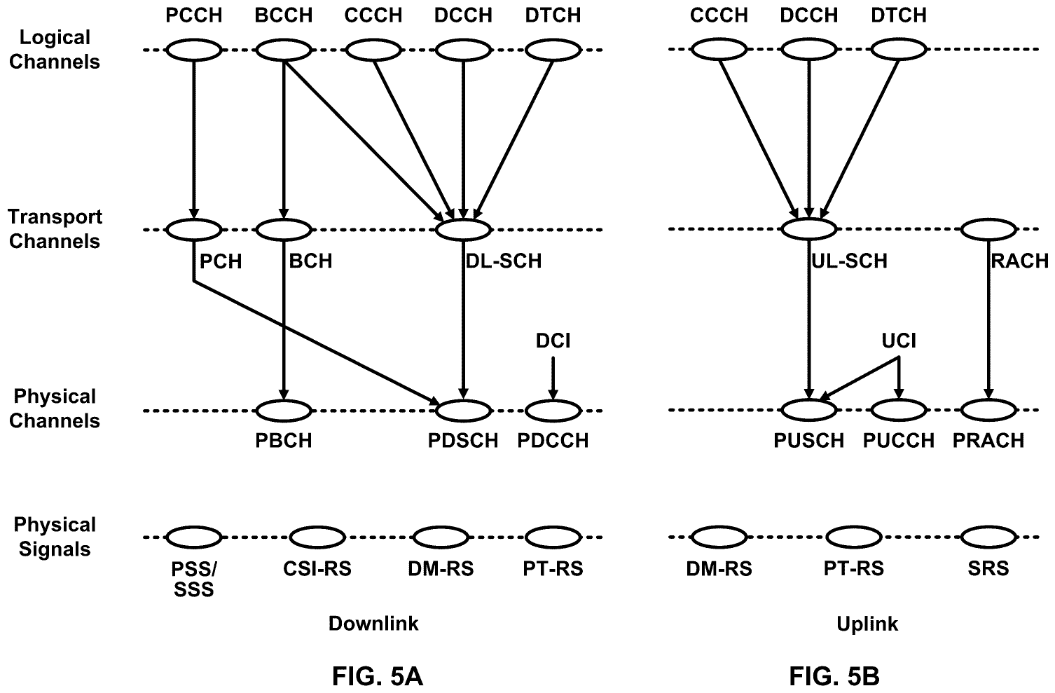

FIG. 5A shows an example mapping for downlink channels. The mapping for downlink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink. Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless devices).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may comprise an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as layer 1 or layer 2 (e.g., L1 or L2, Layer 1/Layer 2, L1/L2, Layer 1 or layer 2, Layer 1 or Layer 2, L1/2, Layer 1/2, layer 1/2, etc.) control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The PHY layer may generate physical signals to support the low-level operation of the PHY layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), SRS, phase-tracking reference signals (PT RS), and/or any other signals.

One or more of the channels (e.g., logical channels, transport channels, physical channels, etc.) may be used to carry out functions associated with the control plane protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHYs 211 and 221, MACs 212 and 222, RLCs 213 and 223, and PDCPs 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane protocol stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and substantially the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QoS management functions; wireless device measurement reporting and control of the reporting; detection of and recovery from radio link failure (RLF); and/or NAS message transfer. As part of establishing an RRC connection, the RRC layers 216 and 226 may establish an RRC context, which may involve configuring parameters for communication between the wireless device 210 and the RAN (e.g., the base station 220).

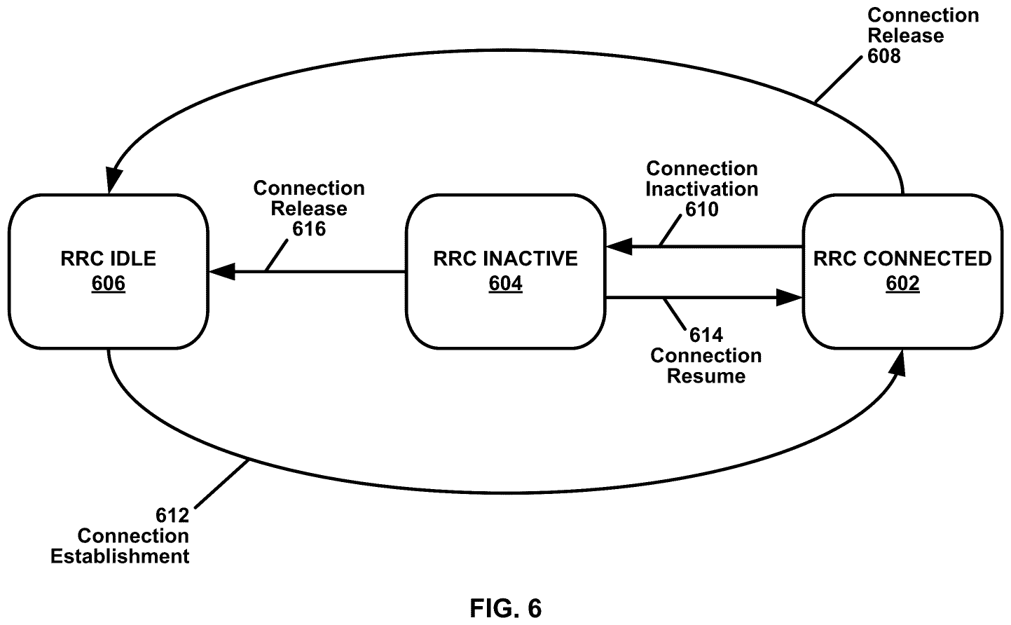

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 606 (e.g., RRC_IDLE), and RRC inactive 604 (e.g., RRC_INACTIVE). The RRC inactive 604 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the base stations/gNBs 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the UE context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by an RAN (e.g., the RAN 104, the RAN 154, or any other RAN). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., the RRC connected 602) to an RRC idle state (e.g., the RRC idle 606) via a connection release procedure 608. The RRC state may transition from the RRC connected state (e.g., the RRC connected 602) to the RRC inactive state (e.g., the RRC inactive 604) via a connection inactivation procedure 610.

An RRC context may not be established for the wireless device. For example, this may be during the RRC idle state. During the RRC idle state (e.g., the RRC idle 606), an RRC context may not be established for the wireless device. During the RRC idle state (e.g., the RRC idle 606), the wireless device may not have an RRC connection with the base station. During the RRC idle state (e.g., the RRC idle 606), the wireless device may be in a sleep state for the majority of the time (e.g., to conserve battery power). The wireless device may wake up periodically (e.g., one time in every DRX cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 606) to the RRC connected state (e.g., the RRC connected 602) via a connection establishment procedure 612, which may involve a random access procedure.

A previously established RRC context may be maintained for the wireless device. For example, this may be during the RRC inactive state. During the RRC inactive state (e.g., the RRC inactive 604), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 606) to the RRC connected state (e.g., the RRC connected 602). During the RRC inactive state (e.g., the RRC inactive 604), the wireless device may be in a sleep state and mobility of the wireless device may be managed/controlled by the wireless device via a cell reselection. The RRC state may transition from the RRC inactive state (e.g., the RRC inactive 604) to the RRC connected state (e.g., the RRC connected 602) via a connection resume procedure 614. The RRC state may transition from the RRC inactive state (e.g., the RRC inactive 604) to the RRC idle state (e.g., the RRC idle 606) via a connection release procedure 616 that may be substantially the same as or similar to connection release procedure 608.

An RRC state may be associated with a mobility management mechanism. During the RRC idle state (e.g., the RRC idle 606) and the RRC inactive state (e.g., the RRC inactive 604), mobility may be managed/controlled by the wireless device via a cell reselection. The purpose of mobility management during the RRC idle state (e.g., the RRC idle 606) or during the RRC inactive state (e.g., the RRC inactive 604) may be to enable/allow the network to be able to notify the wireless device of an event via a paging message without having to broadcast the paging message over the entire mobile communications network. The mobility management mechanism used during the RRC idle state (e.g., the RRC idle 606) or during the RRC inactive state (e.g., the RRC inactive 604) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 606) and the RRC inactive state (e.g., the RRC inactive 604) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the CN 152, or any other CN) may send to the wireless device a list of TAIs associated with a wireless device registration area (e.g., a UE registration area). A wireless device may perform a registration update with the CN to allow the CN to update the location of the wireless device and provide the wireless device with a new the wireless device registration area, for example, if the wireless device moves (e.g., via a cell reselection) to a cell associated with a TAI that may not be included in the list of TAIs associated with the wireless device registration area.

RAN areas may be used to track the wireless device (e.g., the location of the wireless device at the RAN level). For a wireless device in an RRC inactive state (e.g., the RRC inactive 604), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., the RRC inactive 604).

A base station (e.g., the gNBs 160 in FIG. 1B or any other base station) may be split in two parts: a central unit (e.g., a base station central unit, such as a gNB-CU) and one or more distributed units (e.g., a base station distributed unit, such as a gNB-DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM may be a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as if they are in the frequency domain. The F parallel symbol streams may be used as inputs to an Inverse Fast Fourier Transform (IFFT) block that transforms them into the time domain. The IFFT block may take in F source symbols at a time, one from each of the F parallel symbol streams. The IFFT block may use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. An OFDM symbol provided/output by the IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

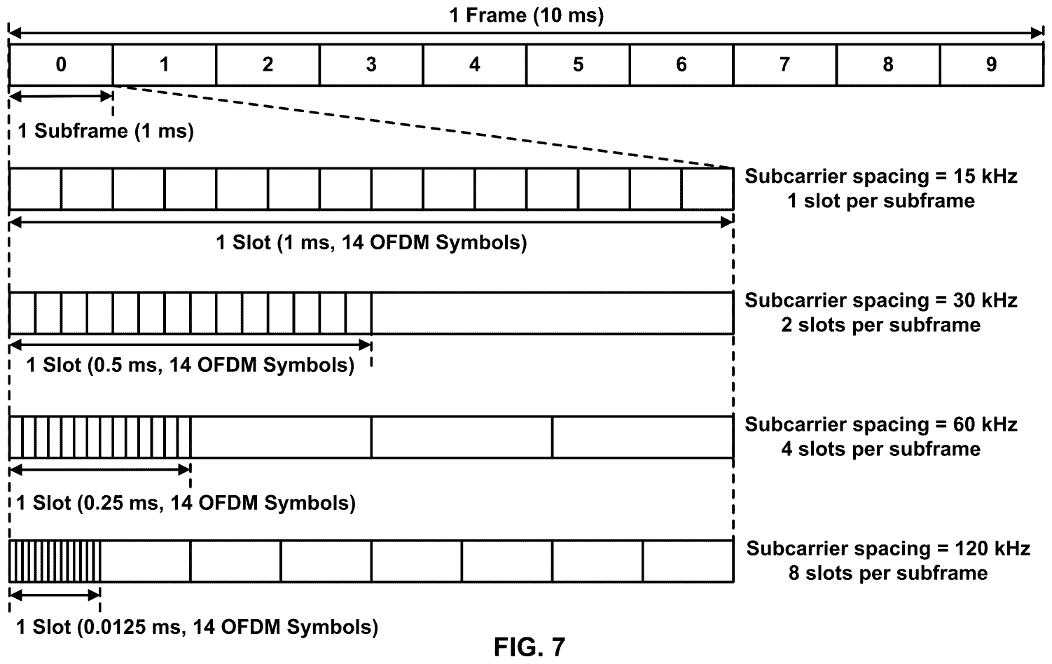

FIG. 7 shows an example configuration of a frame. The frame may comprise, for example, an NR radio frame into which OFDM symbols may be grouped. A frame (e.g., an NR radio frame) may be identified/indicated by a system frame number (SFN) or any other value. The SFN may repeat with a period of 1024 frames. One NR radio frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 kHz/1.2 μs; 120 kHz/0.59 μs; 240 kHz/0.29 μs, and/or any other subcarrier spacing/cyclic prefix duration combinations.

A slot may have a fixed number/quantity of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

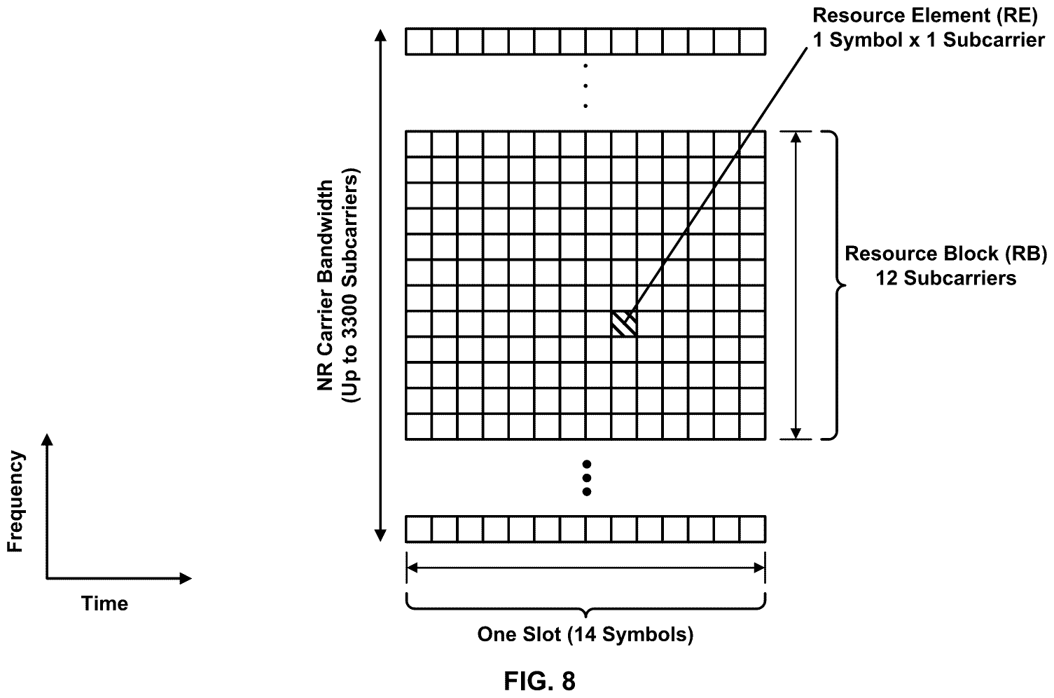

FIG. 8 shows an example resource configuration of one or more carriers. The resource configuration may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), if used, may limit the carrier (e.g., NR carrier) frequency based on subcarrier spacing (e.g., carrier frequency of 50, 100, 200, and 400 MHz for subcarrier spacings of 15, 30, 60, and 120 kHz, respectively). A 400 MHz bandwidth may be set based on a 400 MHz per carrier bandwidth limit. Any other bandwidth may be set based on a per carrier bandwidth limit.

A single numerology may be used across the entire bandwidth of a carrier (e.g., an NR carrier such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a UE-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in DCI. A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, if the wireless device does not detect DCI during a time interval (e.g., 1 ms or 0.5 ms). The wireless device may switch from the active downlink BWP to the default downlink BWP, for example, if the BWP inactivity timer expires.

A base station may semi-statically configure a wireless device with one or more BWPs. A wireless device may switch an active BWP from a first BWP to a second BWP, for example, based on (e.g., after or in response to) receiving DCI indicating the second BWP as an active BWP. A wireless device may switch an active BWP from a first BWP to a second BWP, for example, based on (e.g., after or in response to) an expiry of the BWP inactivity timer (e.g., if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

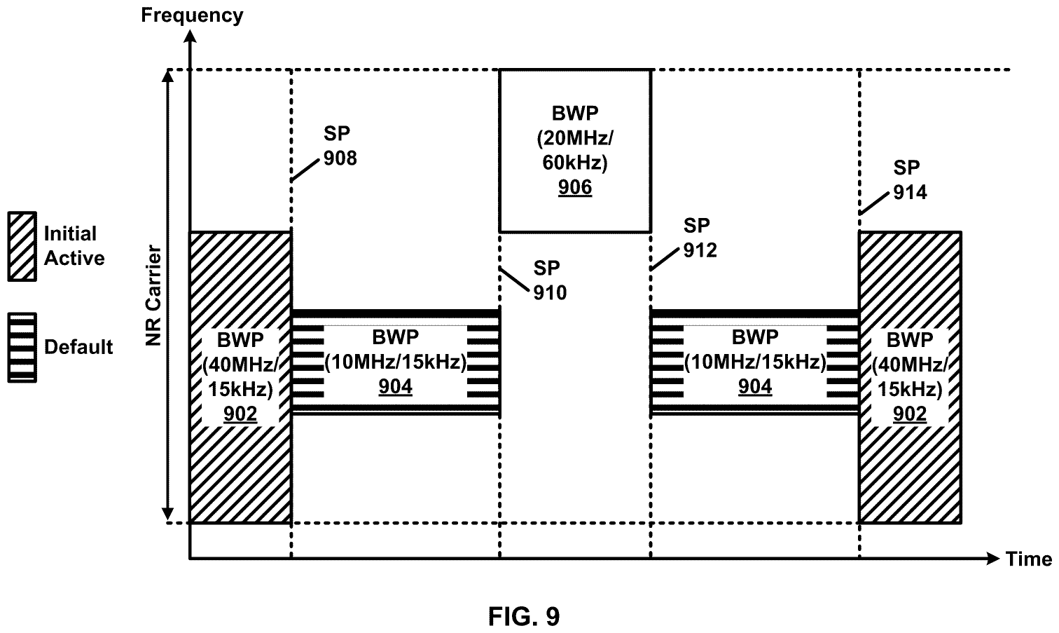

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at the switching point 908 may occur, for example, based on (e.g., after or in response to) an expiry of a BWP inactivity timer (e.g., indicating switching to the default BWP). The switching at the switching point 908 may occur, for example, based on (e.g., after or in response to) receiving DCI indicating the BWP 904 as the active BWP. The wireless device may switch at a switching point 910 from the active BWP (e.g., the BWP 904) to the BWP 906, for example, after or in response receiving DCI indicating the BWP 906 as a new active BWP. The wireless device may switch at a switching point 912 from the active BWP (e.g., the BWP 906) to the BWP 904, for example, a based on (e.g., after or in response to) an expiry of a BWP inactivity timer. The wireless device may switch at the switching point 912 from the active BWP (e.g., the BWP 906) to the BWP 904, for example, after or in response to receiving DCI indicating the BWP 904 as a new active BWP. The wireless device may switch at a switching point 914 from the active BWP (e.g., the BWP 904) to the BWP 902, for example, after or in response receiving DCI indicating the BWP 902 as a new active BWP.

Wireless device procedures for switching BWPs on a secondary cell may be substantially the same/similar as those on a primary cell, for example, if the wireless device is configured for a secondary cell with a default downlink BWP in a set of configured downlink BWPs and a timer value. The wireless device may use the timer value and the default downlink BWP for the secondary cell in substantially the same/similar manner as the wireless device uses the timer value and/or default downlink BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a number/quantity of serving cells for the wireless device (e.g., one serving cell for a CC), for example, if CA is configured/used. The CCs may have multiple configurations in the frequency domain.

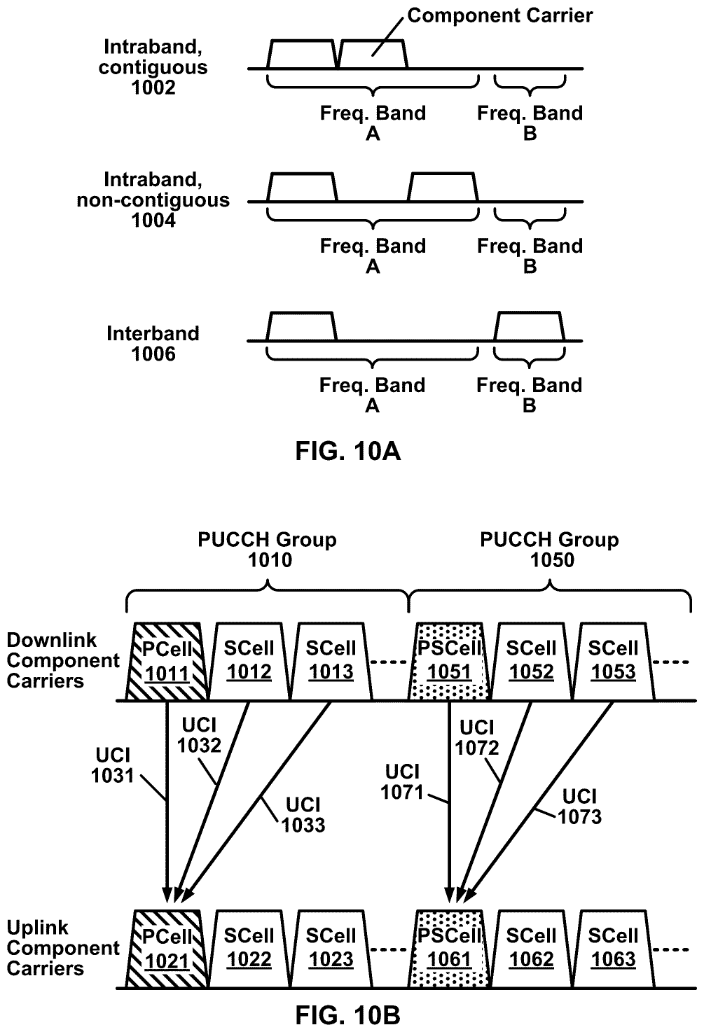

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, if the wireless device has more data traffic in the downlink than in the uplink.

One of the aggregated cells for a wireless device may be referred to as a primary cell (PCell), for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless devices may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, based on (e.g., after or in response to) an expiration of an SCell deactivation timer (e.g., one SCell deactivation timer per SCell may be configured).

DCI may comprise control information for the downlink, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. UCI may comprise control information for the uplink, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, if the aggregated cells shown in FIG. 10B are not divided into the PUCCH group 1010 and the PUCCH group 1050. The PCell 1021 may become overloaded, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may use/apply to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more (RSs) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

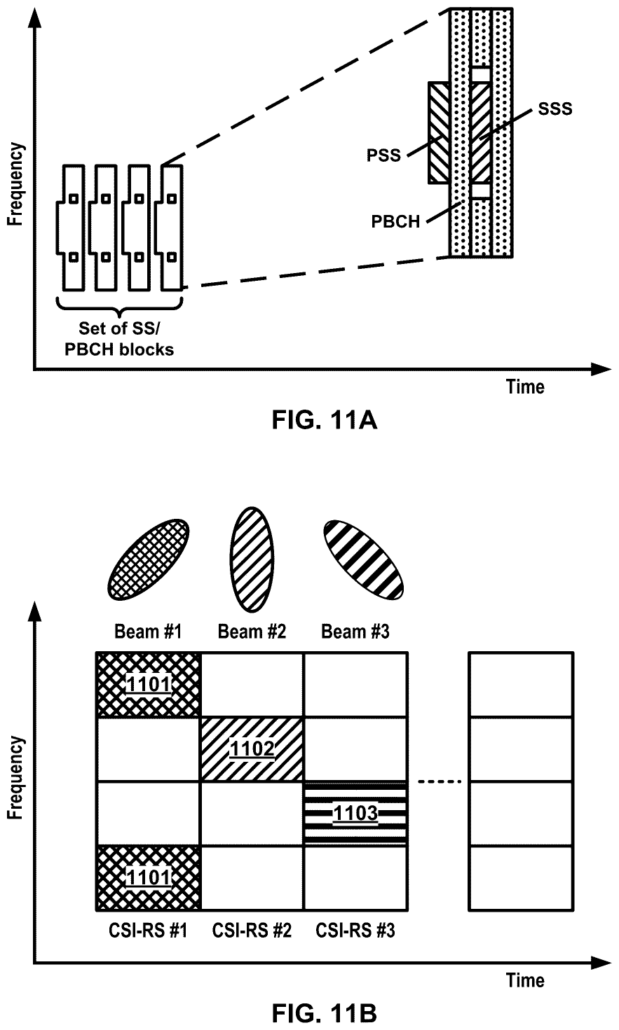

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIB1. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial receiving (Rx) parameters). The wireless device may not assume QCL for SS/PBCH block transmissions having different SS/PBCH block indices. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine CSI. The base station may configure the wireless device with one or more CSI-RSs for channel estimation or any other suitable purpose. The base station may configure a wireless device with one or more of substantially the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a number/quantity (e.g. a maximum number/quantity) of front-loaded DM-RS symbols for a PDSCH. A DM-RS configuration may support one or more DM-RS ports. A DM-RS configuration may support up to eight orthogonal downlink DM-RS ports (or any other quantity of orthogonal downlink DM-RS ports) per wireless device (e.g., for single user-MIMO). A DM-RS configuration may support up to 4 orthogonal downlink DM-RS ports (or any other quantity of orthogonal downlink DM-RS ports) per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be substantially the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across a set of PRBs. The set of PRBs may be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DMRSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI. A dynamic presence of a downlink PT-RS, if configured, may be associated with one or more DCI parameters comprising at least MCS. A network (e.g., an NR network) may support a plurality of PT-RS densities defined in the time and/or frequency domains. A frequency domain density (if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a number/quantity (e.g. the maximum number/quantity) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DMRSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a UE-specific basis), for example, by a combination of RRC signaling and/or one or more parameters configured/employed for other purposes (e.g., MCS), which may be indicated by DCI. A dynamic presence of an uplink PT-RS, if configured, may be associated with one or more DCI parameters comprising at least MCS. A radio network may support a plurality of uplink PT-RS densities defined in time/frequency domain. A frequency domain density (if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in a SRS resource set of the one or more SRS resource sets (e.g., with substantially the same/similar time domain behavior, periodic, aperiodic, and/or the like) may be sent/transmitted at a time instant (e.g., simultaneously), for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS if a PUSCH and an SRS are sent/transmitted in a same slot. A base station may semi-statically configure a wireless device with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, if the first symbol and the second symbol are sent/transmitted on the same antenna port. A first antenna port and a second antenna port may be referred to as QCLed, for example, if one or more large-scale properties of the channel over which a first symbol on the first antenna port is conveyed may be inferred/determined from the channel over which a second symbol on a second antenna port is conveyed. The one or more large-scale properties may comprise at least one of: a delay spread; a Doppler spread; a Doppler shift; an average gain; an average delay; and/or spatial Rx parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 11B may correspond to a RB within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a number of CSI-RS ports, a CSI-RS configuration (e.g., symbol and RE locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, QCL parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams may be shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure a reference signal received power (RSRP) of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication (TCI) states comprising a number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, if the wireless device has the capability of beam correspondence. The wireless device may perform an uplink beam selection procedure to determine the spatial domain filter of the Tx beam, for example, if the wireless device does not have the capability of beam correspondence. The wireless device may perform the uplink beam selection procedure, for example, based on one or more SRS resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a PMI, a CQI, and/or a RI.

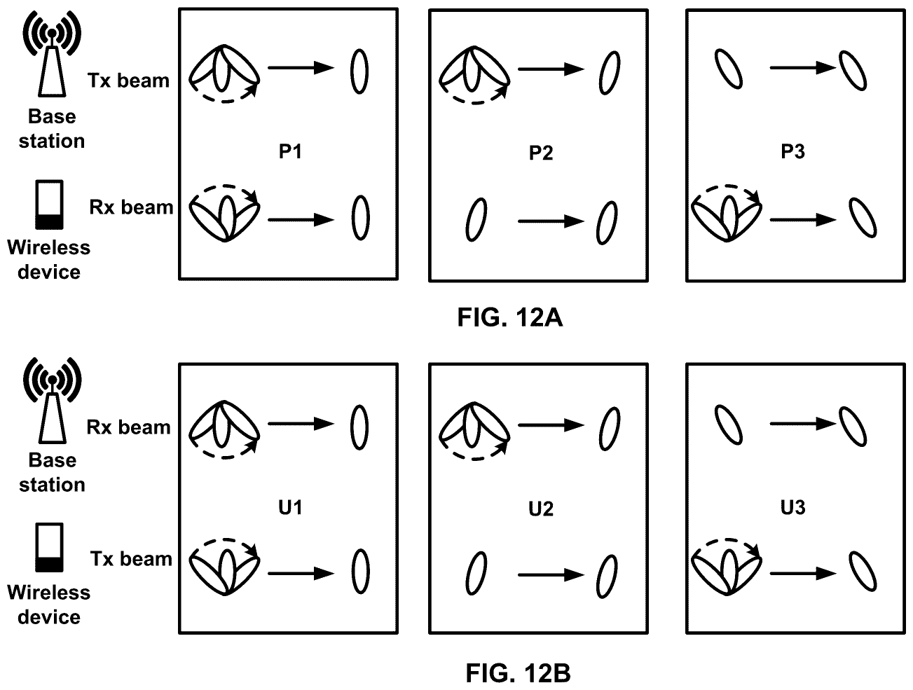

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station and the Rx beams of a wireless device are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station to perform a measurement on Tx beams of a wireless device (e.g., to support a selection of one or more Tx beams of the wireless device and/or Rx beams of the base station). The Tx beams of the wireless device and the Rx beams of the base station are shown as ovals in the bottom row of U1 and top row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, if the wireless device (e.g., UE) uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more RSs comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, if the channel characteristics (e.g., Doppler shift, Doppler spread, an average delay, delay spread, a spatial Rx parameter, fading, and/or the like) from a transmission via the RS resource to the wireless device are substantially the same or similar as the channel characteristics from a transmission via the channel to the wireless device.

A network (e.g., an NR network comprising a base station/gNB and/or an ng-eNB) and/or the wireless device may initiate/start/perform a random access procedure. A wireless device in an RRC idle (e.g., an RRC_IDLE) state and/or an RRC inactive (e.g., an RRC_INACTIVE) state may initiate/perform the random access procedure to request a connection setup to a network. The wireless device may initiate/start/perform the random access procedure from an RRC connected (e.g., an RRC_CONNECTED) state. The wireless device may initiate/start/perform the random access procedure to request uplink resources (e.g., for uplink transmission of an SR if there is no PUCCH resource available) and/or acquire/obtain/determine an uplink timing (e.g., if an uplink synchronization status is non-synchronized). The wireless device may initiate/start/perform the random access procedure to request one or more SIBs (e.g., or any other system information blocks, such as SIB2, SIB3, and/or the like). The wireless device may initiate/start/perform the random access procedure for a beam failure recovery request. A network may initiate/start/perform a random access procedure, for example, for a handover and/or for establishing time alignment for an SCell addition.

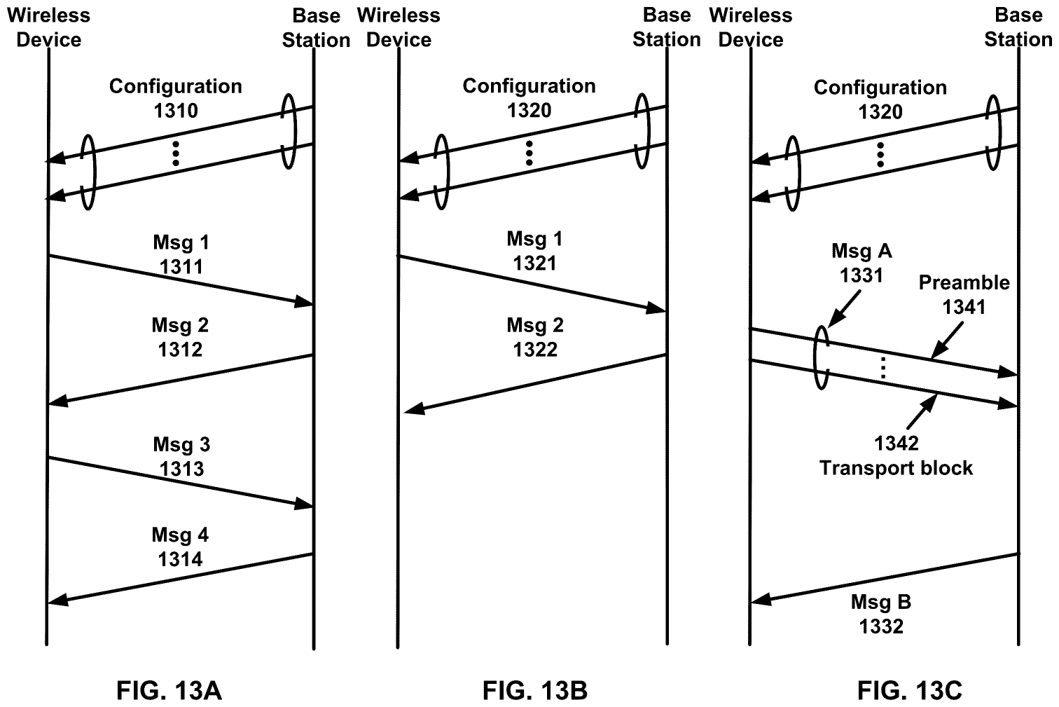

FIG. 13A shows an example four-step random access procedure. The four-step random access procedure may comprise a four-step contention-based random access procedure. A base station may send/transmit a configuration message 1310 to a wireless device, for example, before initiating the random access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random access preamble). The first message (e.g., Msg 1 1311) may be referred to as a preamble. The second message (e.g., Msg 2 1312) may comprise as a random access response (RAR). The second message (e.g., Msg 2 1312) may be referred to as an RAR.

The configuration message 1310 may be sent/transmitted, for example, using one or more RRC messages. The one or more RRC messages may indicate one or more RACH parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-configDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more PRACH occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate at least one of: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, if no response is received based on (e.g., after or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random access procedure has been completed unsuccessfully, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, based on (e.g., after or in response to) the sending/transmitting of the first message (e.g., Msg 1 1311). The second message (e.g., Msg 2 1312) may be scheduled on the DL-SCH and may be indicated by a PDCCH, for example, using a random access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-Response Window) to monitor a PDCCH for the second message (e.g., Msg 2 1312), for example, after sending/transmitting the first message (e.g., Msg 1 1311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Type1-PDCCH common search space) configured by an RRC message. The wireless device may identify/determine the RAR, for example, based on an RNTI. RNTIs may be used depending on one or more events initiating/starting the random access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:

$$RA - RNTI = 1 + s\_id + 14 \times t\_id + 14 \times 80 \times f\_id + 14 \times 80 \times 8 \times ul\_carrier \_id ,$$

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, based on (e.g., after or in response to) a successful reception of the second message (e.g., Msg 2 1312) (e.g., using resources identified in the Msg 2 1312). The third message (e.g., Msg 3 1313) may be used, for example, for contention resolution in the contention-based random access procedure. A plurality of wireless devices may send/transmit the same preamble to a base station, and the base station may send/transmit an RAR that corresponds to a wireless device. Collisions may occur, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another wireless device. The wireless device may comprise a device identifier in the third message (e.g., Msg 3 1313) (e.g., a C-RNTI if assigned, a TC RNTI comprised in the second message (e.g., Msg 2 1312), and/or any other suitable identifier), for example, to perform contention resolution.

The fourth message (e.g., Msg 4 1314) may be received, for example, based on (e.g., after or in response to) the sending/transmitting of the third message (e.g., Msg 3 1313). The base station may address the wireless device on the PDCCH (e.g., the base station may send the PDCCH to the wireless device) using a C-RNTI, for example, if the C-RNTI was included in the third message (e.g., Msg 3 1313). The random access procedure may be determined to be successfully completed, for example, if the unique C-RNTI of the wireless device is detected on the PDCCH (e.g., the PDCCH is scrambled by the C-RNTI). The fourth message (e.g., Msg 4 1314) may be received using a DL-SCH associated with a TC-RNTI, for example, if the TC RNTI is comprised in the third message (e.g., Msg 3 1313) (e.g., if the wireless device is in an RRC idle (e.g., an RRC_IDLE) state or not otherwise connected to the base station). The wireless device may determine that the contention resolution is successful and/or the wireless device may determine that the random access procedure is successfully completed, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, if a measured quality of one or more reference signals (e.g., one or more reference signals associated with the NUL carrier) is lower than a broadcast threshold. Uplink transmissions of the random access procedure (e.g., the first message (e.g., Msg 1 1311) and/or the third message (e.g., Msg 3 1313)) may remain on, or may be performed via, the selected carrier. The wireless device may switch an uplink carrier during the random access procedure (e.g., for the first message (e.g., Msg 1 1311) and/or the third message (e.g., Msg 3 1313)). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random access procedure. Similar to the four-step contention-based random access procedure, a base station may, prior to initiation of the procedure, send/transmit a configuration message 1320 to the wireless device. The configuration message 1320 may be analogous in some respects to the configuration message 1310. The procedure shown in FIG. 13B may comprise transmissions of two messages: a first message (e.g., Msg 1 1321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-Response Window) to monitor a PDCCH for the RAR, for example, based on (e.g., after or in response to) sending/transmitting the preamble. The base station may configure the wireless device with one or more beam failure recovery parameters, such as a separate time window and/or a separate PDCCH in a search space indicated by an RRC message (e.g., recoverySearchSpaceId). The base station may configure the one or more beam failure recovery parameters, for example, in association with a beam failure recovery request. The separate time window for monitoring the PDCCH and/or an RAR may be configured to start after sending/transmitting a beam failure recovery request (e.g., the window may start any quantity of symbols and/or slots after sending/transmitting the beam failure recovery request). The wireless device may monitor for a PDCCH transmission addressed to a Cell RNTI (C-RNTI) on the search space. During the two-step (e.g., contention-free) random access procedure, the wireless device may determine that a random access procedure is successful, for example, based on (e.g., after or in response to) sending/transmitting first message (e.g., Msg 1 1321) and receiving a corresponding second message (e.g., Msg 2 1322). The wireless device may determine that a random access procedure has successfully been completed, for example, if a PDCCH transmission is addressed to a corresponding C-RNTI. The wireless device may determine that a random access procedure has successfully been completed, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random access procedures shown in FIGS. 13A and 13B, a base station may, prior to initiation of the procedure, send/transmit a configuration message 1330 to the wireless device. The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

The first message (e.g., Msg A 1331) may be sent/transmitted in an uplink transmission by the wireless device. The first message (e.g., Msg A 1331) may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, based on (e.g., after or in response to) sending/transmitting the first message (e.g., Msg A 1331). The second message (e.g., Msg B 1332) may comprise contents that are similar and/or equivalent to the contents of the second message (e.g., Msg 2 1312) (e.g., an RAR shown in FIG. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a UE identifier for contention resolution); and/or an RNTI (e.g., a C-RNTI or a TC-RNTI). The wireless device may determine that the two-step random access procedure is successfully completed, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as layer 1 or layer 2 (e.g., L1 or L2, Layer 1/Layer 2, L1/L2, Layer 1 or layer 2, Layer 1 or Layer 2, L1/2, Layer 1/2, layer 1/2 etc.)) control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as DCI. The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCIs may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCIs with one or more DCI formats, for example, depending on the purpose and/or content of the DCIs. DCI format 0_0 may be used for scheduling of a PUSCH in a cell. DCI format 0_0 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 1_0 may be a fallback DCI format (e.g., with compact DCI payloads). DCI format 1_1 may be used for scheduling of a PDSCH in a cell (e.g., with more DCI payloads than DCI format 1_0). DCI format 2_0 may be used for providing a slot format indication to a group of wireless devices. DCI format 2_1 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a number of contiguous control channel elements (CCEs), for example, based on a payload size of the DCI and/or a coverage of the base station. The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

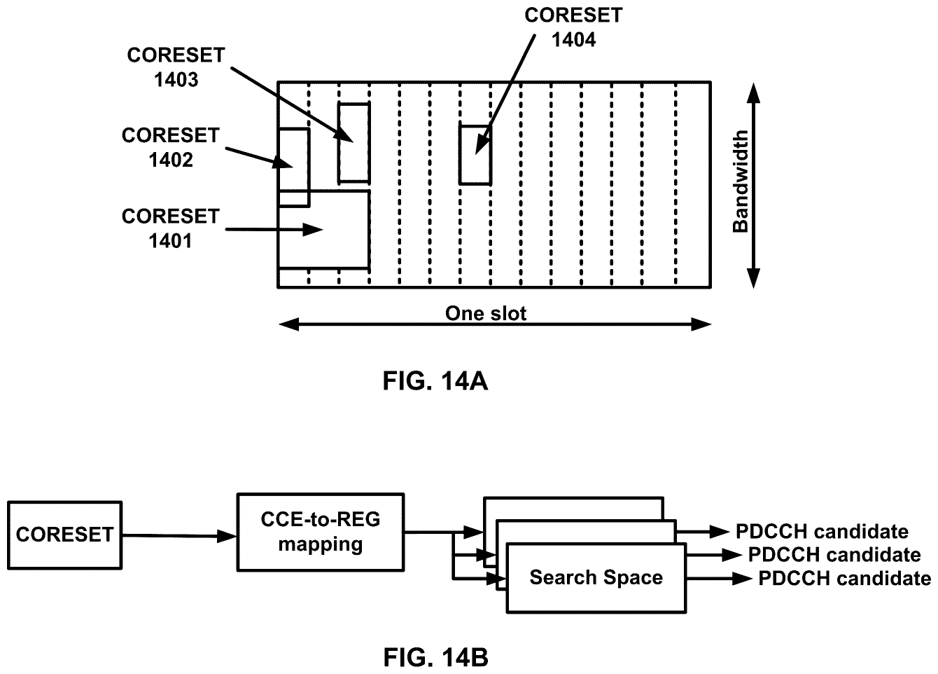

FIG. 14A shows an example of CORESET configurations. The CORESET configurations may be for a bandwidth part or any other frequency bands. The base station may send/transmit DCI via a PDCCH on one or more CORESETs. A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a UE-specific search space set). A set of CCEs in the common search space set may be predefined and known to the wireless device. A set of CCEs in the wireless device-specific search space set (e.g., the UE-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a quantity/number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the quantity/number of CCEs, the quantity/number of PDCCH candidates in common search spaces, and/or the quantity/number of PDCCH candidates in the wireless device-specific search spaces) and possible (or configured) DCI formats. The decoding may be referred to as blind decoding. The wireless device may determine DCI as valid for the wireless device, for example, based on (e.g., after or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The wireless device may send/transmit uplink control signaling (e.g., UCI) to a base station. The uplink control signaling may comprise HARQ acknowledgements for received DL-SCH transport blocks. The wireless device may send/transmit the HARQ acknowledgements, for example, based on (e.g., after or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise SR. The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a quantity/number of UCI bits). PUCCH format 0 may have a length of one or two OFDM symbols and may comprise two or fewer bits. The wireless device may send/transmit UCI via a PUCCH resource, for example, using PUCCH format 0 if the transmission is over/via one or two symbols and the quantity/number of HARQ-ACK information bits with positive or negative SR (HARQ-ACK/SR bits) is one or two. PUCCH format 1 may occupy a quantity/number of OFDM symbols (e.g., between four and fourteen OFDM symbols) and may comprise two or fewer bits. The wireless device may use PUCCH format 1, for example, if the transmission is over/via four or more symbols and the quantity/number of HARQ-ACK/SR bits is one or two. PUCCH format 2 may occupy one or two OFDM symbols and may comprise more than two bits. The wireless device may use PUCCH format 2, for example, if the transmission is over/via one or two symbols and the quantity/number of UCI bits is two or more. PUCCH format 3 may occupy a quantity/number of OFDM symbols (e.g., between four and fourteen OFDM symbols) and may comprise more than two bits. The wireless device may use PUCCH format 3, for example, if the transmission is four or more symbols, the quantity/number of UCI bits is two or more, and the PUCCH resource does not comprise an orthogonal cover code (OCC). PUCCH format 4 may occupy a quantity/number of OFDM symbols (e.g., between four and fourteen OFDM symbols) and may comprise more than two bits. The wireless device may use PUCCH format 4, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a quantity/number (e.g. a maximum number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) if configured with a plurality of PUCCH resource sets. The wireless device may select a first PUCCH resource set having a PUCCH resource set index equal to “0,” for example, if the total bit length of UCI information bits is two or fewer. The wireless device may select a second PUCCH resource set having a PUCCH resource set index equal to “1,” for example, if the total bit length of UCI information bits is greater than two and less than or equal to a first configured value. The wireless device may select a third PUCCH resource set having a PUCCH resource set index equal to “2,” for example, if the total bit length of UCI information bits is greater than the first configured value and less than or equal to a second configured value. The wireless device may select a fourth PUCCH resource set having a PUCCH resource set index equal to “3,” for example, if the total bit length of UCI information bits is greater than the second configured value and less than or equal to a third value (e.g., 1406, 1706, or any other quantity of bits).

The wireless device may determine a PUCCH resource from a PUCCH resource set for UCI (HARQ-ACK, CSI, and/or SR) transmission, for example, after determining the PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

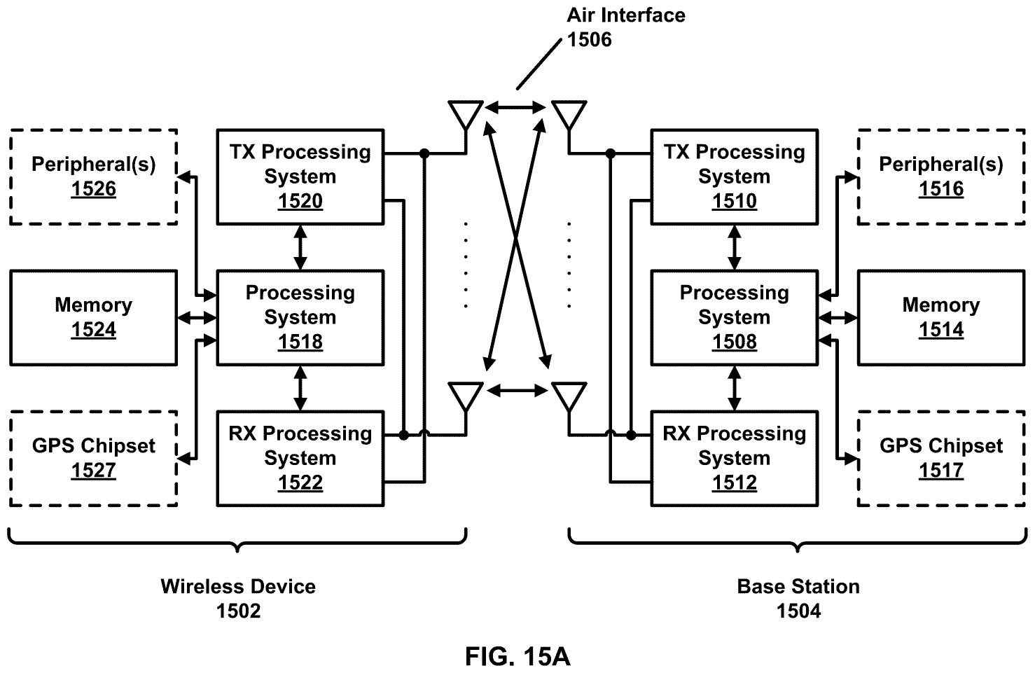

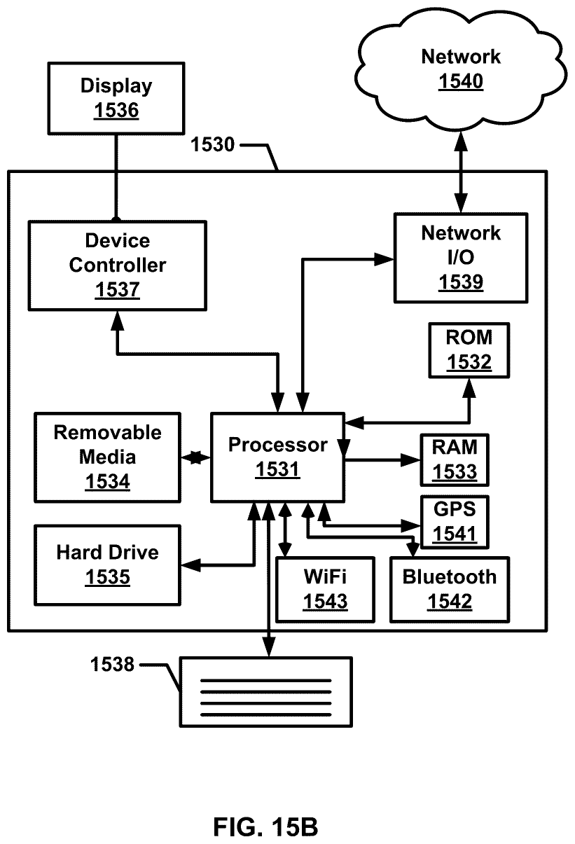

FIG. 15A shows an example of communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, and/or 1504, the wireless device 106, 156A, 156B, 210, and/or 1502, or any other base station, wireless device, AMF, UPF, network device, or computing device described herein. The computing device 1530 may include one or more processors 1531, which may execute instructions stored in the random-access memory (RAM) 1533, the removable media 1534 (such as a USB drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a WiFi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a GPS microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

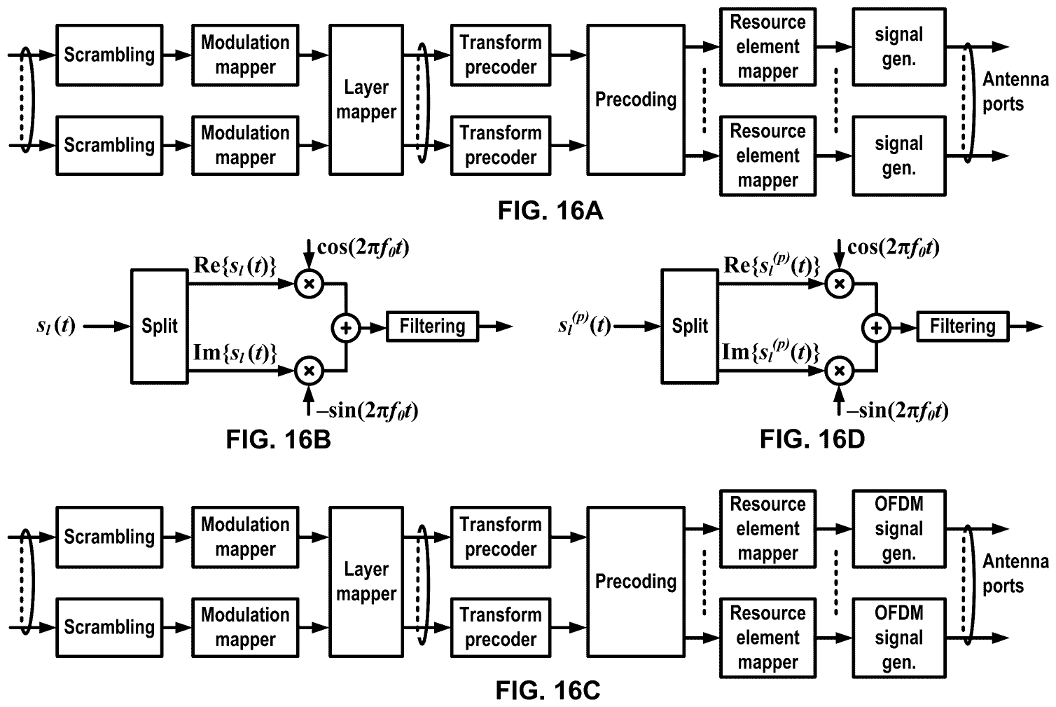

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, if transform precoding is enabled. A CP-OFDM signal for uplink transmission may be generated, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, after it is started and continue running until it is stopped or until it expires. A timer may be started, for example, if it is not running or restarted if it is running. A timer may be associated with a value (e.g., the timer may be started or restarted from a value or may be started from zero and expire after it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random access response window timer may be used for measuring a window of time for receiving a random access response. The time difference between two time stamps may be used, for example, instead of starting a random access response window timer and determine the expiration of the timer. A process for measuring a time window may be restarted, for example, if a timer is restarted. Other example implementations may be configured/provided to restart a measurement of a time window.

A base station may communicate with a wireless device via a wireless network (e.g., a communication network). The communications may use/employ one or more radio technologies (e.g., new radio technologies, legacy radio technologies, and/or a combination thereof). The one or more radio technologies may comprise at least one of: one or multiple technologies related to a physical layer; one or multiple technologies related to a medium access control layer; and/or one or multiple technologies related to a radio resource control layer. One or more enhanced radio technologies described herein may improve performance of a wireless network. System throughput, transmission efficiencies of a wireless network, and/or data rate of transmission may be improved, for example, based on one or more configurations described herein. Battery consumption of a wireless device may be reduced, for example, based on one or more configurations described herein. Latency of data transmission between a base station and a wireless device may be improved, for example, based on one or more configurations described herein. A network coverage of a wireless network may increase, for example, based on one or more configurations described herein.

A base station may send/transmit one or more MAC PDUs to a wireless device. A MAC PDU may be a bit string that is byte aligned (e.g., aligned to a multiple of eight bits) in length. Bit strings may be represented by one or more tables in which the most significant bit may be the leftmost bit of the first line of a table, and the least significant bit may be the rightmost bit on the last line of the table. The bit string may be read from left to right and then in the reading order of the lines (e.g., from the topmost line of the table to the bottommost line of the table). The bit order of a parameter field within a MAC PDU may be represented with the first and most significant bit in the leftmost bit and the last and least significant bit in the rightmost bit.

A MAC SDU may be a bit string that is byte aligned (e.g., aligned to a multiple of eight bits) in length. A MAC SDU may be comprised in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. A MAC subheader may be placed immediately in front of a corresponding MAC SDU, MAC CE, or padding. A wireless device (e.g., the MAC entity of the wireless device) may ignore a value of reserved bits in a downlink (DL) MAC PDU.

A MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, and/or a combination thereof. The MAC SDU may be of variable size. A MAC subheader may correspond to a MAC SDU, a MAC CE, or padding.

A MAC subheader may comprise: an R field with a one-bit length; an F field with a one-bit length; an LCID field with a multi-bit length; an L field with a multi-bit length; and/or a combination thereof, for example, if the MAC subheader corresponds to a MAC SDU, a variable-sized MAC CE, or padding.

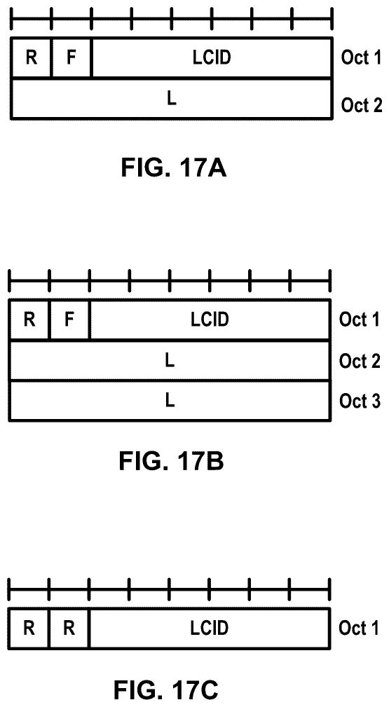

FIG. 17A shows an example of a MAC subheader. The MAC subheader may comprise an R field, an F field, an LCID field, and/or an L field. The LCID field may be six bits in length (or any other quantity of bits). The L field may be eight bits in length (or any other quantity of bits). Each of the R field and the F field may be one bit in length (or any other quantity of bits). FIG. 17B shows an example of a MAC subheader. The MAC subheader may comprise an R field, an F field, an LCID field, and/or an L field. Similar to the MAC subheader shown in FIG. 17A, the LCID field may be six bits in length (or any other quantity of bits), the R field may be one bit in length (or any other quantity of bits), and the F field may be one bit in length (or any other quantity of bits). The L field may be sixteen bits in length (or any other quantity of bits, such as greater than sixteen bits in length). A MAC subheader may comprise: an R field with a two-bit length (or any other quantity of bits) and/or an LCID field with a multi-bit length (or single bit length), for example, if the MAC subheader corresponds to a fixed sized MAC CE or padding. FIG. 17C shows an example of a MAC subheader. In the example MAC subheader shown in FIG. 17C, the LCID field may be six bits in length (or any other quantity of bits), and the R field may be two bits in length (or any other quantity of bits).

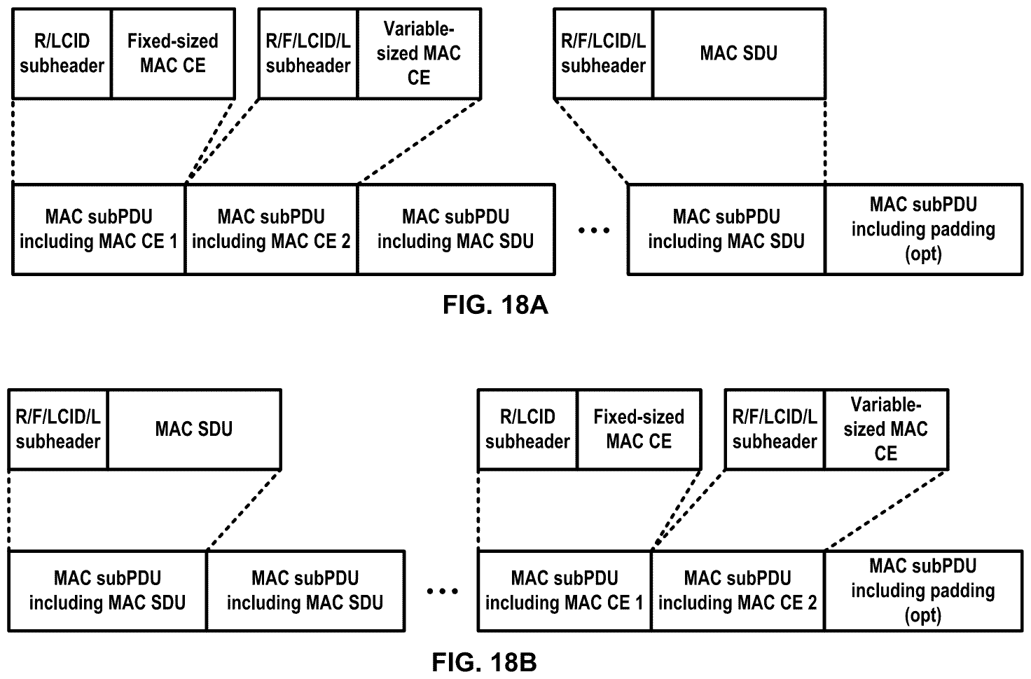

FIG. 18A shows an example of a MAC PDU (e.g., a DL MAC PDU). Multiple MAC CEs, such as MAC CE 1 and 2 shown in FIG. 18A, may be placed together (e.g., located within the same MAC PDU). A MAC subPDU comprising a MAC CE may be placed (e.g., located within a MAC PDU) before any MAC subPDU comprising a MAC SDU or a MAC subPDU comprising padding. MAC CE 1 may be a fixed-sized MAC CE that follows a first-type MAC subheader. The first-type MAC subheader may comprise an R field and an LCID field (e.g., similar to the MAC CE shown in FIG. 17C). MAC CE 2 may be a variable-sized MAC CE that follows a second-type MAC subheader. The second-type MAC subheader may comprise an R field, an F field, an LCID field and an L field (e.g., similar to the MAC CEs shown in FIG. 17A or FIG. 17B). The size of a MAC SDU that follows the second-type MAC subheader may vary.

FIG. 18B shows an example of a MAC PDU (e.g., a UL MAC PDU). Multiple MAC CEs, such as MAC CE 1 and 2 shown in FIG. 18B, may be placed together (e.g., located within the same MAC PDU). A MAC subPDU comprising a MAC CE may be placed (e.g., located within a MAC PDU) after all MAC subPDUs comprising a MAC SDU. The MAC subPDU and/or the MAC subPDU comprising a MAC CE may be placed (e.g., located within a MAC PDU) before a MAC subPDU comprising padding. Similar to the MAC CEs shown in FIG. 18A, MAC CE 1 shown in FIG. 18B may be a fixed-sized MAC CE that follows a first-type MAC subheader. The first-type MAC subheader may comprise an R field and an LCID field (e.g., similar to the MAC CE shown in FIG. 17C). Similar to the MAC CEs shown in FIG. 18A, MAC CE 2 shown in FIG. 18B may be a variable-sized MAC CE that follows a second-type MAC subheader. The second-type MAC subheader may comprise an R field, an F field, an LCID field and an L field (e.g., similar to the MAC CEs shown in FIG. 17A or FIG. 17B). The size of a MAC SDU that follows the second-type MAC subheader may vary.

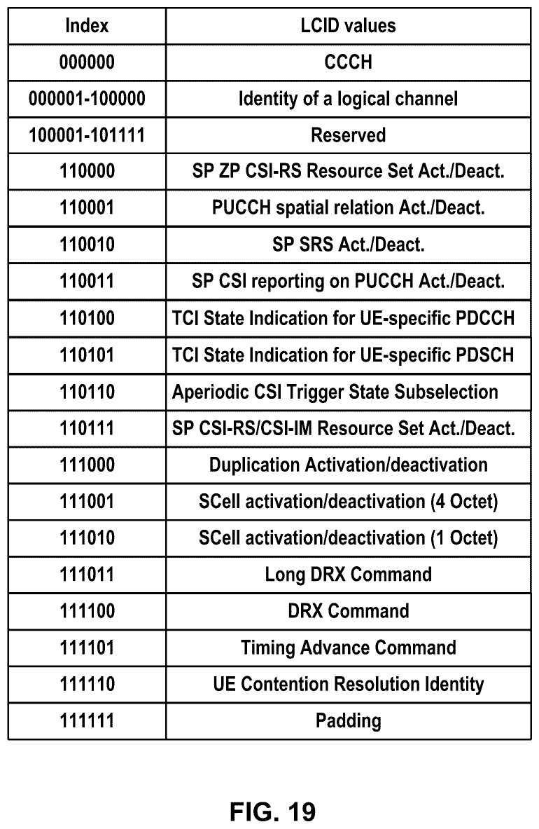

A base station (e.g., the MAC entity of a base station) may send/transmit one or more MAC CEs to a wireless device (e.g., a MAC entity of a wireless device). FIG. 19 shows example LCID values. The LCID values may be associated with one or more MAC CEs. The LCID values may be associated with a downlink channel, such as a DL-SCH. The one or more MAC CEs may comprise at least one of: an semi-persistent zero power CSI-RS (SP ZP CSI-RS) Resource Set Activation/Deactivation MAC CE, a PUCCH spatial relation Activation/Deactivation MAC CE, an SP SRS Activation/Deactivation MAC CE, an SP CSI reporting on PUCCH Activation/Deactivation MAC CE, a TCI State Indication for wireless device-specific (e.g., UE-specific) PDCCH MAC CE, a TCI State Indication for wireless device-specific (e.g., UE-specific) PDSCH MAC CE, an Aperiodic CSI Trigger State Subselection MAC CE, an SP CSI-RS/CSI interference measurement (CSI-IM) Resource Set Activation/Deactivation MAC CE, a wireless device (e.g., UE) contention resolution identity MAC CE, a timing advance command MAC CE, a DRX command MAC CE, a Long DRX command MAC CE, an SCell activation/deactivation MAC CE (e.g., 1 Octet), an SCell activation/deactivation MAC CE (e.g., 4 Octet), and/or a duplication activation/deactivation MAC CE. A MAC CE, such as a MAC CE sent/transmitted by a base station (e.g., a MAC entity of a base station) to a wireless device (e.g., a MAC entity of a wireless device), may be associated with (e.g., correspond to) an LCID in the MAC subheader corresponding to the MAC CE. Different MAC CEs may correspond to a different LCID in the MAC subheader corresponding to the MAC CE. An LCID having an index value “111011” in a MAC subheader may indicate that a MAC CE associated with the MAC subheader is a long DRX command MAC CE, for example, for a MAC CE associated with the downlink.

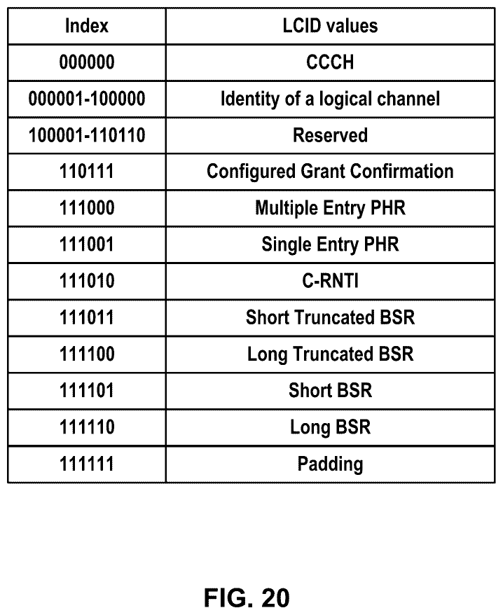

A wireless device (e.g., a MAC entity of a wireless device) may send/transmit to a base station (e.g., a MAC entity of a base station) one or more MAC CEs. FIG. 20 shows an example LCID values that may be associated with the one or more MAC CEs. The LCID values may be associated with an uplink channel, such as a UL-SCH. The one or more MAC CEs may comprise at least one of: a short buffer status report (BSR) MAC CE, a long BSR MAC CE, a C-RNTI MAC CE, a configured grant confirmation MAC CE, a single entry power headroom report (PHR) MAC CE, a multiple entry PHR MAC CE, a short truncated BSR, and/or a long truncated BSR. A MAC CE may be associated with (e.g., correspond to) an LCID in the MAC subheader corresponding to the MAC CE. Different MAC CEs may correspond to a different LCID in the MAC subheader corresponding to the MAC CE. An LCID having an index value “111011” in a MAC subheader may indicate that a MAC CE associated with the MAC subheader is a short-truncated command MAC CE, for example, for a MAC CE associated with the uplink.

Two or more CCs may be aggregated, such as in carrier aggregation (CA). A wireless device may simultaneously receive and/or transmit data via one or more CCs, for example, depending on capabilities of the wireless device (e.g., using the technique of CA). A wireless device may support CA for contiguous CCs and/or for non-contiguous CCs. CCs may be organized into cells. CCs may be organized into one PCell and one or more SCells.

A wireless device may have an RRC connection (e.g., one RRC connection) with a network, for example, if the wireless device is configured with CA. During an RRC connection establishment/re-establishment/handover, a cell providing/sending/configuring NAS mobility information may be a serving cell. During an RRC connection re-establishment/handover procedure, a cell providing/sending/configuring a security input may be a serving cell. The serving cell may be a PCell. A base station may send/transmit, to a wireless device, one or more messages comprising configuration parameters of a plurality of SCells, for example, depending on capabilities of the wireless device.

A base station and/or a wireless device may use/employ an activation/deactivation mechanism of an SCell, for example, if configured with CA. The base station and/or the wireless device may use/employ an activation/deactivation mechanism of an SCell, for example, to improve battery use and/or power consumption of the wireless device. A base station may activate or deactivate at least one of one or more SCells, for example, if a wireless device is configured with the one or more SCells. An SCell may be deactivated unless an SCell state associated with the SCell is set to an activated state (e.g., “activated”) or a dormant state (e.g., “dormant”), for example, after configuring the SCell.

A wireless device may activate/deactivate an SCell. A wireless device may activate/deactivate a cell, for example, based on (e.g., after or in response to) receiving an SCell Activation/Deactivation MAC CE. The SCell Activation/Deactivation MAC CE may comprise one or more fields associated with one or more SCells, respectively, to indicate activation or deactivation of the one or more SCells. The SCell Activation/Deactivation MAC CE may correspond to one octet comprising seven fields associated with up to seven SCells, respectively, for example, if the aggregated cell has less than eight SCells. The SCell Activation/Deactivation MAC CE may comprise an R field. The SCell Activation/Deactivation MAC CE may comprise a plurality of octets comprising more than seven fields associated with more than seven SCells, for example, if the aggregated cell has more than seven SCells.

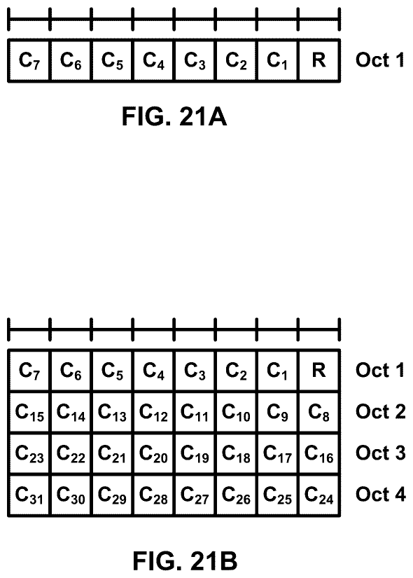

FIG. 21A shows an example SCell Activation/Deactivation MAC CE of one octet. A first MAC PDU subheader comprising a first LCID (e.g., ‘111010’ as shown in FIG. 19) may indicate/identify the SCell Activation/Deactivation MAC CE of one octet. The SCell Activation/Deactivation MAC CE of one octet may have a fixed size. The SCell Activation/Deactivation MAC CE of one octet may comprise a single octet. The single octet may comprise a first quantity/number of C-fields (e.g., seven or any other quantity/number) and a second quantity/number of R-fields (e.g., one or any other quantity/number).

FIG. 21B shows an example SCell Activation/Deactivation MAC CE of four octets. A second MAC PDU subheader comprising a second LCID (e.g., ‘111001’ as shown in FIG. 19) may indicate/identify the SCell Activation/Deactivation MAC CE of four octets. The SCell Activation/Deactivation MAC CE of four octets may have a fixed size. The SCell Activation/Deactivation MAC CE of four octets may comprise four octets. The four octets may comprise a third quantity/number of C-fields (e.g., 31 or any other quantity/number) and a fourth quantity/number of R-fields (e.g., 1 or any other quantity/number).

As shown in FIG. 21A and/or FIG. 21B, a Ci field may indicate an activation/deactivation status of an SCell with/corresponding to an SCell index i, for example, if an SCell with/corresponding to SCell index i is configured. An SCell with an SCell index i may be activated, for example, if the Ci field is set to one. An SCell with an SCell index i may be deactivated, for example, if the Ci field is set to zero. The wireless device may ignore the Ci field, for example, if there is no SCell configured with SCell index i. An R field may indicate a reserved bit. The R field may be set to zero or any other value (e.g., for other purposes).

A base station may configure a wireless device with uplink (UL) BWPs and downlink (DL) BWPs to enable bandwidth adaptation (BA) on a PCell. The base station may further configure the wireless device with at least DL BWP(s) (i.e., there may be no UL BWPs in the UL) to enable BA on an SCell, for example, if carrier aggregation is configured. An initial active BWP may be a first BWP used for initial access, for example, for a PCell. A first active BWP may be a second BWP configured for the wireless device to operate on a SCell upon the SCell being activated. A base station and/or a wireless device may independently switch a DL BWP and an UL BWP, for example, in paired spectrum (e.g., FDD). A base station and/or a wireless device may simultaneously switch a DL BWP and an UL BWP, for example, in unpaired spectrum (e.g., TDD).

A base station and/or a wireless device may switch a BWP between configured BWPs using a DCI message or a BWP inactivity timer. The base station and/or the wireless device may switch an active BWP to a default BWP based on (e.g., after or in response to) an expiry of the BWP inactivity timer associated with the serving cell, for example, if the BWP inactivity timer is configured for a serving cell. The default BWP may be configured by the network. One UL BWP for an uplink carrier (e.g., each uplink carrier) and one DL BWP may be active at a time in an active serving cell, for example, if FDD systems are configured with BA. One DL/UL BWP pair may be active at a time in an active serving cell, for example, for TDD systems. Operating on the one UL BWP and the one DL BWP (or the one DL/UL pair) may improve wireless device battery consumption. BWPs other than the one active UL BWP and the one active DL BWP that the wireless device may work on may be deactivated. The wireless device may not monitor PDCCH transmission, for example, on deactivated BWPs. The wireless device may not send (e.g., transmit) on PUCCH, PRACH, and UL-SCH, for example, on deactivated BWPs.

A serving cell may be configured with at most a first number/quantity (e.g., four) of BWPs. There may be one active BWP at any point in time, for example, for an activated serving cell. A BWP switching for a serving cell may be used to activate an inactive BWP and deactivate an active BWP at a time. The BWP switching may be controlled by a PDCCH transmission indicating a downlink assignment or an uplink grant. The BWP switching may be controlled by a BWP inactivity timer (e.g., bwp-InactivityTimer). The BWP switching may be controlled by a wireless device (e.g., a MAC entity of the wireless device) based on (e.g., after or in response to) initiating a Random Access procedure. One BWP may be initially active without receiving a PDCCH transmission indicating a downlink assignment or an uplink grant, for example, upon addition of an SpCell or activation of an SCell. The active BWP for a serving cell may be indicated by configuration parameter(s) (e.g., parameters of RRC message) and/or PDCCH transmission. A DL BWP may be paired with a UL BWP for unpaired spectrum, and BWP switching may be common for both UL and DL.

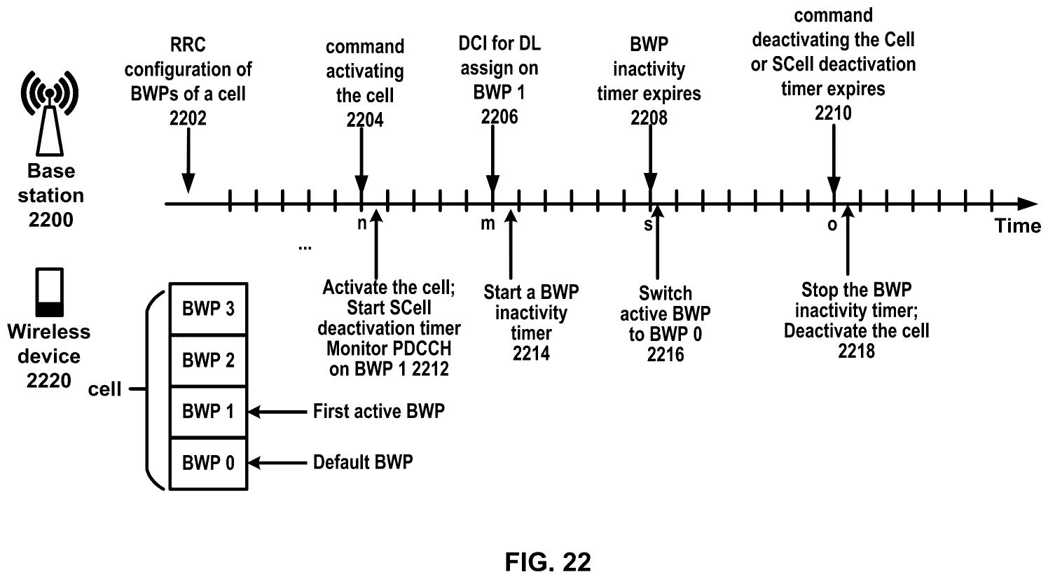

FIG. 22 shows an example of BWP activation/deactivation. The BWP activation/deactivation may be on a cell (e.g., PCell or SCell). The BWP activation/deactivation may be associated with BWP switching (e.g., BWP switching may comprise the BWP activation/deactivation). A wireless device 2220 may receive (e.g., detect) at step 2202, (e.g., from a base station 2200), at least one message (e.g., RRC message) comprising parameters of a cell and one or more BWPs associated with the cell. The RRC message may comprise at least one of: RRC connection reconfiguration message (e.g., RRCReconfiguration), RRC connection reestablishment message (e.g., RRCRestablishment), and/or RRC connection setup message (e.g., RRCSetup). Among the one or more BWPs, at least one BWP may be configured as the first active BWP (e.g., BWP 1), one BWP as the default BWP (e.g., BWP 0). The wireless device 2220 may receive (e.g., detect) a command at step 2204 (e.g., RRC message, MAC CE or DCI message) to activate the cell at an nth slot. The wireless device 2220 may not receive (e.g., detect) a command activating a cell, for example, a PCell. The wireless device 2220 may activate the PCell at step 2212, for example, after the wireless device 2220 receives/detects RRC message comprising configuration parameters of the PCell. The wireless device 2220 may start monitoring a PDCCH transmission on BWP 1 based on (e.g., after or in response to) activating the PCell at step 2212.

The wireless device 2220 may start (or restart) at step 2214, a BWP inactivity timer (e.g., bwp-InactivityTimer) at an mth slot based on (e.g., after or in response to) receiving a DCI message 2206 indicating DL assignment on BWP 1. The wireless device 2220 may switch back at step 2216 to the default BWP (e.g., BWP 0) as an active BWP, for example, if the BWP inactivity timer expires at step 2208, at sth slot. At step 2210, the wireless device 2220 may deactivate the cell and/or stop the BWP inactivity timer, for example, if a secondary cell deactivation timer (e.g., sCellDeactivationTimer) expires at step 2210 (e.g., if the cell is a SCell). The wireless device 2220 may not deactivate the cell and may not apply or use a secondary cell deactivation timer (e.g., sCellDeactivationTimer) on the PCell, for example, based on the cell being a PCell.

A wireless device (e.g., a MAC entity of the wireless device) may apply or use various operations on an active BWP for an activated serving cell configured with a BWP. The various operations may comprise at least one of: sending (e.g., transmitting) on UL-SCH, sending (e.g., transmitting) on RACH, monitoring a PDCCH transmission, sending (e.g., transmitting) PUCCH, receiving DL-SCH, and/or (re-) initializing any suspended configured uplink grants of configured grant Type 1 according to a stored configuration, if any.

A wireless device (e.g., a MAC entity of the wireless device) may not perform certain operations, for example, on an inactive BWP for an activated serving cell (e.g., each activated serving cell) configured with a BWP. The certain operations may include at least one of sending (e.g., transmit) on UL-SCH, sending (e.g., transmit) on RACH, monitoring a PDCCH transmission, sending (e.g., transmit) PUCCH, sending (e.g., transmit) SRS, or receiving DL-SCH. The wireless device (e.g., the MAC entity of the wireless device) may clear any configured downlink assignment and configured uplink grant of configured grant Type 2, and/or suspend any configured uplink grant of configured Type 1, for example, on the inactive BWP for the activated serving cell (e.g., each activated serving cell) configured with the BWP.

A wireless device may perform a BWP switching of a serving cell to a BWP indicated by a PDCCH transmission, for example, if a wireless device (e.g., a MAC entity of the wireless device) receives/detects the PDCCH transmission for the BWP switching and a random access procedure associated with the serving cell is not ongoing. A bandwidth part indicator field value may indicate the active DL BWP, from the configured DL BWP set, for DL receptions, for example, if the bandwidth part indicator field is configured in DCI format 1_1. A bandwidth part indicator field value may indicate the active UL BWP, from the configured UL BWP set, for UL transmissions, for example, if the bandwidth part indicator field is configured in DCI format 0_1.

A wireless device may be provided by a higher layer parameter such as a default DL BWP (e.g., Default-DL-BWP) among the configured DL BWPs, for example, for a primary cell. A default DL BWP may be the initial active DL BWP, for example, if a wireless device is not provided with the default DL BWP by the higher layer parameter (e.g., Default-DL-BWP). A wireless device may be provided with a higher layer parameter such as a value of a timer for the primary cell (e.g., bwp-InactivityTimer). The wireless device may increment the timer, if running, every interval of 1 millisecond for frequency range 1 or every 0.5 milliseconds for frequency range 2, for example, if the wireless device may not detect a DCI format 1_1 for paired spectrum operation or if the wireless device may not detect a DCI format 1_1 or DCI format 0_1 for unpaired spectrum operation during the interval.

Procedures of a wireless device on the secondary cell may be substantially the same as on the primary cell using a timer value for a secondary cell and the default DL BWP for the secondary cell, for example, if the wireless device is configured for the secondary cell with a higher layer parameter (e.g., Default-DL-BWP) indicating a default DL BWP among the configured DL BWPs and the wireless device is configured with a higher layer parameter (e.g., bwp-InactivityTimer) indicating the timer value. A wireless device may use an indicated DL BWP and an indicated UL BWP on a secondary cell respectively as a first active DL BWP and a first active UL BWP on the secondary cell or carrier, for example, if the wireless device is configured by a higher layer parameter (e.g., Active-BWP-DL-SCell) associated with the first active DL BWP and by a higher layer parameter (e.g., Active-BWP-UL-SCell) associated with the first active UL BWP on the secondary cell or carrier.

A set of PDCCH candidates for a wireless device to monitor may be referred to as PDCCH search space sets. A search space set may comprise a CSS set or a USS set. A wireless device may monitor PDCCH transmission candidates in one or more of the following search spaces sets: a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG, a Type0A-PDCCH CSS set configured by searchSpaceOtherSystemInformation in PDCCH-ConfigCommon for a DCI format with CRC scrambled by a SI-RNTI on the primary cell of the MCG, a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or PS-RNTI and, for the primary cell, C-RNTI, MCS-C-RNTI, or CS-RNTI(s), and a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

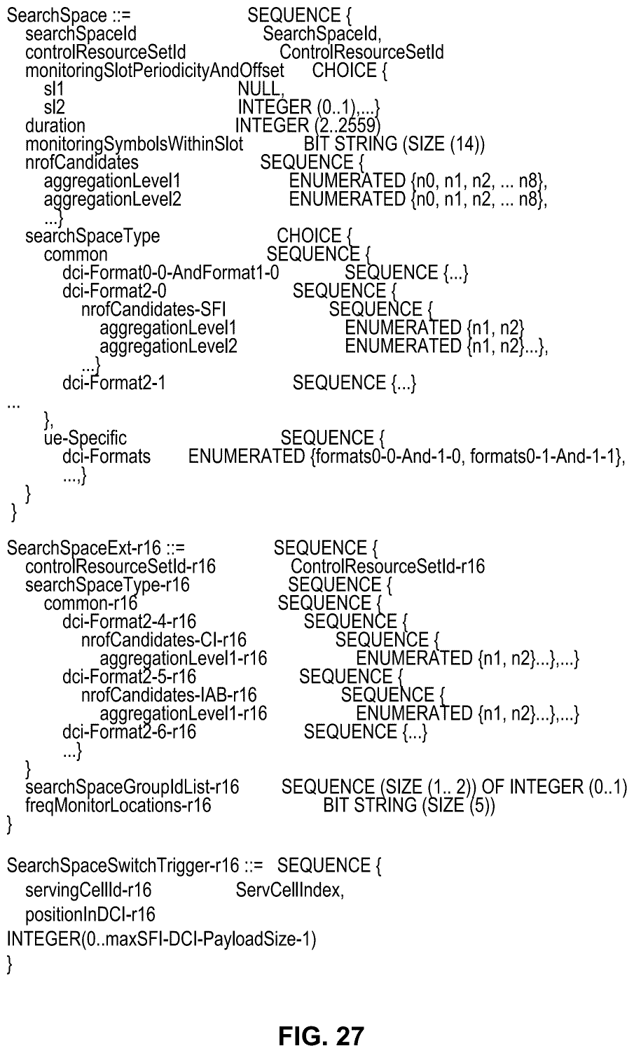

A wireless device may determine a PDCCH transmission monitoring occasion on an active DL BWP based on one or more PDCCH transmission configuration parameters (e.g., as described with respect to FIG. 27) comprising at least one of: a PDCCH transmission monitoring periodicity, a PDCCH transmission monitoring offset, or a PDCCH transmission monitoring pattern within a slot. For a search space set (SS s), the wireless device may determine that a PDCCH transmission monitoring occasion(s) exists in a slot with number/quantity n_{s,f}^{μ} in a frame with number/quantity n_{f} if (n_{f}·Nₛₗₒₜ^{frame,μ}+n_{s,f}^{μ}−oₛ) mod kₛ=0. Nₛₗₒₜ^{frame,μ} may be a number/quantity of slots in a frame if numerology μ is configured. oₛ may be a slot offset indicated in the PDCCH transmission configuration parameters. kₛ may be a PDCCH transmission monitoring periodicity indicated in the PDCCH transmission configuration parameters. The wireless device may monitor PDCCH transmission candidates for the search space set for Tₛ consecutive slots, starting from slot n_{s,f}^{μ}, and may not monitor PDCCH transmission candidates for search space set s for the next kₛ−Tₛ consecutive slots. A USS at CCE aggregation level Lϵ{1, 2, 4, 8, 16} may be defined by a set of PDCCH transmission candidates for CCE aggregation level L.

A wireless device may decide, for a search space set s associated with CORESET p, CCE indexes for aggregation level L corresponding to PDCCH transmission candidate m_{s,n}_{_{Cl}} of the search space set in slot n_{s,f}^{μ} for an active DL BWP of a serving cell corresponding to carrier indicator field value n_{Cl} as

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i ,$$

where, Y_{p,n}_{_{s,f}}_{^{μ}}=0 for any CSS; Y_{p,n}_{_{s,f}}_{^{μ}}=(Ap·Y_{p,n}_{_{s,f}}_{^{μ}}₋₁) mod D for a USS, Y_{p,-1}=n_{RNTI}≠0, Aₚ=39827 for p mod 3=0, Aₚ=39829 for p mod 3=1, Aₚ=39839 for p mod 3=2, and D=65537; i=0, . . . , L−1; N_{CCE,p} is the number/quantity of CCEs, numbered/quantified from 0 to N_{CCE,p}−1, in CORESET p; n_{Cl} is the carrier indicator field value if the wireless device is configured with a carrier indicator field by CrossCarrierSchedulingConfig for the serving cell on which PDCCH transmission is monitored; otherwise, including for any CSS, n_{Cl}=0; m_{s,n}_{_{Cl}}=0, . . . , M_{s,n}_{_{Cl}}^{(L)}−1, where M_{s,n}_{_{Cl}}^{(L)} is the number/quantity of PDCCH transmission candidates the wireless device is configured to monitor for aggregation level L of a search space set s for a serving cell corresponding to n_{Cl}; for any CSS, M_{s,max}^{(L)}=M_{s,0}^{(L)}; for a USS, M_{s,max}^{(L)} is the maximum of M_{s,n}_{_{Cl}}^{(L)} over configured n_{Cl} values for a CCE aggregation level L of search space set s; and the RNTI value used for n_{RNTI} is the C-RNTI.

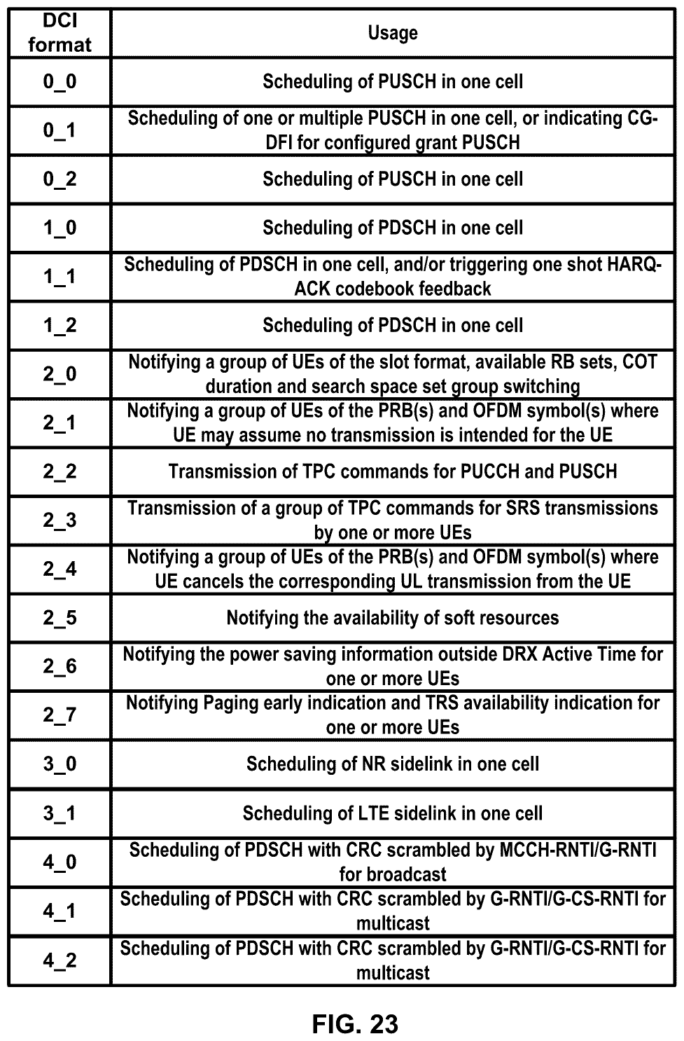

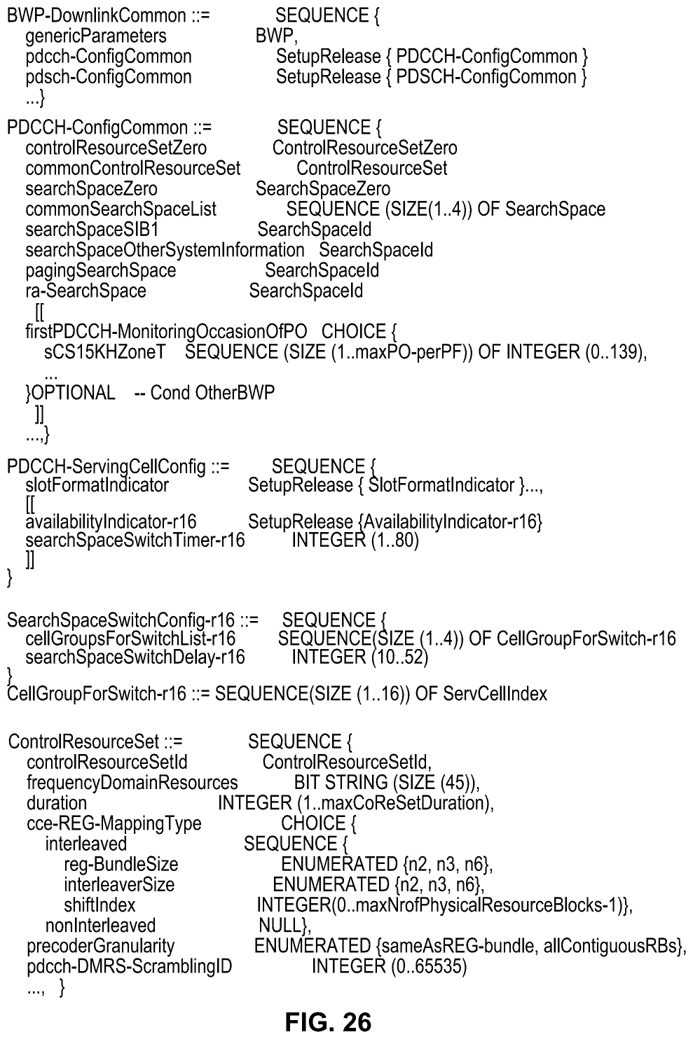

A wireless device may monitor a set of PDCCH transmission candidates according to configuration parameters of a search space set comprising a plurality of search spaces. The wireless device may monitor a set of PDCCH transmission candidates in one or more CORESETs for detecting one or more DCI messages. A CORESET may be configured, for example, as described with respect to FIG. 26. Monitoring may comprise decoding one or more PDCCH transmission candidates of the set of the PDCCH transmission candidates according to the monitored DCI formats. Monitoring may comprise decoding DCI content of one or more PDCCH transmission candidates with possible (or configured) PDCCH transmission locations, possible (or configured) PDCCH transmission formats (e.g., number/quantity of CCEs, number/quantity of PDCCH transmission candidates in common search spaces, and/or number/quantity of PDCCH transmission candidates in the wireless device-specific search spaces (e.g., the UE-specific search spaces)) and possible (or configured) DCI formats. The decoding may be referred to as blind decoding. The possible DCI formats may be based on examples of FIG. 23.

FIG. 23 shows examples of various DCI formats. The various DCI formats may be used, for example, by a base station to send (e.g., transmit) control information (e.g., to a wireless device and/or to be used by the wireless device) for PDCCH transmission monitoring. Different DCI formats may comprise different DCI fields and/or have different DCI payload sizes. Different DCI formats may have different signaling purposes. DCI format 0_0 may be used to schedule PUSCH transmission in one cell. DCI format 0_1 may be used to schedule one or multiple PUSCH transmissions in one cell or indicate CG-DFI (configured grant-Downlink Feedback Information) for configured grant PUSCH transmission, etc. The DCI format(s), that the wireless device may monitor for reception via a search space, may be configured.

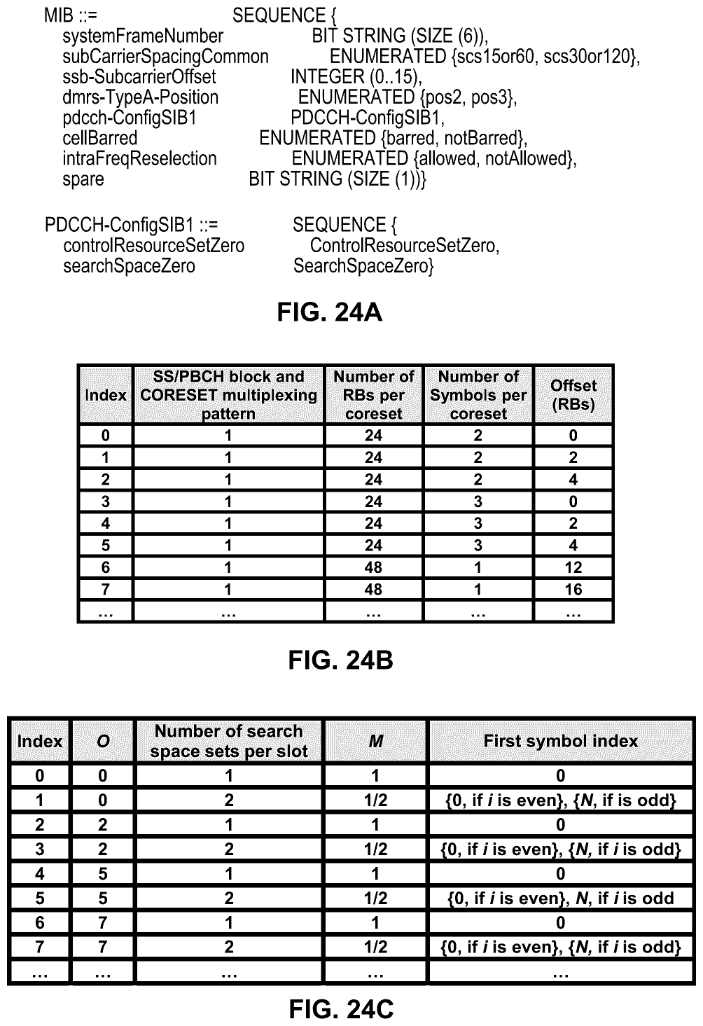

FIG. 24A shows an example MIB message. FIG. 24A shows example configuration parameters of a MIB of a cell. The cell may be a PCell (or any other cell). A wireless device may receive a MIB via a PBCH. The wireless device may receive the MIB, for example, based on receiving a PSS and/or an SSS. The configuration parameters of a MIB may comprise/indicate a SFN (e.g., indicated via a higher layer parameter systemFrameNumber), subcarrier spacing indication (e.g., indicated via a higher layer parameter subCarrierSpacingCommon), a frequency domain offset (e.g., indicated via a higher layer parameter ssb-SubcarrierOffset) between SSB and overall resource block grid in number of subcarriers, a parameter indicating whether the cell is barred (e.g., indicated via a higher layer parameter cellBarred), a DMRS position indication (e.g., indicated via a higher layer parameter dmrs-TypeA-Position) indicating position of DMRS, parameters of a CORESET and a search space of a PDCCH (e.g., indicated via a higher layer parameter pdcch-ConfigSIB1) comprising a common CORESET, a common search space and necessary PDCCH parameters, etc. Each of the higher layer parameters may be indicated via one or bits. For example, the SFN may be indicated using 6 bits (or any other quantity of bits).

A configuration parameter (e.g., pdcch-ConfigSIB1) may comprise a first parameter (e.g., controlResourceSetZero) indicating a common CORESET of an initial BWP of the cell. The common CORESET may be associated with an indicator/index (e.g., 0, or any other indicator). For example, the common CORESET may be CORESET 0. The first parameter may be an integer between 0 and 15 (or any other integer). Each integer (e.g., between 0 and 15, or any other integer) may indicate/identify a configuration of CORESET 0.

FIG. 24B shows an example configuration of a CORESET. The CORESET may be CORESET 0 (or any other CORESET). A wireless device may determine an SSB and CORESET 0 multiplexing pattern, a quantity/number of RBs for CORESET 0, a quantity/number of symbols for CORESET 0, an RB offset for CORESET 0, for example, based on a value of the first parameter (e.g., controlResourceSetZero).

A higher layer parameter (e.g., pdcch-ConfigSIB1) may comprise a second parameter (e.g., searchSpaceZero). The second parameter may indicate a common search space of the initial BWP of the cell. The common search space may be associated with an indicator/index (e.g., 0, or any other indicator). For example, the common search space may be search space 0. The second parameter may be an integer between 0 and 15 (or any other integer). Each integer (e.g., between 0 and 15, or any other integer) may identify a configuration of search space 0.

FIG. 24C shows an example configuration of a search space. The search space may be search space 0 (or any other search space). A wireless device may determine one or more parameters (e.g., O, M) for slot determination for PDCCH monitoring, a first symbol indicator/index for PDCCH monitoring, and/or a quantity/number of search spaces per slot, for example, based on a value of the second parameter (e.g., searchSpaceZero). For example, for operation without shared spectrum channel access and for the SS/PBCH block and CORESET multiplexing pattern 1, the wireless device may monitor PDCCH (e.g., in the Type0-PDCCH CSS set) over two slots. For SS/PBCH block with index i, the wireless device may determine an index of slot no as n₀=(0·2^{μ}+[i·M])modNₛₗₒₜ^{frame,μ}. Slot n₀ is may be in a frame with a SFN SFN_{C} that satisfies the condition SFN_{c}mod2=0 (e.g., if [(0·2^{μ}+[i·M])/Nₛₗₒₜ^{frame,μ}]mod2=0), or in a frame with a SFN that SFN_{C} satisfies the condition SFN_{c}mod2=1 (e.g., if [(0·2^{μ}+[i·M])/Nₛₗₒₜ^{frame,μ}]mod2=1), where μϵ{0,1,2,3,5,6} based on the SCS for PDCCH receptions in the CORESET.

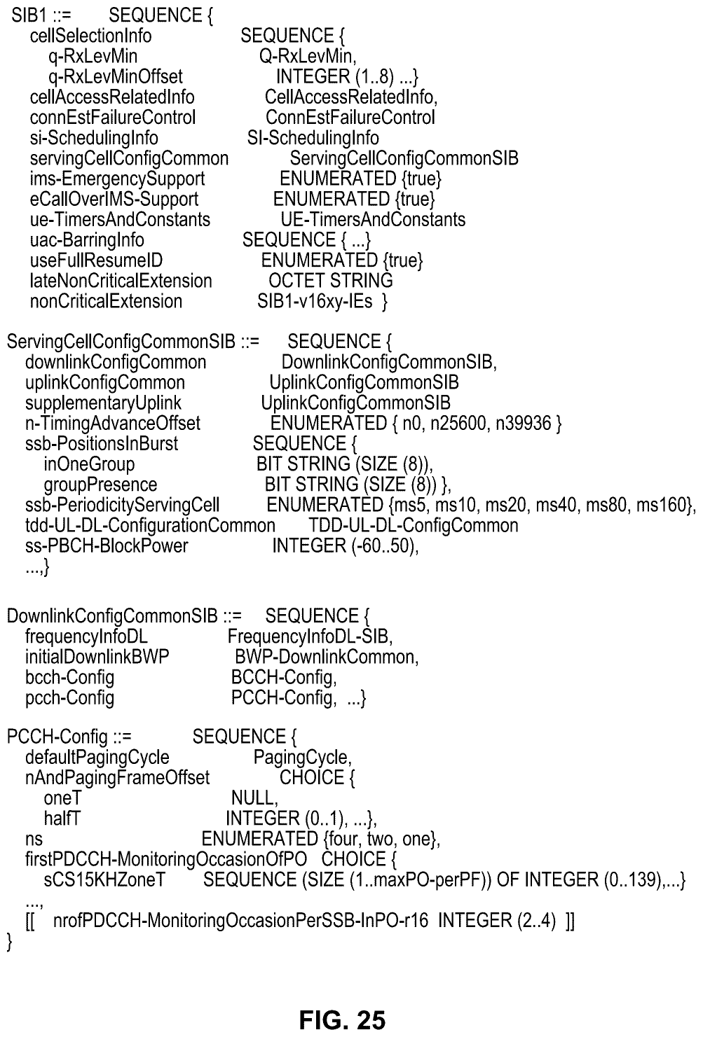

A wireless device may monitor a PDCCH for receiving DCI. The wireless device may monitor a search space 0 of a CORESET 0 for receiving the DCI. The DCI may schedule a SIB1. For example, a SIB1 message may be similar to as described with respect to FIG. 25. The wireless device may receive the DCI with CRC scrambled with a SI-RNTI dedicated for receiving the SIB1.

FIG. 25 shows an example SIB. The SIB may comprise one or more configuration parameters (e.g., RRC configuration parameters). A SIB (e.g., SIB1) may be sent/transmitted to one or more wireless devices. For example, the SIB may be broadcasted to multiple wireless devices. The SIB may contain information for evaluating/determining whether a wireless device is allowed to access a cell, information of paging configuration, and/or scheduling configuration of other system information. A SIB may comprise radio resource configuration information that may be common for multiple wireless devices and barring information used/applied to a unified access control. A base station may send/transmit, to a wireless device (or a plurality of wireless devices), one or more SIB information messages. As shown in FIG. 25, parameters of the one or more SIB information messages may comprise: one or more parameters for cell selection related to a serving cell (e.g., cellSelectionInfo), one or more parameters configuration of a serving cell (e.g., in ServingCellConfigCommonSIB information element (IE)), and/or one or more other parameters. The ServingCellConfigCommonSIB IE may comprise at least one of: common downlink parameters (e.g., in DownlinkConfigCommonSIB IE) of the serving cell, common uplink parameters (e.g., in UplinkConfigCommonSIB IE) of the serving cell, and/or other parameters.

A DownlinkConfigCommonSIB IE may comprise parameters of an initial downlink BWP (e.g., indicated via initialDownlinkBWP IE) of the serving cell (e.g., SpCell). The parameters of the initial downlink BWP may be comprised in a BWP-DownlinkCommon IE (e.g., as shown in FIG. 26). The BWP-DownlinkCommon IE may be used to configure common parameters of a downlink BWP of the serving cell. The base station may configure a parameter (e.g., locationAndBandwidth) such that the initial downlink BWP may comprise an entire CORESET (e.g., CORESET 0) of the serving cell in the frequency domain. The wireless device may use/apply the parameter locationAndBandwidth based on reception of the parameter. The wireless device may use/apply the parameter locationAndBandwidth to determine the frequency position of signals in relation to the frequency as indicated via locationAndBandwidth. The wireless device may keep CORESET 0, for example, until after reception of an RRC setup message (e.g., RRCSetup), RRC resume message (e.g., RRCResume) and/or an RRC re-establishment message (e.g., RRCReestablishment).

The DownlinkConfigCommonSIB IE may comprise parameters of a paging channel configuration. The parameters may comprise a paging cycle value (T, e.g., indicated by defaultPagingCycle IE), a parameter indicating total quantity/number (N) of paging frames (PFs) (e.g., indicated by nAndPagingFrameOffset IE) and paging frame offset in a paging DRX cycle (e.g., indicated by parameter PF_offset), a quantity/number (Ns) for total paging occasions (POs) per PF, a first PDCCH monitoring occasion indication parameter (e.g., firstPDCCH-MonitoringOccasionofPO IE) indicating a first PDCCH monitoring occasion for paging of each PO of a PF. The wireless device may monitor a PDCCH for receiving a paging message, for example, based on parameters of a PCCH configuration.

A parameter (e.g., first-PDCCH-MonitoringOccasionOfPO) may be signaled in SIB1 for paging in initial DL BWP. The parameter first-PDCCH-MonitoringOccasionOfPO may be signaled in the corresponding BWP configuration, for example, for paging in a DL BWP other than the initial DL BWP.

FIG. 26 shows example RRC configuration parameters. The configuration parameters may be RRC configuration parameters for a downlink BWP of a serving cell. The configuration parameters may be indicated via a higher layer parameter BWP-DownlinkCommon IE. A base station may send/transmit to a wireless device (or a plurality of wireless devices) one or more configuration parameters of a downlink BWP (e.g., initial downlink BWP) of a serving cell. The one or more configuration parameters of the downlink BWP may comprise: one or more generic BWP parameters of the downlink BWP, one or more cell-specific parameters for PDCCH of the downlink BWP (e.g., in pdcch-ConfigCommon IE), one or more cell specific parameters for the PDSCH of the BWP (e.g., in pdsch-ConfigCommon IE), and/or one or more other parameters. A pdcch-ConfigCommon IE may comprise parameters of CORESET 0 (e.g., indicated via parameter controlResourceSetZero) which may be used in any common or wireless device-specific search spaces. A value of the controlResourceSetZero may be interpreted in the same manner as the corresponding bits in MIB parameter pdcch-ConfigSIB1. A pdcch-ConfigCommon IE may comprise parameters (e.g., in commonControlResourceSet) of an additional common control resource set which may be configured and used for any common or wireless device-specific search space. The network may use a parameter ControlResourceSetId other than 0 for this ControlResourceSet, for example, if the network configures commonControlResourceSet. The network may configure the commonControlResourceSet in SIB1 such that the SIB1 is contained within the bandwidth of CORESET 0. A pdcch-ConfigCommon IE may comprise parameters (e.g., in commonSearchSpaceList) of a list of additional common search spaces. Parameters of a search space may be implemented based on example of FIG. 27. A pdcch-ConfigCommon IE may indicate, from a list of search spaces, a search space for paging (e.g., via parameter pagingSearchSpace), a search space for random access procedure (e.g., via parameter ra-SearchSpace), a search space for SIB1 message (e.g., via parameter searchSpaceSIB1), a common search space 0 (e.g., via parameter searchSpaceZero), and/or one or more other search spaces.

A CORESET may be associated with a CORESET indicator/index (e.g., indicated via parameter ControlResourceSetId). A CORESET may be implemented based on examples described with respect to FIG. 14A and/or FIG. 14B. The CORESET index 0 may identify a common CORESET configured in MIB and in ServingCellConfigCommon (e.g., indicated via controlResourceSetZero). The CORESET index 0 may not be used in the ControlResourceSet IE. The CORESET index with other values may identify CORESETs configured by dedicated signaling or in SIB1. The controlResourceSetId may be unique among the BWPs of a serving cell. A CORESET may be associated with coresetPoolIndex indicating an index of a CORESET pool for the CORESET. A CORESET may be associated with a time duration parameter (e.g., duration) indicating contiguous time duration of the CORESET (e.g., in terms of a quantity/number of symbols). Configuration parameters of a CORESET may comprise at least one of: frequency resource indication (e.g., frequencyDomainResources), a CCE-REG mapping type indicator (e.g., cce-REG-MappingType), a plurality of TCI states, and/or an indicator indicating whether a TCI is present in DCI, etc. The frequency resource indication (e.g., comprising a quantity/number of bits, such as 45 bits, or any other quantity of bits) may indicate frequency domain resources. Each bit of the frequency resource indication may correspond to a group of RBs (e.g., 6 RBs, or any other quantity of RBs), with the grouping starting from the first RB group in a BWP of a cell (e.g., SpCell, SCell). For example, the first (e.g., left-most, most significant) bit may correspond to the first RB group in the BWP, with the other bits sequentially corresponding to other RB groups. A bit that is set to 1 may indicate that an RB group, corresponding to the bit, is contained in the frequency domain resource of the CORESET. Bits corresponding to a group of RBs not fully contained in the BWP within which the CORESET is configured may be set to zero.

FIG. 27 shows an example configuration of a search space. The configuration of the search space may be within a SearchSpace IE. One or more search space configuration parameters of a search space may comprise at least one of: a search space ID (e.g., searchSpaceId), a CORESET indicator (ID) (e.g., controlResourceSetId), a monitoring slot periodicity and offset parameter (e.g., monitoringSlotPeriodicityAndOffset), a search space time duration value (e.g., duration), a monitoring symbol indication (e.g., monitoringSymbolsWithinSlot), a quantity/number of candidates for an aggregation level (e.g., nrofCandidates), and/or a search space type indicating a common search space type or a wireless device-specific search space type (e.g., searchSpace Type). The monitoring slot periodicity and offset parameter may indicate slots (e.g., in a radio frame) and slot offset (e.g., related to a starting of a radio frame) for PDCCH monitoring. The monitoring symbol indication may indicate symbol(s), of a slot, in which a wireless device may monitor a PDCCH on the search space. The control resource set ID may indicate/identify a CORESET on which a search space may be located.

A wireless device, in an RRC idle state (e.g., RRC_IDLE) or in an RRC inactive state (e.g., RRC_INACTIVE), may periodically monitor POs for receiving paging message(s) for the wireless device. The wireless device, in an RRC idle state or an RRC inactive state and before monitoring the POs, may wake up at a time before each PO for preparation and/or to activate (e.g., turn on) all components in preparation of data reception (e.g., warm up stage). The gap between the waking up and the PO may be set to be sufficient to accommodate all the processing requirements. The wireless device may perform, after the warming up, timing acquisition from SSB and coarse synchronization, frequency and time tracking, time and frequency offset compensation, and/or calibration of local oscillator. The wireless device, after warm up, may monitor a PDCCH for a paging DCI via one or more PDCCH monitoring occasions. The wireless device may monitor the PDCCH, for example, based on configuration parameters of the PCCH configuration (e.g., as configured in SIB1). The configuration parameters of the PCCH configuration may be as described with respect to FIG. 25.

A base station may send/transmit one or more SSBs (e.g., periodically) to a wireless device or a plurality of wireless devices. The wireless device (in RRC idle state, RRC inactive state, or RRC connected state) may use the one or more SSBs for time and frequency synchronization with a cell of the base station. An SSB, comprising a PSS, a SSS, a PBCH, and/or a PBCH DM-RS, may be sent/transmitted (e.g., as described with respect to FIG. 11A). An SSB may occupy a quantity/number (e.g., 4, or any other quantity) of OFDM symbols. The base station may send/transmit one or more SSBs in an SSB burst (e.g., to enable beam-sweeping for PSS/SSS and PBCH). An SSB burst may comprise a set of SSBs, with each SSB potentially being transmitted via a corresponding different beam. SSBs, in the SSB burst, may be transmitted using time-division multiplexing. An SSB burst may be within a time window (e.g., a 5 ms window, or a window of any other duration) and may be either located in first-half or in the second-half of a radio frame (e.g., with a duration of 10 ms, or any other duration). An SSB burst may be equivalently referred to as a transmission window (e.g., 5 ms, or any other time duration) in which the set of SSBs are transmitted.

The base station may indicate a transmission periodicity of SSB via an RRC message (e.g., a SIB1 message). For example, the transmission periodicity may be indicated using parameter ssb-PeriodicityServingCell as present in ServingCellConfigCommonSIB of a SIB1 message (e.g., as shown in FIG. 25). A candidate value of the transmission periodicity may be in a range of {5 ms, 10 ms, 20 ms, 40 ms, 80 ms, 160 ms}. The transmission periodicity may have any other value. A maximum quantity/number of candidate SSBs (Lₘₐₓ) within an SSB burst may depend on a carrier frequency/band of the cell. For example, Lₘₐₓ=4 if f_{c}<=3 GHZ. Lₘₐₓ=8 if 3 GHz<f_{c}<=6 GHz. Lₘₐₓ=64 if f_{c}>=6 GHZ, etc., wherein f_{c} may be the carrier frequency of the cell. A starting OFDM symbol indicator/index, of a candidate SSB (e.g., occupying 4 OFDM symbols) within an SSB burst (e.g., comprised in a 5 ms time window), may depend on an SCS and a carrier frequency band of the cell.

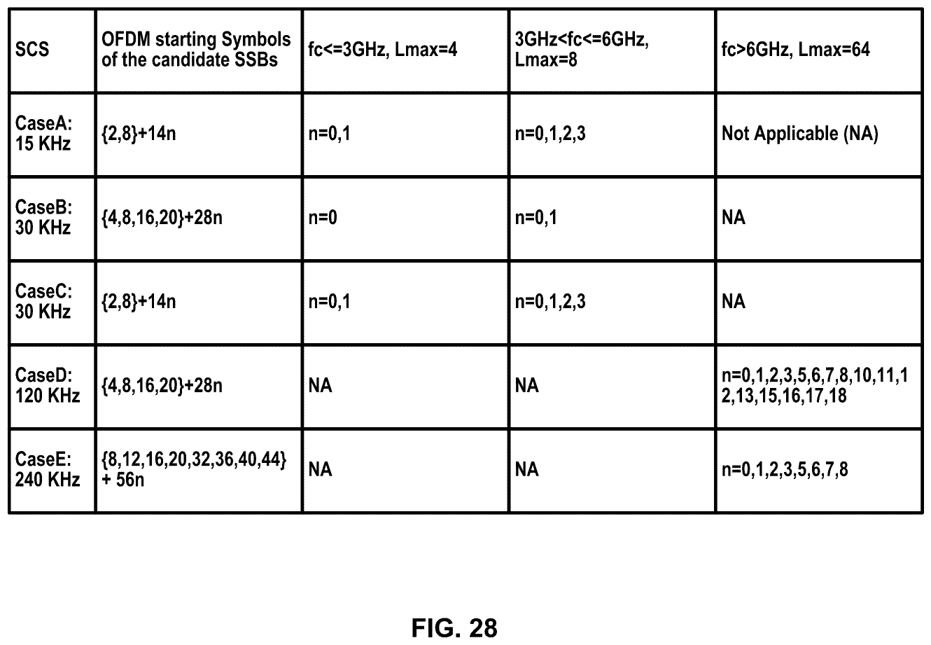

FIG. 28 shows an example of SSB configurations. FIG. 28 shows an example table for determination of a starting OFDM symbol index of candidate SSBs. OFDM starting symbols may be determined as a function of a SCS and carrier frequency. For example, starting OFDM symbol indexes of SSBs in an SSB burst, for a cell configured with 15 kHz SCS and carrier frequency fc<3 GHZ (e.g., Lₘₐₓ=4), may be 2, 8, 16, and 22. OFDM symbols in a half-frame may be indexed with the first symbol of the first slot being indexed as 0. Starting OFDM symbol indexes of SSBs in an SSB burst, for a cell configured with 15 kHz and carrier frequency 3 GHz<fc<6 GHZ (Lₘₐₓ=8) may be 2, 8, 16, 22, 30, 36, 44 and 50. Starting OFDM symbol indexes for other SCSs and carrier frequencies may be similarly determined in accordance with the table shown in FIG. 28. The base station may send/transmit only one SSB by using the first SSB starting position, for example, if the base station is not transmitting the SSBs with beam forming.

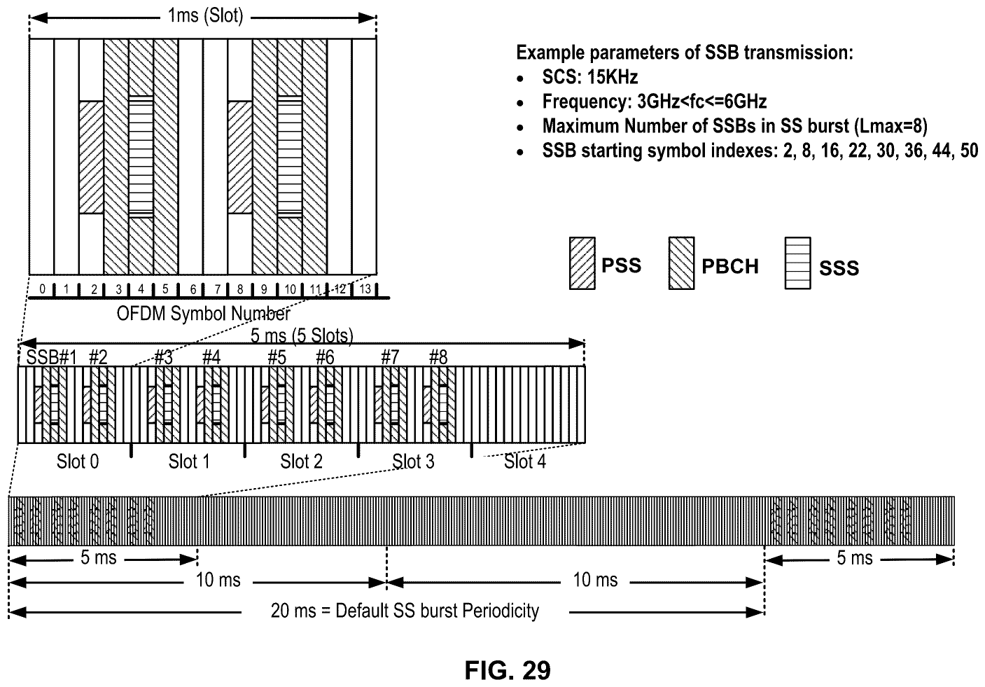

FIG. 29 shows an example of SSB transmissions of a base station. An SCS of the cell may be 15 kHz, and the cell may be configured with carrier frequency f_{c}, such that 3 GHz<fc<=6 GHz. A maximum quantity of candidate SSBs in an SSB burst may be 8 (Lₘₐₓ=8), for example, based on the value of f_{c}. Starting symbols for SSB transmission may be determined in accordance with the table shown in FIG. 28. SSB #1 may start at symbol 2 (of 70 symbols included in 5 ms half-frame), SSB #2 may start at symbol #8, SSB #3 may start at symbol #16, SSB #4 may start at symbol #22, SSB #5 may start at symbol #30, SSB #6 may start at symbol #36, SSB #7 may start at symbol #44, and SSB #8 may start at symbol 50. The SSB burst may be transmitted in the first half (and not the second half) of a radio frame (with 10 ms duration).

The SSB burst (and each SSB of the SSB burst) may be sent/transmitted with a periodicity. A default periodicity of an SSB burst may be 20 ms (e.g., as shown in FIG. 29, or any other duration of time). The default transmission periodicity may be a periodicity, for example, before a wireless device may receive a SIB1 message for initial access of the cell. For example, the base station, with 20 ms transmission periodicity of SSB (or SSB burst), may send/transmit the SSB burst in the first 5 ms of each 20 ms period. The base station may not send/transmit the SSB burst in the rest 15 ms of the each 20 ms period.

A base station may send/transmit RRC messages (e.g., SIB1 messages) indicating cell specific configuration parameters of SSB transmission. The cell specific configuration parameters may comprise a value for a transmission periodicity (e.g., parameter ssb-PeriodicityServingCell) of an SSB burst and locations (e.g., presence) of SSBs (e.g., active SSBs), of a plurality of candidate SSBs, in the SSB burst. The plurality of candidate SSBs (e.g., starting symbols of candidate SSBs) may be determined as described with respect to FIG. 28. The cell specific configuration parameters may comprise a position indication of an SSB in an SSB burst (e.g., parameter ssb-PositionsInBurst). The position indication may comprise a first bitmap (e.g., groupPresence) and a second bitmap (e.g., inOneGroup) indicating locations/presence of SSBs in an SSB burst.

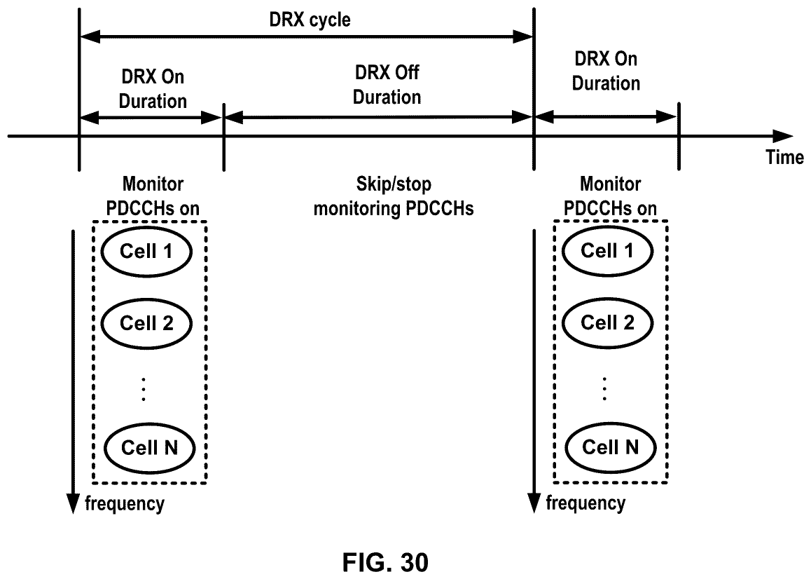

FIG. 30 shows an example of DRX configuration for a wireless device. A base station may send (e.g., transmit) an RRC message comprising one or more DRX parameters of a DRX cycle. The one or more parameters may comprise a first parameter and/or a second parameter. The first parameter may indicate a first time/window value of the DRX Active state (e.g., DRX on duration) of the DRX cycle. The second parameter may indicate a second time of the DRX Sleep state (e.g., DRX Off duration) of the DRX cycle. The one or more parameters may further comprise a time duration of the DRX cycle. For the DRX Active state, the wireless device may monitor PDCCHs for detecting one or more DCIs on a serving cell. For the DRX Sleep state, the wireless device may stop monitoring PDCCHs on the serving cell. The wireless device may monitor all PDCCHs on (or for) the multiple cells for the DRX Active state, for example, if multiple cells are in active state. For the DRX off duration, the wireless device may stop monitoring all PDCCH on (or for) the multiple cells. The wireless device may repeat the DRX operations according to the one or more DRX parameters.

DRX may be beneficial to the base station. The wireless device may be sending (e.g., transmitting) periodic CSI and/or SRS frequently (e.g., based on the configuration), for example, if DRX is not configured. With DRX, for DRX OFF periods, the wireless device may not send (e.g., transmit) periodic CSI and/or SRS. The base station may assign these resources to the other wireless devices to improve resource utilization efficiency.

The MAC entity may be configured by RRC with a DRX functionality that controls the wireless device's downlink control channel (e.g., PDCCH) monitoring activity for a plurality of RNTIs for the MAC entity. The plurality of RNTIs may comprise at least one of: C-RNTI; CS-RNTI; INT-RNTI; SP-CSI-RNTI; SFI-RNTI; TPC-PUCCH-RNTI; TPC-PUSCH-RNTI; Semi-Persistent Scheduling C-RNTI; cIMTA-RNTI; SL-RNTI; SL-V-RNTI; CC-RNTI; or SRS-TPC-RNTI. The MAC entity may monitor the PDCCH discontinuously using the DRX operation (e.g., if DRX is configured), for example, based on being RRC_CONNECTED; otherwise the MAC entity may monitor the PDCCH continuously.

RRC may control DRX operation by configuring a plurality of timers. The plurality of timers may comprise: a DRX On duration timer (e.g., drx-onDurationTimer); a DRX inactivity timer (e.g., drx-InactivityTimer); a downlink DRX HARQ round trip time (RTT) timer (e.g., drx-HARQ-RTT-TimerDL); an uplink DRX HARQ RTT Timer (e.g., drx-HARQ-RTT-TimerUL); a downlink retransmission timer (e.g., drx-Retransmission TimerDL); an uplink retransmission timer (e.g., drx-RetransmissionTimerUL); one or more parameters of a short DRX configuration (e.g., drx-ShortCycle and/or drx-ShortCycleTimer)) and one or more parameters of a long DRX configuration (e.g., drx-LongCycle). Time granularity for DRX timers may be in terms of PDCCH subframes (e.g., indicated as psf in the DRX configurations), and/or in terms of milliseconds.

Based on a DRX cycle being configured, the Active Time of the DRX operation may include the time for which at least one timer is running. The at least one timer may comprise drx-onDurationTimer, drx-InactivityTimer, drx-RetransmissionTimerDL, drx-RetransmissionTimerUL, and/or mac-ContentionResolutionTimer. For the Active time of the DRX operation, the wireless device may monitor PDCCH with RNTI(s) impacted by the DRX operation. The RNTIs may comprise C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and/or AI-RNTI.

A timer (e.g., a drx-Inactivity-Timer) may specify a time duration for which the wireless device may be active, for example, after successfully decoding a PDCCH indicating a new transmission (UL or DL or SL). This timer may be restarted upon receiving PDCCH for a new transmission (UL or DL or SL). The wireless device may transition to a DRX mode (e.g., using a short DRX cycle or a long DRX cycle), for example, based on the expiry of this timer. a cycle (e.g., a drx-ShortCycle) may be a first type of DRX cycle (e.g., if configured) that needs to be followed, for example, if the wireless device enters DRX mode. An IE (e.g., a DRX-Config IE) may indicate the length of the short cycle. A timer (e.g., a drx-ShortCycleTimer) may be expressed as multiples of a cycle (e.g., a shortDRX-Cycle). The timer may indicate the number of initial DRX cycles to follow the short DRX cycle, for example, before entering the long DRX cycle. A timer (e.g., a drx-onDurationTimer) may specify the time duration at the beginning of a DRX Cycle (e.g., DRX ON). A timer (e.g., a drx-onDuration Timer) may indicate the time duration, for example, before entering the sleep mode (DRX OFF). A timer (e.g., a drx-HARQ-RTT-TimerDL) may specify a minimum duration from the time new transmission is received and, for example, before the wireless device may expect a retransmission of a same packet. This timer may be fixed and may not be configured by RRC. A timer (e.g., a drx-RetransmissionTimerDL) may indicate a maximum duration for which the wireless device may be monitoring PDCCH, for example, if a retransmission from the eNodeB is expected by the wireless device.

The Active Time may comprise the time for which a Scheduling Request is sent on PUCCH and is pending, for example, based on (e.g., after or in response to) a DRX cycle being configured. Based on (e.g., after or in response to) a DRX cycle being configured, the Active Time may comprise the time for which an uplink grant for a pending HARQ retransmission can occur and there is data in the corresponding HARQ buffer for synchronous HARQ process. The Active Time may comprise the time for which a PDCCH may indicate a new transmission addressed to the C-RNTI of the MAC entity has not been received, for example, after successful reception of a Random Access Response for the preamble not selected by the MAC entity, for example, based on a DRX cycle being configured.

A timer, such as a DL HARQ RTT Timer (e.g., drx-HARQ-RTT-TimerDL), may expire in a subframe and the data of the corresponding HARQ process may not be successfully decoded. The MAC entity may start the timer (e.g., the drx-RetransmissionTimerDL) for the corresponding HARQ process. A UL HARQ RTT Timer (e.g., drx-HARQ-RTT-TimerUL) may expire in a subframe. The MAC entity may start the timer (e.g., the drx-RetransmissionTimerUL) for the corresponding HARQ process.

A wireless device may receive a DRX Command MAC CE and/or a Long DRX Command MAC CE (e.g., based on examples described herein with respect to FIG. 19). The MAC entity of the wireless device may stop a timer (e.g., a drx-onDuration Timer) and/or stop another timer (e.g., drx-InactivityTimer), for example, based on receiving the DRX Command MAC CE and/or the long DRX Command MAC CE. The MAC entity may start or restart a timer (e.g., a drx-ShortCycleTimer) and/or may use a cycle (e.g., Short DRX Cycle), for example, if an inactivity timer (e.g., drx-InactivityTimer) expires and/or if the cycle is being configured. For example, the MAC entity may use a cycle (e.g., the Long DRX cycle).

A timer (e.g., a drx-ShortCycleTimer) may expire in a subframe. The MAC entity may use a cycle (e.g., the Long DRX cycle). A Long DRX Command MAC control element may be received. The MAC entity may stop a timer (e.g., a drx-ShortCycleTimer) and may use the Long DRX cycle.

The wireless device may start a timer (e.g., a drx-onDuration Timer), for example, after a value (e.g., drx-SlotOffset) from the beginning of the subframe, wherein drx-SlotOffset may be a value (configured in the DRX configuration parameters) indicating a delay, for example, before starting the drx-onDurationTimer, for example, if the Short DRX Cycle is used and [(SFN*10)+subframe number] modulo (drx-ShortCycle)=(drxStartOffset) modulo (drx-ShortCycle). The wireless device may start a timer (e.g., drx-onDurationTimer), for example, after a value (e.g., drx-SlotOffset) from the beginning of the subframe, wherein drx-SlotOffset may be a value (configured in the DRX configuration parameters) indicating a delay, for example, before starting the drx-onDurationTimer, for example, if the Long DRX Cycle is used and [(SFN*10)+subframe number] modulo (drx-longCycle)=drxStartOffset.

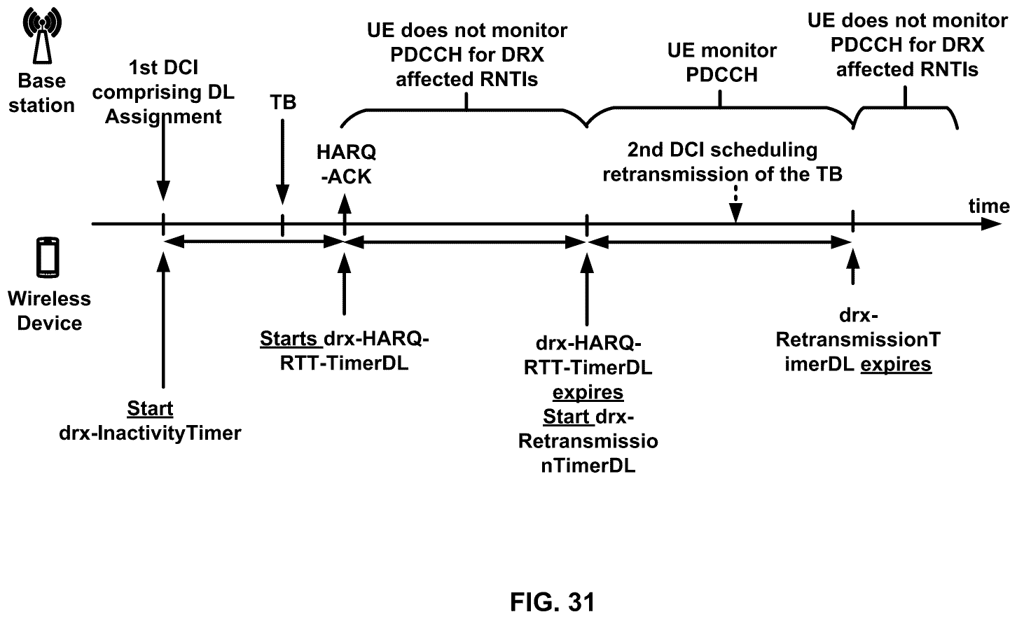

FIG. 31 shows an example of DRX configuration for a wireless device. A base station may send (e.g., transmit) an RRC message comprising configuration parameters of DRX operation. The configuration parameters may comprise a first timer value for a DRX inactivity timer (e.g., drx-InactivityTimer), a second timer value for a HARQ RTT timer (e.g., drx-HARQ-RTT-TimerDL, drx-HARQ-RTT-TimerUL), a third timer value for a HARQ retransmission timer (e.g., drx-RetransmissionTimerDL and/or drx-RetransmissionTimerUL).

A base station may send (e.g., transmit), via a PDCCH, DCI (e.g., first DCI) comprising downlink assignment for a TB, to a wireless device (such as shown in FIG. 31). The wireless device may start the drx-InactivityTimer, for example, based on (e.g., after or in response to) receiving the DCI. The wireless device may monitor the PDCCH, for example, for a timer (e.g., the drx-InactivityTimer) running. The wireless device may receive a TB based on receiving the DCI. The wireless device may send (e.g., transmit) a NACK to the base station upon unsuccessful decoding the TB. The wireless device may start a HARQ RTT Timer (e.g., drx-HARQ-RTT-TimerDL) in the first symbol, for example, after the end of sending (e.g., transmitting) the NACK. The wireless device may stop a retransmission timer (e.g., the drx-RetransmissionTimerDL) for a HARQ process corresponding to the TB. The wireless device may stop monitoring the PDCCH for one or more RNTI(s) impacted by the DRX operation, for example, for the HARQ RTT Timer running. The one or more RNTI(s) may comprise C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and/or AI-RNTI.

The wireless device may monitor the PDCCH and start a HARQ retransmission timer (e.g., drx-RetransmissionTimerDL), for example, if the HARQ RTT Timer expires (such as shown in FIG. 31). The wireless device, for monitoring the PDCCH, may receive second DCI (e.g., second DCI in FIG. 31) scheduling retransmission of the TB, for example, if the HARQ retransmission timer is running. The wireless device may stop monitoring the PDCCH, for example, if not receiving the second DCI (e.g., before the HARQ retransmission timer expires).

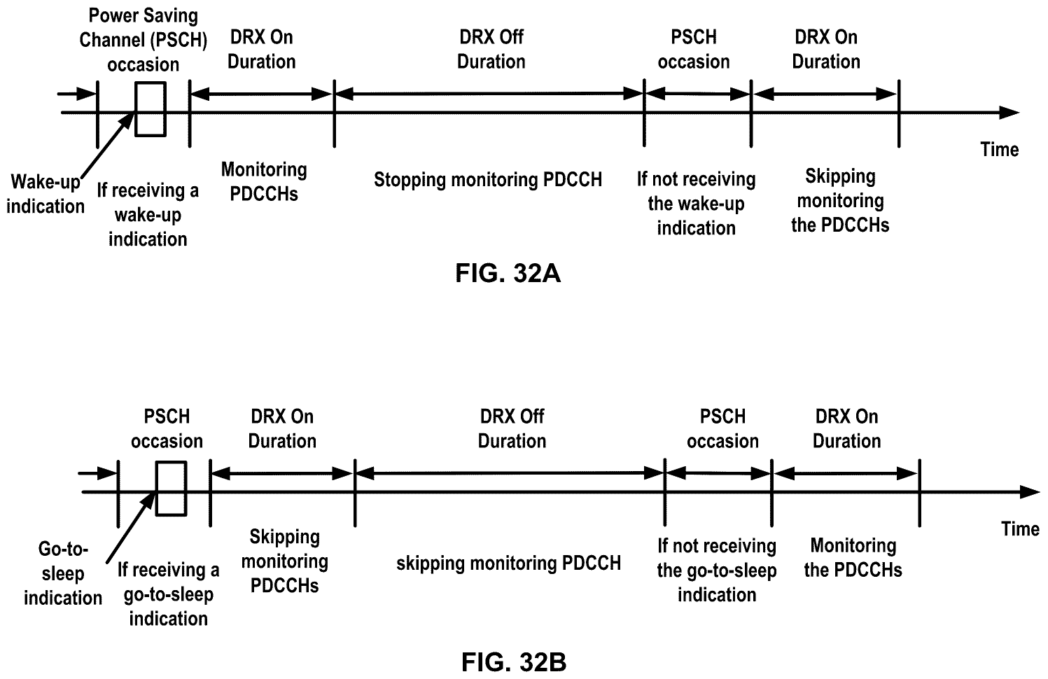

FIG. 32A shows an example power saving operation for a wireless device. The example power saving operation of FIG. 32A may be based on a wake-up indication. A base station may send/transmit one or more messages comprising parameters of a wake-up duration (e.g., a power saving duration, or a power saving channel (PSCH) occasion), to a wireless device. The wake-up duration may be located at (e.g., start from) a time that is a quantity/number of slots (or symbols) before a DRX ON duration of a DRX cycle. The quantity/number of slots (or symbols) may be a gap between a wake-up duration and a DRX ON duration. A DRX cycle may be implemented based on examples, such as described with respect to FIG. 30. The quantity of slots may be configured in the one or more RRC messages or may be predefined as a fixed value. The gap may be used for at least one of: synchronization with the base station, measuring reference signals, and/or retuning RF parameters. The gap may be determined based on a capability of the wireless device and/or the base station. The parameters of the wake-up duration may be pre-defined without RRC configuration. The wake-up mechanism may be based on a wake-up indication (e.g., via a PSCH). The parameters of the wake-up duration may comprise at least one of: a PSCH channel format (e.g., numerology, DCI format, PDCCH format), a periodicity of the PSCH, a control resource set, and/or a search space of the PSCH. The wireless device may monitor the PSCH for receiving the wake-up signal during the wake-up duration, for example, if configured with the parameters of the wake-up duration. The wireless device may monitor the PSCH for detecting a wake-up indication during the PSCH occasion/wake-up duration, for example, if configured with the parameters of the PSCH occasion. The wireless device may wake up to monitor PDCCHs in a DRX active time (e.g., comprising DRX ON duration) of a next DRX cycle according to the DRX configuration, for example, based on/in response to receiving the wake-up signal/channel (or a wake-up indication via the PSCH). The wireless device may monitor PDCCHs in the DRX active time (e.g., when drx-onDuration Timer is running), for example, based on/in response to receiving the wake-up indication via the PSCH. The wireless device may go back to sleep if the wireless device does not receive PDCCH transmissions in the DRX active time. The wireless device may stay in a sleep state during the DRX OFF duration of the DRX cycle. The wireless device may skip monitoring PDCCHs in the DRX active time, for example, if the wireless device doesn't receive the wake-up signal/channel (or a wake-up indication via the PSCH) during the wake-up duration (or the PSCH occasion). The wireless device may skip monitoring PDCCHs in the DRX active time, for example, if the wireless device receives, during the wake-up duration (or the PSCH occasion), an indication indicating skipping PDCCH monitoring.

FIG. 32B shows an example power saving operation for a wireless device. The power saving operation of FIG. 32B may be based on go-to-sleep indication. The wireless device may go back to sleep and skip monitoring PDCCHs during the DRX active time (e.g., during a next DRX ON duration of a DRX cycle), for example, based on/in response to receiving a go-to-sleep indication via the PSCH. The wireless device may monitor PDCCH during the DRX active time, according to the configuration parameters of the DRX operation, for example, if the wireless device doesn't receive the go-to-sleep indication via the PSCH during the wake-up duration. The power saving mechanisms of FIG. 32A and FIG. 32B may reduce power consumption for PDCCH monitoring during the DRX active time.

A power saving operation may be based on combining the operations described with respect to FIG. 32A and FIG. 32B. A base station may send/transmit a power saving indication, in DCI via a PSCH, indicating whether the wireless device may wake up for a next DRX ON duration or skip the next DRX ON duration. The wireless device may receive the DCI via the PSCH. The wireless device may wake up for next DRX ON duration, for example, based on/in response to the power saving indication indicating that the wireless device may wake up for next DRX ON duration. The wireless device may monitor PDCCH in the next DRX ON duration in response to the waking up. The wireless device may go to sleep during or skip the next DRX ON duration, for example, based on/in response to the power saving indication indicating the wireless device may skip (or go to sleep) for next DRX ON duration. The wireless device may skip monitoring PDCCH in the next DRX ON duration, for example, based on/in response to the power saving indication indicating the wireless device shall go to sleep for next DRX ON duration. Various examples described with respect to FIG. 31, FIG. 32A, and/or FIG. 32B may be extended and/or combined to further improve power consumption of a wireless device and/or signaling overhead of a base station.

A base station may be equipped with multiple transmission reception points (TRPs) to improve spectrum efficiency and/or transmission robustness. The base station may transmit DL signals/channels via intra-cell multiple TRPs and/or via inter-cell multiple TRPs. A base station may be equipped with more than one TRP. A first TRP may be physically located at a different place from a second TRP. The first TRP may be connected with the second TRP via a backhaul link (e.g., wired link or wireless link), the backhaul link being ideal backhaul link with zero or neglectable transmission latency, or the backhaul link being non-ideal backhaul link. A first TRP may be implemented with antenna elements, RF chain and/or baseband processor independently configured/managed from a second TRP.

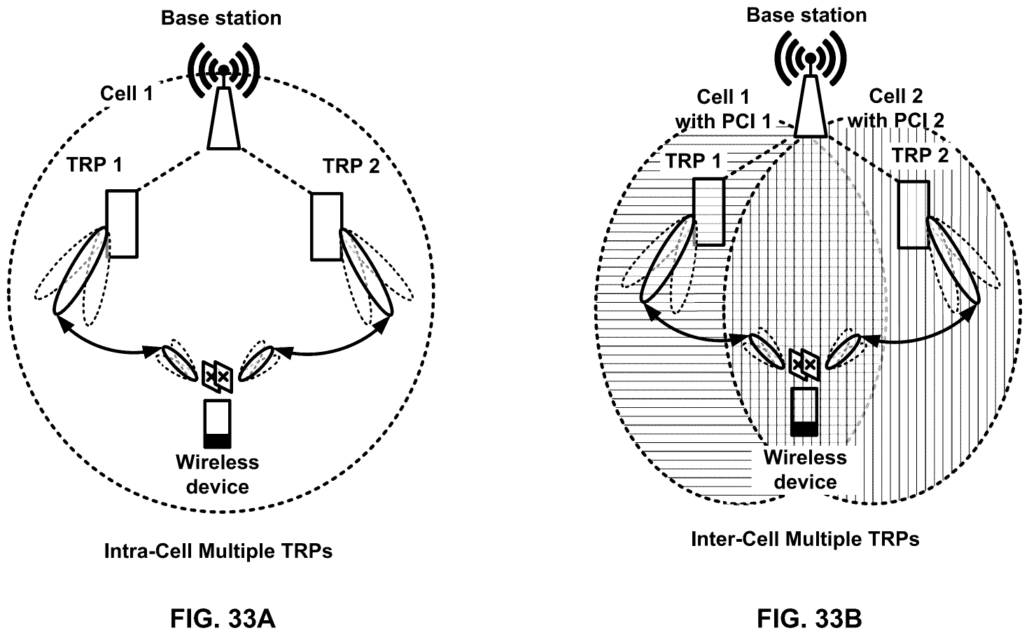

FIG. 33A and FIG. 33B show examples of multiple transmission and reception point (TRP) configurations. FIG. 33A shows an example of a communication between a base station (equipped with multiple TRPs) and a wireless device (equipped with single panel or multiple panels) based on intra-cell TRPs. Transmission and reception with multiple TRPs may improve system throughput and/or transmission robustness for a wireless communication in a high frequency (e.g., above 6 GHZ). The multiple TRPs may be associated with a same physical cell identifier (PCI). Multiple TRPs on which PDCCH/PDSCH/PUCCH/PUSCH resources of a cell are shared may be referred to as intra-cell TRPs (or intra-PCI TRPs).

A TRP of multiple TRPs of the base station may be indicated/identified by at least one of: a TRP identifier (ID), a virtual cell index, or a reference signal index (or group index). In an example, in a cell, a TRP may be identified by a control resource set (coreset) group (or pool) index (e.g., CORESETPoolIndex as shown in FIG. 26) of a coreset group from which DCI is transmitted from the base station on a coreset. A TRP ID of a TRP may comprise a TRP index indicated in the DCI. A TRP ID of a TRP may comprise a TCI state group index of a TCI state group. A TCI state group may comprise at least one TCI state with which the wireless device receives the downlink TBs, or with which the base station transmits the downlink TBs.

A base station may transmit to a wireless device one or more RRC messages comprising configuration parameters of a plurality of CORESETs on a cell (or a BWP of the cell). One of the plurality of CORESETs (e.g., each of the plurality of CORESETs) may be identified with a CORESET index and may be associated with (or configured with) a CORESET pool (or group) index. One or more CORESETs, of the plurality of CORESETs, having a same CORESET pool index may indicate that DCIs received on the one or more CORESETs are transmitted from a same TRP of a plurality of TRPs of the base station. The wireless device may determine receiving beams (or spatial domain filters) for PDCCHs/PDSCHs based on a TCI indication (e.g., DCI) and a CORESET pool index associated with a CORESET for the DCI.

A wireless device may receive multiple PDCCHs scheduling fully/partially/non-overlapped PDSCHs in time and frequency domain, for example, if the wireless device receives one or more RRC messages (e.g., PDCCH-Config IE) comprising a first CORESET pool index (e.g., CORESETPoolIndex) value and a second CORESET pool index in ControlResourceSet IE. The wireless device may determine the reception of full/partially overlapped PDSCHs in time domain only when PDCCHs that schedule two PDSCHs are associated to different ControlResourceSets having different values of CORESETPoolIndex.

A wireless device may assume (or determine) that the ControlResourceSet is assigned with CORESETPoolIndex as for 0 a ControlResourceSet without CORESETPoolIndex. Scheduling information for receiving a PDSCH is indicated and carried only by the corresponding PDCCH, for example, if the wireless device is scheduled with full/partially/non-overlapped PDSCHs in time and frequency domain. The wireless device may be expected to be scheduled with the same active BWP and the same SCS. A wireless device can be scheduled with at most two codewords simultaneously when the wireless device is scheduled with full/partially overlapped PDSCHs in time and frequency domain.

The wireless device may be allowed to the following operations, for example, if PDCCHs that schedule two PDSCHs are associated to different ControlResourceSets having different values of CORESETPoolIndex: for any two HARQ process IDs in a given scheduled cell, if the wireless device is scheduled to start receiving a first PDSCH starting in symbol j by a PDCCH associated with a value of CORESETpoolIndex ending in symbol i, the wireless device can be scheduled to receive a PDSCH starting earlier than the end of the first PDSCH with a PDCCH associated with a different value of CORESETpoolIndex that ends later than symbol i; in a given scheduled cell, the wireless device can receive a first PDSCH in slot i, with the corresponding HARQ-ACK assigned to be transmitted in slot j, and a second PDSCH associated with a value of CORESETpoolIndex different from that of the first PDSCH starting later than the first PDSCH with its corresponding HARQ-ACK assigned to be transmitted in a slot before slot j.

For example, if a wireless device configured by higher layer parameter PDCCH-Config that contains two different values of CORESETPoolIndex in ControlResourceSet, for both cases, when tei-PresentInDCI is set to ‘enabled’ and tci-PresentInDCI is not configured in RRC connected mode, for example, if the offset between the reception of the DL DCI and the corresponding PDSCH is less than the threshold timeDurationForQCL, the wireless device may assume that the DM-RS ports of PDSCH associated with a value of CORESETPoolIndex of a serving cell are quasi co-located with the RS(s) with respect to the QCL parameter(s) used for PDCCH quasi co-location indication of the CORESET associated with a monitored search space with the lowest CORESET-ID among CORESETs, which are configured with the same value of CORESETPoolIndex as the PDCCH scheduling that PDSCH, in the latest slot in which one or more CORESETs associated with the same value of CORESETPoolIndex as the PDCCH scheduling that PDSCH within the active BWP of the serving cell are monitored by the wireless device. For example, if the offset between the reception of the DL DCI and the corresponding PDSCH is less than the threshold timeDurationForQCL and at least one configured TCI states for the serving cell of scheduled PDSCH contains the ‘QCL-TypeD’, and at least one TCI codepoint indicates two TCI states, the wireless device may assume that the DM-RS ports of PDSCH of a serving cell are quasi co-located with the RS(s) with respect to the QCL parameter(s) associated with the TCI states corresponding to the lowest codepoint among the TCI codepoints containing two different TCI states.

FIG. 33B shows an example of a communication between a base station (equipped with multiple TRPs) and a wireless device (equipped with single panel or multiple panels) based on inter-cell TRPs (or inter-PCI TRPs). In this case, the multiple TRPs may be associated with different PCIs. The multiple TRPs may be associated with (or belong to) different physical cells (Cell 1 with PCI 1 and Cell 2 with PCI 2), which may be referred to as inter-cell TRPs (or inter-PCI TRPs). A cell may be a serving cell or a non-serving (neighbor) cell of the wireless device. A base station may configure Cell 2 with PCI 2 as a part of Cell 1 with PCI 1 (e.g., a second TRP with a second PCI different from a first PCI of a first TRP), in which case, the wireless device may receive first SSBs from Cell 1with PCI 1 and receive second SSBs from Cell 2 with PCI 2, for example, if operating the inter-cell TRPs for a wireless device. The first SSBs and the second SSBs may have different configuration parameters, wherein the configuration parameters may be implemented such as described herein with respect to FIG. 28, FIG. 29 and/or FIG. 30. With the inter-cell TRPs, the wireless device may receive PDCCHs/PDSCHs and/or transmit PUCCH/PUSCHs on Cell 1 with PCII and Cell 2 with PCI 2 with different TCI states (e.g., one being associated with one of the first SSBs, another being associated with one of the second SSBs, etc.).

A serving cell may be a cell (e.g., PCell, SCell, PSCell, etc.) on which the wireless device receives SSB/CSI-RS/PDCCH/PDSCH and/or transmits PUCCH/PUSCH/SRS etc. The serving cell may be identified by a serving cell index (e.g., ServCellIndex or SCellIndex configured in RRC message). For a wireless device in RRC_CONNECTED not configured with CA/DC, there may only be one serving cell comprising of the primary cell. For a wireless device in RRC_CONNECTED configured with CA/DC the term ‘serving cells’ may be used to denote the set of cells comprising of the Special Cell(s) and all secondary cells. For a wireless device configured with CA, a cell providing additional radio resources on top of Special Cell may be referred to as a secondary cell. A non-serving (or neighbor) cell may be a cell on which the wireless device does not receive MIBs/SIBs/PDCCH/PDSCH and/or does not transmit PUCCH/PUSCH/SRS etc. The non-serving cell may have a physical cell identifier (PCI) different from a PCI of a serving cell. The non-serving cell may not be identified by (or associated with) a serving cell index (e.g., ServCellIndex or SCellIndex). The wireless device may rely on a SSB of a non-serving cell for Tx/Rx beam (or spatial domain filter) determination (for PDCCH/PDSCH/PUCCH/PUSCH/CSI-RS/SRS for a serving cell, etc.), for example, if a TCI state of the serving cell is associated with (e.g., in TCI-state IE of TS 38.331) a SSB of the non-serving cell. The base station may not transmit RRC messages configuring resources of PDCCH/PDSCH/PUCCH/PUSCH/SRS of a non-serving cell for the wireless device.

For a specific wireless device, Cell 1 may be a serving cell and may be associated with a first TRP (TRP 1). Cell 2 may be a non-serving (or neighbor) cell and may be associated with a second TRP. A base station may transmit to a wireless device one or more RRC messages comprising configuration parameters of Cell 1. The configuration parameters of Cell 1 may indicate a plurality of additional PCI configurations (e.g., SSB-MTC-AdditionalPCI IE) for a plurality of (non-serving or neighbor) cells for cell 1, each additional PCI configuration corresponding to a (non-serving or neighbor) cell having a PCI different from the PCI value of the serving cell, and comprising: an additional PCI index (AdditionalPCIIndex) identifying the additional PCI configuration, a PCI of the non-serving cell, a SSB periodicity indication, position indications of (candidate) SSBs in a SSB burst, a transmission power indication of SSBs, etc. The configuration parameter of Cell 1 may further indicate a plurality of TCI states. A TCI state (e.g., each TCI state) of the plurality of TCI states may be associated with one or more TCI parameters comprising a TCI state identifier identifying the TCI state, one or more QCL information parameters comprising a SSB index identifying the SSB and a QCL type indicator indicating a QCL type of a plurality of QCL types, for example, if the SSB is transmitted via Cell 1 (or in another serving cell). For example, if a SSB of a TCI state is transmitted via a non-serving (neighbor) cell, the TCI state may be further associated with an additional PCI index (AdditionalPCIIndex) indicating a (non-serving or neighbor) cell configured in the SSB-MTC-AdditionalPCI IE. Similar to intra-cell multiple TRPs, the wireless device may receive downlink signals and/or transmit uplink signals based on a TCI state (activated/indicated) associated with a TRP. A difference between intra-cell multiple TRPs and inter-cell multiple TRPs may be that a reference RS of a TCI state for a serving cell may come from (or be transmitted via) a (non-serving or neighbor) cell for the latter cases. A SSB may be implemented based on examples described herein with respect to FIG. 28, FIG. 29 and/or FIG. 30.

Cell 1 may be a serving cell for a wireless device. Cell 2 may be a (non-serving or neighbor) cell associated with Cell 1 for the wireless device. Cell 2 may be a serving cell for a second wireless device. Cell 1 may be a (non-serving or neighbor) cell for the second wireless device. Different wireless devices may have different serving cells and non-serving/neighbor cells.

The base station may use both TRPs for transmissions via Cell 1 to a wireless device. The base station may indicate (by DCI/MAC CE) a first TCI state associated with an SSB/CSI-RS transmitted via Cell 1 (or another serving cell) for a first transmission (via PDCCH/PDSCH/PUSCH/PUCCH/SRS resources of Cell 1) to the wireless device. The base station may indicate (by the same DCI/MAC CE or another DCI/MAC CE) a second TCI state associated with a second SSB transmitted via Cell 2 (which is the non-serving/neighbor) cell indicated by AdditionalPCIIndex in TCI configuration parameters) for a second transmission (via PDCCH/PDSCH/PUSCH/PUCCH/SRS resources of Cell 1) to the wireless device. The second SSB transmitted via Cell 2 may be different from the first SSB transmitted via Cell 1. Using two TCI states from two TRPs (one may be from a serving cell and another may be from a non-serving/neighbor cell) may avoid executing time-consuming handover (HO) between Cell 1 to Cell 2 and improve coverage if the wireless device is moving at the edge of Cell 1 and Cell 2.

A wireless device may be provided two TCI states, each TCI state corresponding to a TRP of multiple TRPs (e.g., such as described with respect to FIG. 33A and FIG. 33B). A TCI state may be referred to as a channel-specific TCI state, when the TCI state is used for a specific channel (e.g., PDSCH/PDCCH/PUCCH/PUSCH), where different channels may be associated with different channel-specific TCI states. A TCI state may be referred to as a unified TCI state, when the TCI state is used for multiple channels (e.g., PDSCH/PDCCH/PUCCH/PUSCH), where different channels may be associated with the same unified TCI state. The base station may transmit RRC messages indicating whether a TCI state is a unified TCI state for the wireless device.

A base station may perform data/signaling transmissions based on intra-cell multiple TRPs (e.g., which may be referred to as Intra-cell M-TRP or Intra-PCI M-TRP) for a wireless device, for example, if the wireless device is close to the center of a cell, has more data to deliver and/or requires high reliability (e.g., for URLLC service), for example, such as described with respect to FIG. 33A and FIG. 33B. The base station may perform data/signaling transmissions based on inter-cell multiple TRPs (e.g., which may be referred to as Inter-cell M-TRP or Inter-PCI M-TRP) for a wireless device, for example, when the wireless device is at the edge of a cell and is (moving or located) in the coverage of another cell (which may be or may not be a serving cell of the wireless device).

In at least some technologies, a base station may enable a power saving operation for a wireless device due to limited battery capacity of the wireless device, for example, based on BWP management, SCell dormancy mechanism, wake-up/go-to-sleep indication associated with DRX (e.g., based on example embodiments described above with respect to FIG. 32A and/or FIG. 32B), SSSG switching on an active BWP, and/or PDCCH skipping.

A base station may not be able to save energy from the viewpoint of the base station, (e.g., if the base station is required to send/transmit some always-on downlink signals periodically (e.g., SSB, MIB, SIB1, SIB2, periodic CSI-RS, etc.) in some time period even for which there is no active wireless device sending/transmitting to and/or receiving from the base station), for example, if indicating a power saving operation for a wireless device. The base station may be required to send/transmit some always-on downlink signals periodically (e.g., SSB, MIB, SIB1, SIB2, periodic CSI-RS, etc.), for example, if the base station transitions a cell into a dormant state by switching an active BWP to a dormant BWP of the cell.

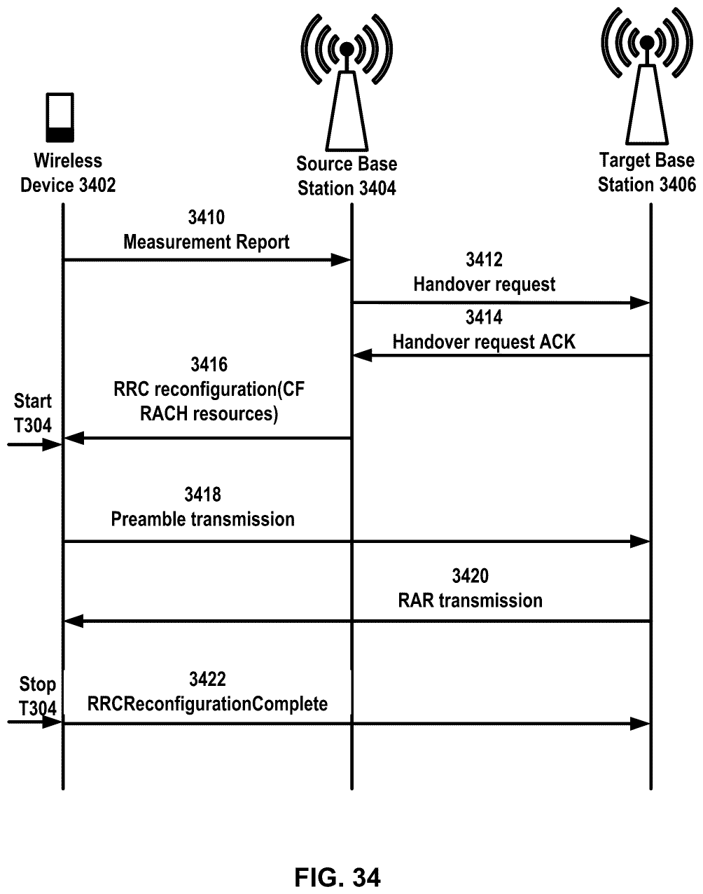

A base station may send/transmit an RRC message (e.g., SIB1) indicating a longer periodicity for the always-on downlink signal transmission, for example, if the base station needs to reduce periodicity of the always-on downlink signal transmission. A base station may send/transmit RRC reconfiguration messages to a wireless device in a source cell (e.g., each wireless device in a source cell) to indicate a handover to a neighbor cell, for example, before determining to power off (e.g., both RF modules and base band units (BBUs)) for energy saving. A handover (HO) procedure may be implemented (e.g., such as described herein with respect to FIG. 34).

A cell in a network energy saving state may be referred to as a network-energy-saving (NES) cell. A base station may send (e.g., transmit) less power, less bandwidth, less antenna ports/TRPs, less PDSCH/PDCCH via a NES cell. A non-NES cell may be a cell which is not operating in a NES state. A base station may send (e.g., transmit) full power, full bandwidth, more channels via a non-NES cell.

FIG. 34 shows an example of layer 3 based handover procedure. FIG. 34 shows an example of executing HO procedure from a source base station (e.g., gNB) to a target base station for a wireless device.

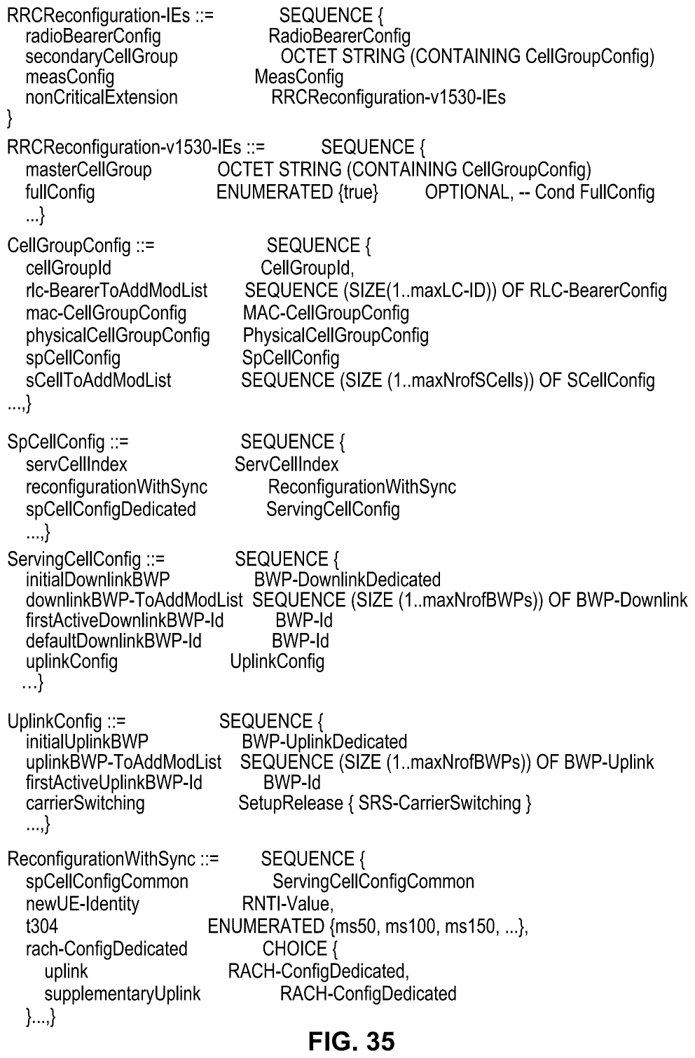

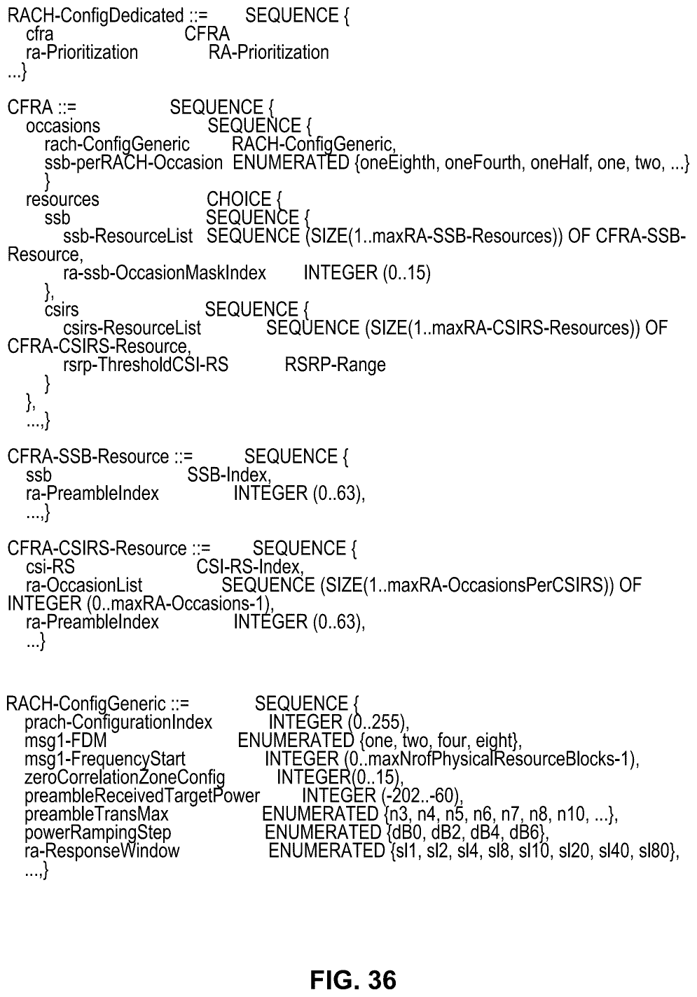

For network-controlled mobility in RRC_CONNECTED, the PCell may be changed using an RRC connection reconfiguration message (e.g., RRCReconfiguration) including reconfigurationWithSync (in NR specifications) or mobilityControlInfo in LTE specifications (handover). The SCell(s) may be changed using the RRC connection reconfiguration message either with or without the reconfiguration WithSync or mobilityControlInfo. The network may trigger the HO procedure, for example, based on radio conditions, load, QoS, UE category, and/or the like. The RRC connection reconfiguration message may be implemented such as described herein with respect to FIG. 35 and FIG. 36.

The network may configure the wireless device to perform measurement reporting (possibly including the configuration of measurement gaps (MG)). The measurement reporting is a layer 3 reporting, different from layer 1 CSI reporting. The wireless device (e.g., wireless device 3402) may transmit one or more measurement reports 3410 to the source base station (e.g., source gNB/base station 3404) (and/or source PCell). The network may initiate HO blindly, for example without having received measurement reports from the wireless device. The source base station (e.g., gNB) may prepare one or more target cells, for example, before sending the HO message to the wireless device. The source base station (e.g., gNB) may select a target PCell.

The source base station (e.g., gNB) may provide the target base station (e.g., target base station 3406) with a list of best cells on each frequency for which measurement information is available (e.g., in order of decreasing RSRP values), for example, based on the one or more measurement reports from the wireless device. The source base station may also include available measurement information for the cells provided in the list. The target base station may decide which cells are configured for use after HO, which may include cells other than the ones indicated by the source base station. The source base station may transmit a HO request 3412 to the target base station. The target base station may response with a HO message 3414 (e.g., Handover request ACK). In the HO message, the target base station may indicate access stratum configuration to be used in the target cell(s) for the wireless device.

The source base station (e.g., gNB) may transparently (e.g., by not altering values/content) forward the HO message/information received from the target base station to the wireless device. In the HO message, RACH resource configuration may be configured for the wireless device to access a cell in the target base station. When appropriate, the source base station may initiate data forwarding for (a subset of) the dedicated radio bearers.

The wireless device may start a HO timer (e.g., T304) with an initial timer value, for example, after receiving the HO message. The HO timer may be configured in the HO message. Based on the HO message, the wireless device may apply the RRC parameters of a target PCell and/or a cell group (MCG/SCG) associated with the target PCell of the target base station and perform downlink synchronization to the target base station. After or in response to performing downlink synchronization (e.g., searching a suitable/detectable SSB from candidate SSBs configured on the target base station, such as described with respect to FIG. 28 and/or FIG. 29) to the target base station, the wireless device may initiate a random access (e.g., contention-free, or contention-based, such as described with respect to FIG. 13A, FIG. 13B and/or FIG. 13C) procedure attempting to access the target base station (e.g., gNB) at the available RACH occasion according to a RACH resource selection, where the available RACH occasion may be configured in the RACH resource configuration (e.g., such as described herein with respect to FIG. 36). RAN may ensure the preamble is available from the first RACH occasion the wireless device may use, for example, if allocating a dedicated preamble for the random access in the target base station (e.g., gNB).

The wireless device may activate the uplink BWP configured with firstActiveUplinkBWP-id and/or the downlink BWP configured with firstActiveDownlinkBWP-id on the target PCell upon performing HO to the target PCell. The wireless device may perform UL synchronization by conducting RACH procedure, for example, based on applying the RRC parameters of a target PCell and/or completing the downlink synchronization with the target PCell (e.g., such as described with respect to FIG. 13A, FIG. 13B and/or FIG. 13C). The performing UL synchronization may comprise transmitting a preamble via an active uplink BWP (e.g., a BWP configured as firstActiveUplinkBWP-id such as described with respect to FIG. 35) of uplink BWPs of the target PCell, monitoring PDCCH on an active downlink BWP (e.g., a BWP configured as firstActiveDownlinkBWP-id such as described with respect to FIG. 35) for receiving a RAR comprising a TA which is used for PUSCH/PUCCH transmission via the target PCell, receiving the RAR and/or obtaining the TA. The wireless device may obtain the TA to be used for PUSCH/PUCCH transmission via the target PCell, for example, based on (e.g., after) completing the UL synchronization. The wireless device, for example, by using the TA to adjust uplink transmission timing, may transmit PUSCH/PUCCH via the target PCell. The adjusting uplink transmission timing may comprise advancing or delaying the transmissions by an amount indicated by a value of the TA, for example, to ensure the uplink signals received at the target PCell are aligned (in time domain) with uplink signals transmitted from other wireless devices.

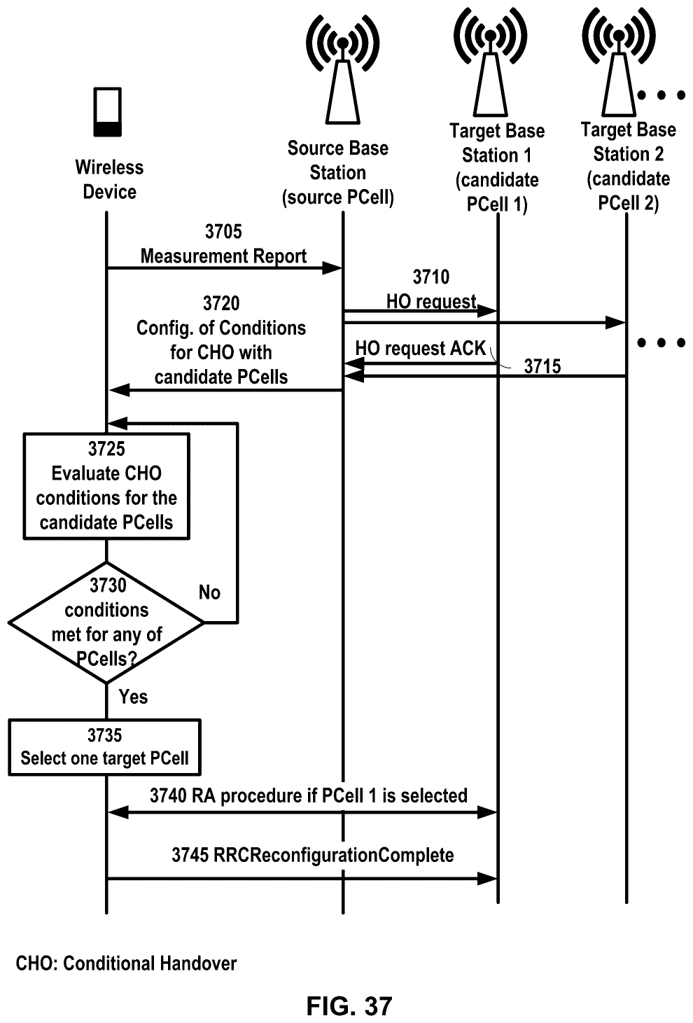

The wireless device may release RRC configuration parameters of the source PCell and an MCG/SCG associated with the source PCell. A HO triggered by receiving a RRC reconfiguration message 3416 (e.g., RRCReconfiguration) comprising the HO command/message (e.g., by including reconfiguration WithSync (in NR specifications) or mobilityControlInfo in LTE specifications (handover)) is referred to as a normal HO, an unconditional HO, which is in contrast with a conditional HO (CHO) which is described herein with respect to FIG. 37.

The wireless device may send (e.g., transmit) a preamble 3418 to the target base station (e.g., gNB) via a RACH resource. The RACH resource may be selected from a plurality of RACH resources (e.g., configured in rach-ConfigDedicated IE such as descried with respect to FIG. 35 and FIG. 36) based on SSBs/CSI-RSs measurements of the target base station. The wireless device may select a (best) SSB/CSI-RS of the configured SSBs/CSI-RSs of the target base station (e.g., gNB). The wireless device may select a SSB/CSI-RS, from the configured SSBs/CSI-RSs of the target base station (e.g., gNB), with a RSRP value greater than a RSRP threshold configured for the RA procedure. The wireless device then determines a RACH occasion (e.g., time domain resources, etc.) associated with the selected SSB/CSI-RS and determines the preamble associated with the selected SSB/CSI-RS.

The target base station (e.g., gNB) may receive the preamble transmitted from the wireless device. The target base station may transmit a random access response (RAR) 3420 to the wireless device, where the RAR comprises the preamble transmitted by the wireless device. The RAR may further comprise a TAC to be used for uplink transmission via the target PCell. The wireless device may complete the random access procedure, for example, based on (e.g., in response to) receiving the RAR comprising the preamble. The wireless device may stop the HO timer (T304), for example, based on (e.g., in response to) completing the random access procedure. The wireless device may transmit an RRC reconfiguration complete message 3422 to the target base station, after completing the random access procedure, or before completing the random access procedure. The wireless device, after completing the random access procedure towards the target base station, may apply first parts of CQI reporting configuration, SR configuration and SRS configuration that do not require the wireless device to know a system frame number (SFN) of the target base station. The wireless device may apply second parts of measurement and radio resource configuration that require the wireless device to know the SFN of the target base station (e.g., MGs, periodic CQI reporting, SR configuration, SRS configuration), upon acquiring the SFN of the target base station, for example, based on (e.g., after or in response to) completing the random access procedure towards the target PCell.

For network energy saving purposes, a base station may instruct each wireless device in a source cell to perform a 4-step or 2-step RACH-based (contention free) HO to a neighbor cell, for example, based on HO procedure. After the wireless devices complete the HO procedure to neighbor cells, the base station may turn off (RF parts and BBUs, etc.) for energy saving.

FIG. 35 shows an example of a radio resource control (RRC) message for layer 3 based handover. FIG. 35 shows an example of RRC message for HO. A base station may transmit, and/or a wireless device may receive, an RRC reconfiguration message (e.g., RRCReconfiguration-IEs) indicating an RRC connection modification. It may convey information for measurement configuration, mobility control, radio resource configuration (including RBs, MAC main configuration and physical channel configuration) and AS security configuration. The RRC reconfiguration message may comprise a configuration of a master cell group (masterCellGroup). The master cell group may be associated with a SpCell (SpCellConfig). When the SpCellConfig comprises a reconfiguration with Sync (reconfiguration WithSync), the wireless device determines that the SpCell is a target PCell for the HO. The reconfiguration with sync (reconfiguration WithSync) may comprise cell common parameters (spCellConfigCommon) of the target PCell, a RNTI (newUE-Identity) identifying the wireless device in the target PCell, a value of T304, a dedicated RACH resource (rach-ConfigDedicated), etc. In an example, a dedicated RACH resource may comprise one or more RACH occasions, one or more SSBs, one or more CSI-RSs, one or more RA preamble indexes, etc.

FIG. 36 shows an example of an RRC message for layer 3 based handover. FIG. 35 shows an example of RRC messages for RACH resource configuration for HO procedure. The reconfiguration WithSync IE comprises a dedicated RACH resource indicated by a rach-ConfigDedicated IE (e.g., such as described with respect to FIG. 35).

An IE such as a rach-ConfigDedicated IE (as shown in FIG. 36) may comprise a contention free RA resource indicated by a CFRA IE. The cfra IE may comprise a plurality of occasions indicated by a rach-ConfigGeneric IE, a ssb-perRACH-Occasion IE, a plurality of resources associated with SSB (indicated by a ssb IE) and/or CSI-RS (indicated by a csirs IE). An IE such as a ssb-perRACH-Occasion IE may indicate a number of SSBs per RACH occasion. An IE such as a rach-ConfigGeneric IE may indicate configuration of CFRA occasions. The wireless device may ignore preambleReceivedTargetPower, preamble TransMax, powerRampingStep, ra-Response Window signaled within this field and use the corresponding values provided in RACH-ConfigCommon.

The resources (resources IE) comprise the ssb IE (as shown in FIG. 36), for example, if the plurality of resources for the CFRA configured in the reconfiguration WithSync IE are associated with SSBs. The ssb IE may comprise a list of CFRA SSB resources (ssb-ResourceList) and an indication of PRACH occasion mask index (ra-ssb-OccasionMaskIndex). One or more of the list of CFRA SSB resources (e.g., each of the list of CFRA SSB resources) may comprise a SSB index, a RA preamble index, etc. The ra-ssb-OccasionMaskIndex may indicate a PRACH mask index for RA resource selection. The mask may be valid for all SSB resources signaled in ssb-ResourceList.

The resources (resources IE) may comprise the csirs IE, for example, if the plurality of resources for the CFRA configured in the reconfiguration WithSync IE are associated with CSI-RSs. The csirs IE may comprise a list of CFRA CSI-RS resources (csirs-ResourceList) and a RSRP threshold (rsrp-ThresholdCSI-RS). One or more of the list of CFRA CSI-RS resources (e.g., each of the list of CFRA CSI-RS resources) may comprise a CSI-RS index, a list of RA occasions (ra-OccasionList), a RA preamble index, etc.

Executing the HO triggered by receiving a RRC reconfiguration message comprising a reconfigurationWithSync IE may introduce HO latency (e.g., too-late HO), for example, if a wireless device is moving in a network deployed with multiple small cells (e.g., with hundreds of meters of cell coverage of a cell). An improved HO mechanism, based on measurement event triggering, is proposed to reduce the HO latency such as described herein with respect to FIG. 37.

FIG. 37 shows an example of layer 3 based conditional handover procedure. FIG. 37 shows an example of a conditional handover (CHO) procedure. In an example the network (e.g., a base station, a source gNB) may configure the wireless device to perform measurement reporting (possibly including the configuration of MGs) for a plurality of neighbor cells (e.g., cells from a candidate target base station 1, a candidate target base station 2, etc.). The measurement reporting may be a layer 3 reporting, different from layer 1 CSI reporting. The wireless device may transmit one or more measurement reports 3705 to the source base station (e.g., gNB) (or source PCell).

The source base station (e.g., gNB) may provide the target base station with a list of best cells on each frequency for which measurement information is available, for example, in order of decreasing RSRP, for example, based on the one or more measurement reports from the wireless device. The source base station may also include available measurement information for the cells provided in the list. The target base station may decide which cells are configured for use after the CHO, which may include cells other than the ones indicated by the source base station. In an example the source base station may transmit a HO 3710 request to the target base station. The target base station may respond with a HO message 3715. In the HO message, for example, the target base station may indicate access stratum configuration (e.g., RRC configurations of the target cells) to be used in the target cell(s) for the wireless device.

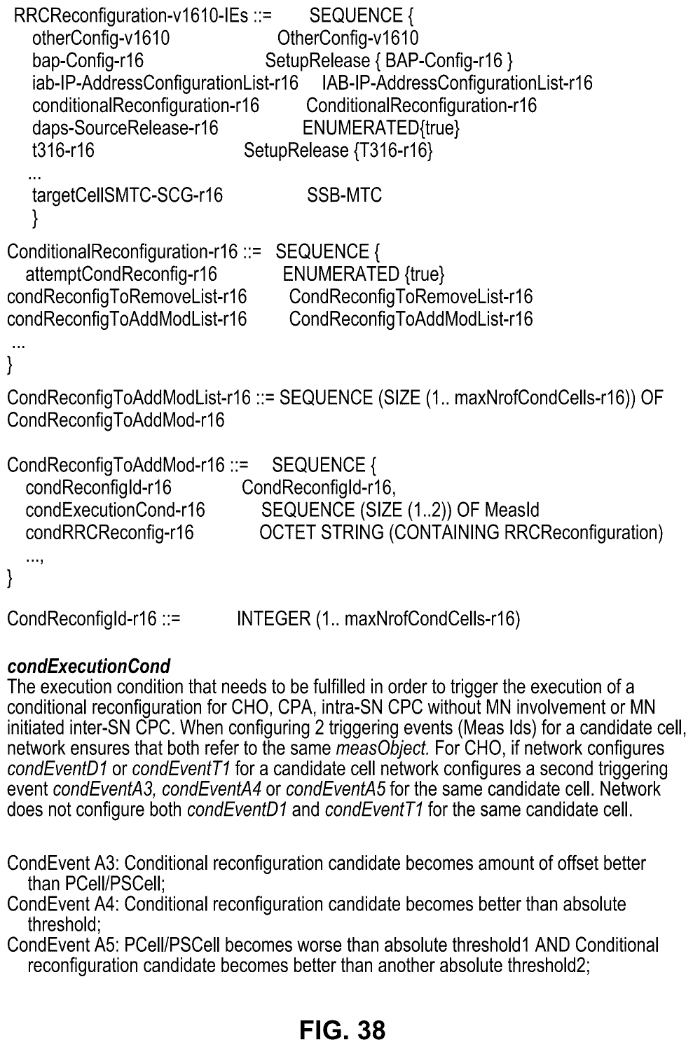

The source base station (e.g., gNB) may transparently (e.g., by not altering values/content) forward the handover (e.g., contained in RRC reconfiguration messages of the target base station) message/information received from the target base station to the wireless device. The source base station may configure a CHO procedure different from a normal HO procedure 3720 (e.g., such as described with respect to FIG. 34, FIG. 35 and/or FIG. 36), by comprising a conditional reconfiguration message (e.g., conditionalReconfiguration IE in RRC reconfiguration message, which will be described later in FIG. 38). The conditional reconfiguration message may comprise a list of candidate target PCells, each candidate target PCell being associated with dedicated RACH resources for the RA procedure in case a CHO is executed to the candidate target PCell. A CHO execution condition (or RRC reconfiguration condition) may also be configured for each of the candidate target PCells, etc. A CHO execution condition may comprise a measurement event A3 where a candidate target PCell becomes amount of offset better than the current PCell (e.g., the PCell of the source gNB), a measurement event A4 where a candidate target PCell becomes better than absolute threshold configured in the RRC reconfiguration message, a measurement event A5 where the current PCell becomes worse than a first absolute threshold, and a candidate target PCell becomes better than a second absolute threshold, etc.

The wireless device as shown in FIG. 37, according to the received RRC reconfiguration messages comprising parameters of a CHO procedure, may evaluate 3725 the (RRC) reconfiguration conditions for the list of candidate target PCells and/or the current/source PCell. The wireless device may measure RSRP/RSRQ of SSBs/CSI-RSs of each candidate target PCell of the list of candidate target PCells. Different from the normal HO procedure described with respect to FIG. 34, the wireless device may not execute the HO to the target PCell in response to receiving the RRC reconfiguration messages comprising the parameters of the CHO procedure. The wireless device may execute the HO to a target PCell for the CHO, for example, if the (RRC) reconfiguration condition(s) of the target PCell are met (or satisfied) 3730. The wireless device may keep evaluating the reconfiguration conditions for the list of the candidate target PCells 3725, for example, until an expiry of a HO timer, or receiving a RRC reconfiguration indicating an abort of the CHO procedure.

The wireless device as shown in FIG. 37 may execute the CHO procedure towards the first candidate target PCell, for example, based on (e.g., in response to) a reconfiguration condition of a first candidate target PCell (e.g., PCell 1) being met or satisfied. The wireless device may select one of multiple candidate target PCells 3735 by its implementation when the multiple candidate target PCells have reconfiguration conditions satisfied or met.

Executing the CHO procedure towards the first candidate target PCell may be the same as or similar to executing the HO procedure such as described with respect to FIG. 34. By executing the CHO procedure, the wireless device may release RRC configuration parameters of the source PCell and the MCG associated with the source PCell, apply the RRC configuration parameters of the PCell 1, reset MAC, perform cell group configuration for the received MCG comprised in the RRC reconfiguration message of the PCell 1, and/or perform RA procedure to the PCell 1 3740, etc.

The MCG of the RRC reconfiguration message of the PCell 1 may be associated with a SpCell (SpCellConfig) on the target base station 1. The wireless device may determine that the SpCell is a target PCell (PCell 1) for the HO, for example, if the sPCellConfig comprises a reconfiguration with Sync (reconfiguration WithSync). The reconfiguration with sync (reconfigurationWithSync) may comprise cell common parameters (spCellConfigCommon) of the target PCell, a RNTI (newUE-Identity) identifying the wireless device in the target PCell, a value of T304, a dedicated RACH resource (rach-ConfigDedicated), etc. A dedicated RACH resource may comprise one or more RACH occasions, one or more SSBs, one or more CSI-RSs, one or more RA preamble indexes, etc. The wireless device may perform cell group configuration for the received master cell group comprised in the RRC reconfiguration message 3745 (e.g., RRCReconfigurationComplete) of the PCell 1 on the target base station 1 such as described with respect to FIG. 34.

FIG. 38 shows an example of an RRC message for layer based conditional handover procedure. FIG. 38 shows an example of RRC message for CHO. A base station may transmit, and/or a wireless device may receive, a RRC reconfiguration message (e.g., RRCReconfiguration-V1610-IEs) indicating an RRC connection modification. The RRC reconfiguration message may be comprised in a (parent) RRC reconfiguration message (e.g., RRCReconfiguration-IEs) such as described with respect to FIG. 35, where the (parent) RRC reconfiguration message may comprise (L3 beam/cell) measurement configuration (e.g., measConfig IE).

The RRC reconfiguration message in FIG. 38 (e.g., RRCReconfiguration-V1610-IEs) may comprise a conditional reconfiguration IE (conditionalReconfiguration IE). The conditional reconfiguration IE may comprise a list of conditional reconfigurations (condReconfigToAddModList). Each conditional reconfiguration corresponds to a respective candidate target cell (PCell) of a list of candidate target cells. For each conditional reconfiguration of the list of conditional reconfigurations, the base station may indicate one or more measurement events (condExecutionCond) for triggering the CHO on the candidate target PCell, a RRC reconfiguration message (condRRCReconfig) of a candidate target cell (PCell) which is received by the source base station (e.g., gNB) from the target base station via X2/Xn interface. The RRC reconfiguration message of the candidate target cell may be implemented such as described with respect to FIG. 35 and/or FIG. 36. The RRC reconfiguration message may comprise a configuration of a master cell group (masterCellGroup) for the target base station. The master cell group may be associated with a SpCell (SpCellConfig). The SpCell may be a target PCell for executing the CHO, for example, if the sPCellConfig comprises a reconfiguration with Sync (reconfigurationWithSync). The reconfiguration with sync (reconfigurationWithSync) may comprise cell common parameters (spCellConfigCommon) of the target PCell, a RNTI (newUE-Identity) identifying the wireless device in the target PCell, a value of T304, a dedicated RACH resource (rach-ConfigDedicated), etc. A dedicated RACH resource may comprise one or more RACH occasions, one or more SSBs, one or more CSI-RSs, one or more RA preamble indexes, etc.

A measurement event in FIG. 38 (condExecutionCond) for triggering the CHO on the candidate target PCell may be an execution condition that needs to be fulfilled (at the wireless device) in order to trigger the execution of a conditional reconfiguration for CHO. The indication of the measurement event may point to a measurement ID (MeasId) which identifies a measurement configuration of a plurality of measurement configurations (e.g., comprised in measConfig IE) configured by the source base station. The measurement configuration may be associated with a measurement event (or a conditional event) of a plurality of measurements. A conditional event may comprise a conditional event A3, conditional event A4, and/or conditional event A5, etc. A conditional event A3 is that a candidate target PCell becomes amount of offset better than the current PCell (e.g., the PCell of the source base station/gNB). A conditional event A4 is that a candidate target PCell becomes better than an absolute threshold configured in the RRC reconfiguration message. A conditional event A5 is that the current PCell becomes worse than a first absolute threshold and a candidate target PCell becomes better than a second absolute threshold, etc.

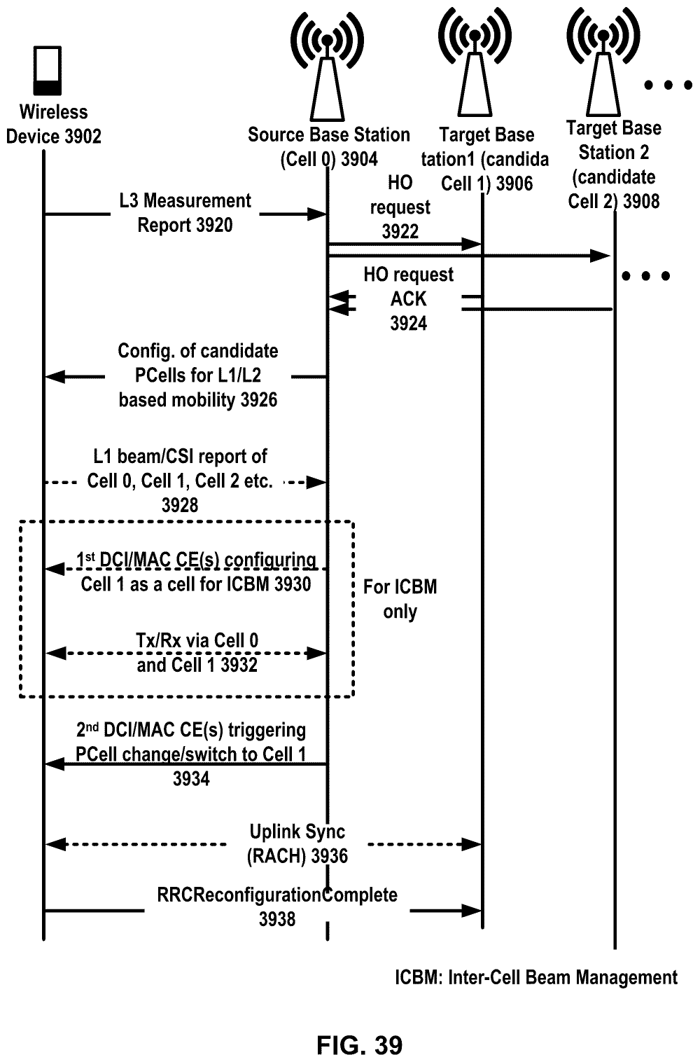

Executing CHO by the wireless device's decision based on evaluating reconfiguration conditions (long-term and/or layer 3 beam/cell measurements against one or more configured thresholds) on a plurality of candidate target cells may cause load unbalanced on cells, and/or lead to CHO failure in case that the target cell changes its configuration (e.g., for network energy saving) during the CHO condition evaluation, etc. An improved handover based on layer 1 or layer 2 signaling triggering is described herein with respect to FIG. 39. A layer 1 or layer 2 triggered handover may be referred to a layer 1 or layer 2 triggered mobility (LTM) procedure. A layer 1 signaling may comprise DCI transmitted via a PDCCH. A layer 2 signaling may comprise a MAC CE scheduled by DCI. Layer 1 or layer 2 signaling is different from Layer 3 signaling, for HO/CHO, which comprises RRC reconfiguration message.

FIG. 39 shows an example of layer 1 or layer 2 based handover. For example, FIG. 39 shows an example of layer 1 or layer 2 triggered HO procedure. For example. FIG. 39 shows an example of layer 1 or layer triggered mobility. The network (e.g., a source base station/gNB 3904) may configure the wireless device (e.g., wireless device 3902) to perform measurement reporting (possibly including the configuration of MGs) for a plurality of neighbor cells (e.g., cells from a candidate target base station 1 3906, a candidate target base station 2 3908, etc.). The measurement reporting may be a layer 3 reporting, different from layer 1 CSI reporting. The wireless device may transmit one or more measurement reports 3920 to the source base station (or source PCell, cell 0 in FIG. 39).

The source base station (e.g., gNB) may provide the target base station with a list of best cells on each frequency for which measurement information is available, for example, in order of decreasing RSRP, for example, based on the one or more measurement reports from the wireless device. The source base station may also include available measurement information for the cells provided in the list. The target base station may decide which cells are configured for use (as a target PCell, and/or one or more SCells) after HO, which may include cells other than the ones indicated by the source base station. The source base station may transmit a HO request 3922 to the target base station. The target base station may response with a HO message (e.g., HO request ACK 3924). In the HO message, the target base station may indicate access stratum configuration (e.g., RRC configurations of the target cells) to be used in the target cell(s) for the wireless device.

The source base station may transparently (e.g., by not altering values/content) forward the HO (e.g., contained in RRC reconfiguration messages of the target base station, cell group configuration IE of the target base station, and/or SpCell configuration IE of a target PCell/SCells of the target base station/gNB) message/information received from the target base station to the wireless device.

The source base station may configure a layer 1 or layer 2 signaling based HO (PCell switching/changing, mobility, etc.) procedure different from a normal HO procedure (e.g., such as described with respect to FIG. 34, FIG. 35 and/or FIG. 36) and/or a CHO procedure (e.g., such as described with respect to FIG. 37 and/or FIG. 38), by comprising a layer 1 or layer 2 candidate PCell configuration message 3926 (e.g., a newly defined candidates-LIL2-Config IE) in RRC reconfiguration message of the source base station (e.g., gNB). The layer 1 or layer 2 candidate PCell configuration message 3926 may comprise a list of candidate target PCells, each candidate target PCell being associated with dedicated RACH resources for the RA procedure in case a layer 1 or layer 2 signaling based HO is trigged by a layer 1 or layer 2 signaling and executed to the candidate target PCell, etc. There may be multiple options for parameter configurations of a candidate target PCell.

As a first option for the parameter configuration, for each candidate target PCell, the RRC reconfiguration message of the source base station (e.g., gNB) may comprise a (capsuled) RRC reconfiguration message (e.g., RRCReconfiguration), of a candidate target base station (e.g., gNB), received by the source base station from a candidate target base station via X2/Xn interface. The (capsuled) RRC reconfiguration message, of the candidate target base station (e.g., gNB), may reuse the same signaling structure of the RRC reconfiguration message of the source base station, such as described with respect to FIG. 35 and/or FIG. 36.

As a second option for the parameter configuration, for each candidate target PCell, the RRC reconfiguration message of the source base station (e.g., gNB) may comprise a (capsuled) cell group configuration message (e.g., CellGroupConfig), of a candidate target base station, received by the source base station from a candidate target base station (e.g., gNB) via X2/Xn interface. The (capsuled) cell group configuration message, of the candidate target base station (e.g., gNB), may reuse the same signaling structure of the cell group configuration message of the source base station (e.g., gNB), such as described with respect to FIG. 35 and/or FIG. 36. The second option may reduce signaling overhead of the parameter configuration of a candidate target PCell compared with the first option.

As a third option for the parameter configuration, for each candidate target PCell, the RRC reconfiguration message of the source base station (e.g., gNB) may comprise a (capsuled) SpCell configuration message (e.g., SpCellConfig), of a candidate target base station, received by the source base station from a candidate target base station via X2/Xn interface. The (capsuled) SpCell configuration message, of the candidate target base station, may reuse the same signaling structure of the SpCell configuration message of the source base station, such as described with respect to FIG. 35 and/or FIG. 36. The third option may reduce signaling overhead of the parameter configuration of a candidate target PCell compared with the second option.

For a candidate target PCell (e.g., each candidate target PCell), the source base station may indicate cell common and/or wireless-device-specific parameters (e.g., SSBs/CSI-RSs, BWPs, RACH resources, PDCCH/PDSCH/PUCCH/PUSCH resources etc.). The wireless device, according to the received RRC reconfiguration messages comprising parameters of a layer 1 or layer 2 signaling based HO procedure, may perform layer 1 or layer 2 measurement report (CSI/beam) for the list of candidate target PCells and/or the current PCell. The layer 1 or layer 2 measurement report may comprise layer 1 RSRP, layer 1 RSRQ, PMI, RI, layer 1 SINR, CQI, etc. The layer 1 or layer 2 measurement report 3928 may be transmitted to the source base station with a periodicity configured by the source base station (e.g., gNB). The layer 1 or layer 2 measurement report may be triggered when the measurement of the CSI/beam of a candidate target PCell is greater than a threshold, or (amount of offset) greater than the current PCell, etc.

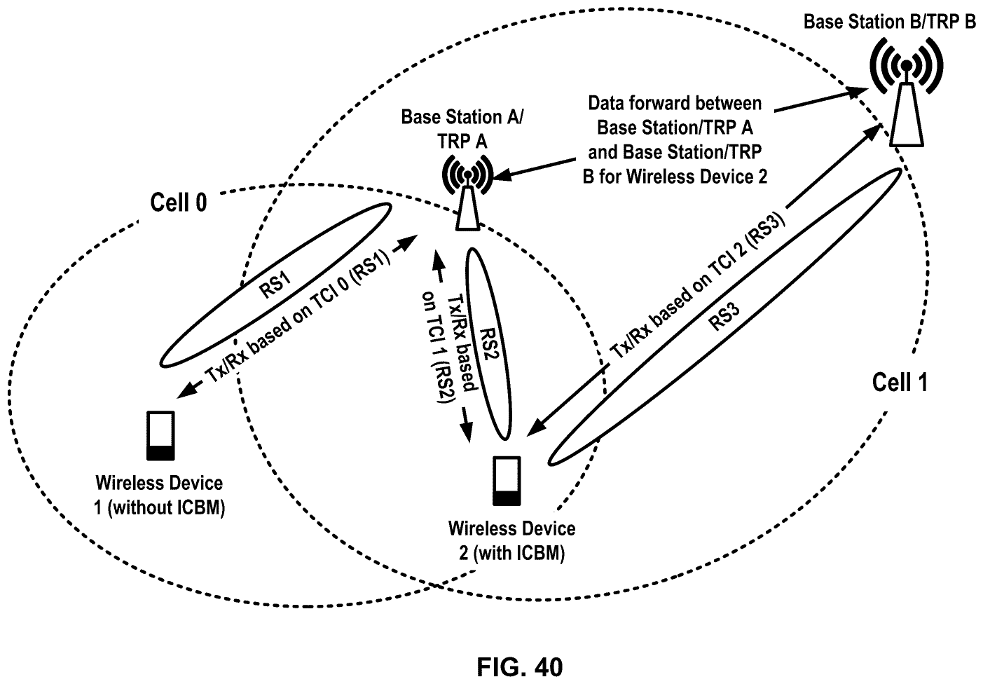

The base station in FIG. 39 may perform an inter-cell beam management (ICBM) procedure before sending (e.g., transmitting) a layer 1 or layer 2 signaling triggering the HO procedure comprising switching PCell from the source base station (e.g., gNB) to a target base station. The ICBM procedure may allow the base station and the wireless device to use resources (time/frequency/spatial) of the target base station (or a PCell/SCell of the target base station) without executing HO procedure to the target base station, therefore reducing frequently executing the HO procedure. The ICBM procedure may allow the base station and the wireless device to synchronize time/frequency/beam to a target PCell of the target base station before executing the HO, which may reduce HO latency. The ICBM may be implemented such as described herein with respect to FIG. 40.

The source base station in FIG. 39 may send (e.g., transmit) to the wireless device a first DCI/MAC CE configuring/indicating a first candidate target cell (e.g., Cell 1) of the candidate target cells (PCells/SCells) 3930 as a neighbor or non-serving cell, in addition to the current PCell (e.g., Cell 0), for the wireless device, for example, based on (e.g., in response to) the ICBM procedure being configured. The base station may select the first candidate target cell from the candidate target cells, based on layer 1 or layer 2 measurement report from the wireless device.

The first DCI/MAC CE (e.g., activating TCI states) may indicate that a reference RS (e.g., SSB/CSI-RS) associated with a first TCI state is from the first candidate target cell (Cell 1) (e.g., by associating the reference RS with an additional PCI, of Cell1, different from a PCI of the Cell 0), in addition to a reference RS associated with a second TCI state being from the current PCell (Cell 0). Association between a reference signal and a TCI state may be implemented based on examples described above with respect to FIG. 31B. Activating, by DCI and/or MAC CE, a TCI state with a RS of a neighbor (non-serving) cell as a reference RS, may allow the base station to use a beam of the neighbor cell to transmit downlink signals/channels or to receive uplink signals/channels, and/or use a beam of the current cell for the transmissions/receptions, without performing HO to the neighbor cell for the transmissions/receptions.

The wireless device may apply the first TCI state and the second TCI state for downlink reception and/or uplink transmission 3932, for example, based on (e.g., in response to) receiving the first DCI/MAC CE. Applying the first TCI state and the second TCI state for downlink reception may comprise: receiving (from Cell 1) PDCCH/PDSCH/CSI-RS with a reception beam/filter same as that for receiving the reference signal, transmitted from Cell 1, according to (or associated with) the first TCI state, and receiving (from cell 0) PDCCH/PDSCH/CSI-RS with a reception beam/filter same as that for receiving the reference signal, transmitted from Cell 0, according to (or associated with) the second TCI state. Applying the first TCI state and the second TCI state for uplink transmission may comprise: transmitting (via Cell 1) PUCCH/PUSCH/SRS with a transmission beam/filter same as that for receiving the reference signal, transmitted from Cell 1, according to (or associated with) the first TCI state, and transmitting (via cell 0) PUCCH/PUSCH/SRS with a transmission beam/filter same as that for receiving the reference signal, transmitted from Cell 0, according to (or associated with) the second TCI state.

The base station may skip performing the ICBM procedure before transmitting the layer 1 or layer 2 signaling triggering the HO procedure. The base station may skip performing the ICBM procedure, for example, when beamforming is not used in the target PCell, if there is no good SSB(s) from the target PCell, if there is no available radio resources from the target PCell to accommodate the wireless device, and/or when the wireless device does not support ICBM and/or when the base station does not support ICBM.

The source base station may determine to handover the wireless device from the source base station (Cell 0) to the target base station (Cell 1). The source base station may determine the handover based on a load/traffic condition, a CSI/beam report of the target base station (e.g., gNB), a location/trajectory of the wireless device, a network energy saving strategy (e.g., the source base station determines to turn of the Cell 0 and/or one or more SCells for power saving), etc.

The source base station in FIG. 39 may send (e.g., transmit) a second DCI/MAC CE indicating a PCell changing from the current PCell (Cell 0) to a new cell (e.g., Cell 1) 3934. The new cell may be one of the neighbor (non-serving) cells used in the ICBM procedure (e.g., indicated by the first DCI/MAC CE). The new cell may be cell 1 in the example of FIG. 39. The wireless device, for example, before executing HO procedure indicated by the source base station, may have already synchronized with the target base station regarding which beam should be used for transmission/reception via the target base station, which is different from layer 3 signaling based (C) HO (as shown in FIG. 34 and/or FIG. 37) where the wireless device needs to synchronize to the target base station upon executing the HO/CHO and then obtains an indication of a new beam to be used for the target base station, for example, if the ICBM procedure is supported and/or configured.

The new cell may be one of a plurality of neighbor (non-serving) cells comprised in L1 beam/CSI report, e.g., with the best measurement report, with the distance closest to the wireless etc., when device, the ICBM procedure is not configured/supported/indicated/activated for the new cell. The wireless device may change the PCell from cell 0 to cell 1, for example, based on (e.g., in response to) receiving the second DCI/MAC CE in FIG. 39. The wireless device may apply the (stored/received) RRC parameters (comprised in RRCReconfiguration, CellGroupConfig, and/or SpCellConfig IE) of the target PCell (cell 1) as the current PCell.

The wireless device may skip downlink (time/frequency/beam) synchronization (e.g., monitoring MIB/SSB/SIBs and/or selecting a SSB as a reference for downlink reception and/or uplink transmission) in case the wireless device has already synchronized with the target PCell based on the ICBM procedure, for example, if the ICBM is configured/supported/indicated/activated before receiving the second DCI/MAC CE. The wireless device may skip performing RA procedure towards the target PCell before transmitting to and/or receiving from the target PCell, for example, when the target PCell is close to the source PCell, or the uplink TA is same or similar for the source PCell and the target PCell, or the dedicated RACH resource is not configured in the RRC reconfiguration message of the target PCell. The wireless device may perform downlink synchronization (SSB/PBCH/SIBs monitoring), may perform uplink synchronization (RA procedure) 3936 for the layer 1 or layer 2 signaling based HO (e.g., when ICBM is not configured/indicated/supported/activated) and/or may send RRCReconfigurationComplete 3938 to the target base station 1 as it does for layer 3 signaling based HO/CHO such as described with respect to FIG. 34, FIG. 35, FIG. 36, FIG. 37 and/or FIG. 38.

FIG. 40 shows an example of inter-cell beam management. FIG. 40 shows an example of an ICBM procedure. A first wireless device (wireless device 1) may be in the coverage of Cell 0 deployed under a first node (e.g., base station A or TRP A). wireless device 1 is not in the coverage of Cell 1 deployed under a second node (e.g., base station B or TRP B). Cell 0 and Cell 1 have different PCIs. Wireless device 1 may use the RSs (e.g., RS1) transmitted from Cell 0 as a reference RS for a TCI state (which is used for beam/spatial domain filter determination for downlink reception and/or uplink transmission (Tx/Rx based TCI state 0 associated with RS1)). Wireless device 1 may not use RSs (e.g., RS2 and/or RS3) transmitted from Cell 1 as the reference RS for the TCI state. Wireless device 1 configured with a TCI state, associated with a RS of a serving cell with a first PCI and not associated with a RS of another cell with a second PCI different from the first PCI, may be referred to as a wireless device (e.g., UE) without (configured/activated) ICBM herein.

A second wireless device in FIG. 40 (wireless device 2) may be in the coverage of Cell 0 deployed under a first node (e.g., base station A or TRP A). Wireless device 2 is also in the coverage of Cell 1 deployed under a second node (e.g., base station B or TRP B). Cell 0 and Cell 1 have different PCIs. Wireless device 2 may use the RSs (e.g., RS2) transmitted from Cell 0 as a reference RS for a first TCI state (which is used for beam/spatial domain filter determination for downlink reception and/or uplink transmission via Cell 0 (Tx/Rx based TCI state 1 associated with RS2)). Wireless device 2 may use RSs (e.g., RS3) transmitted from Cell 1 as the reference RS for a second TCI state (which is used for beam/spatial domain filter determination for downlink reception and/or uplink transmission via Cell 1 (Tx/Rx based TCI state 2 associated with RS3)). Wireless device 2 configured with a first TCI state, associated with a RS of a serving cell with a first PCI and configured with a second TCI state associated with a RS of another cell with a second PCI different from the first PCI, may be referred to as a wireless device (e.g., UE) with (configured/activated) ICBM herein.

For example, if base station B or TRP B receives uplink signals/channels with the second TCI state, it may forward the uplink signals/channels to base station A or TRPA for processing. A base station such as base station A or TRP A may forward downlink signals/channels to base station B or TRP B to transmit with the second TCI state to the wireless device. Cell 1 with the second PCI different from the first PCI of Cell 0 may be considered/configured as a part (e.g., a second TRP with a second PCI different from a first PCI of a first TRP) of cell 0 for wireless device 2, for example, such as described with respect to FIG. 33B. Cell 0 and Cell 1 may belong to a same DU (or base station-DU (e.g., gNB0DU)) if, for example, Cell 1 is configured as the part of Cell 0. A base station-DU may be implemented, for example, based on examples described above with respect to FIG. 1A and/or FIG. 1B. The PDCCH/PDSCH/PUCCH/PUSCH resources may be shared between Cell 1 and Cell 0 in a way that is transparent to wireless device 2. SSBs/CSI-RSs of Cell 0 may not share the same resources with SSBs/CSI-RSs of Cell 1. SSBs/CSI-RSs of Cell 0 may have configuration parameters (e.g., number of beams, periodicity, transmission power, etc.) different than configuration parameters of SSBs/CSI-RSs of Cell 1.

Cell 1 with the second PCI different from the first PCI of Cell 0 may be considered/configured as a separate cell different from cell 0 for wireless device 2, for example, when Cell 1 is configured as a candidate target cell such as described with respect to FIG. 35 and/or FIG. 38. Cell 0 and Cell 1 may belong to different DUs (or base station-DUs (e.g., gNB-DUs)) associated with a same CU (or base station-CU (e.g., gNB-CU)) or different CUs if, for example, Cell 1 is configured as a sperate cell from Cell 0. A base station-DU and/or a base station-CU may be implemented, for example, based on examples described with respect to FIG. 1A and/or FIG. 1B. Cell resources (SSB/CSI-RS/PDCCH/PDSCH/PUCCH/PUSCH) may not be shared between Cell 1 and Cell 0. Cell 1 has configuration parameters, of the cell resources, different from (or independent of) configuration parameters of the cell resources of Cell 0.

In at least some technologies, a base station may configure, for a wireless device, RRC configuration parameters (SSBs, RACH resources, MAC parameters, PHY cell common and/or UE-specific parameters, as shown in FIG. 35, FIG. 36 and/or FIG. 38) of a target PCell for performing (C) HO to the target PCell from a source PCell. When performing the (C) HO to the target PCell, the wireless device may use the received/stored RRC configuration parameters. The wireless device may start to perform downlink synchronization towards the target PCell (e.g., time/frequency alignment by monitoring the SSBs configured on the target PCell, e.g., according to 3GPP TS 38.213 Section 4—Synchronization procedures). The wireless device may start to perform uplink synchronization, for example, by initiating a (CF) RA procedure based on the RACH resources configured on the target PCell, for example, based on (e.g., after) the downlink synchronization is complete. The wireless device may receive a timing advance (TA) command in a RAR corresponding to a preamble transmitted by the wireless device.

In at least some technologies, for sending (e.g., transmitting) a preamble for the CFRA procedure, when multiple beams are used for SSB transmissions (e.g., such as described with respect to FIG. 28 and/or FIG. 29) by the base station, the wireless device may select, based on a RSRP value of a first SSB being greater than a RSRP threshold, the first SSB from a plurality of candidate SSBs configured in the RACH resources (e.g., such as described with respect to FIG. 36) on the target PCell. The wireless device may determine the preamble with a preamble index associated with the selected first SSB according to RACH resource configuration parameters. The wireless device may determine a next available PRACH occasion from PRACH occasions corresponding to the selected first SSB permitted by the restrictions given by the ra-ssb-OccasionMaskIndex configured in the rach-ConfigDedicated IE (e.g., such as described with respect to FIG. 36, for example, based on (e.g., after) selecting the first SSB. The wireless device may transmit the preamble via the determined PRACH occasion to the target PCell. The wireless device may monitor a PDCCH of the target PCell for receiving a RAR corresponding to the preamble. The wireless device may receive the RAR comprising the preamble index and/or a TA command. The wireless device may complete the CFRA procedure. The CFRA procedure may be implemented such as described with respect to FIG. 13B. The wireless device may receive, from the target PCell, a beam indication (or a TCI state indication) used for PDCCH/PDSCH/CSI-RS reception and/or PUCCH/PUSCH/SRS transmission for the target PCell, for example, based on (e.g., after) completing the CFRA procedure. The wireless device may apply the beam (or the TCI state) for PDCCH/PDSCH/CSI-RS reception and/or PUCCH/PUSCH/SRS transmission for the target PCell. In at least some technologies, the wireless device may perform downlink synchronization and uplink synchronization, beam alignment/management via a target PCell, for example, based on (e.g., after) receiving a HO command (e.g., RRC reconfiguration with a Reconfiguration WithSync IE). Performing downlink synchronization, uplink synchronization and/or beam alignment may be time consuming.

Configurations (e.g., RS configurations) for reporting (e.g., CSI reporting) (e.g., layer 1 CSI reporting) may be configured within a serving cell configuration of a cell (e.g., of each cell). The configurations may be configured in a message, for example, in an RRC message (e.g., ServingCellConfig). Different serving cells may be configured differently (e.g., with different RS configurations). A similar principle may be adopted for other HOs and CHOs (e.g., layer 3 based HO and CHO) such that each candidate cell may be configured with different configurations.

Some HO procedures (e.g., LTM procedures), however, may proceed differently. For example, in some HO procedures (e.g., LTM), the wireless device may perform a first measurement/reporting (e.g., layer 1 CSI measurement/reporting) for candidate cells prior to switching to one of the candidate cells as the PCell. Additionally or alternatively, a wireless device may perform subsequent HO (e.g., LTM) procedures, for example, to switch to a new PCell, after initial HO procedures, without reconfiguration (e.g., RRC reconfiguration) of the candidate cells. Using at least some wireless communications that support early reporting (e.g., CSI reporting) for HO procedures (e.g., initial and subsequent LTM procedures), for example, by configuring each candidate cell, may increase signaling overhead.

As described herein, it may be advantageous to, instead of configuring resources (e.g., RS resources) separately in each candidate cell, resource configuration for early reporting (e.g., a layer 1/layer 2 measurement and/or reporting of a candidate cell before switching to the candidate cell as a serving cell) of a HO procedure may be jointly configured (e.g., in a reference configuration, for example, a reference cell configuration) separate from a serving cell configuration and/or a candidate cell configuration. The resource configuration (e.g., the reference configuration) may comprise one or more portions (e.g., one or more SSBs). A portion (e.g., each of the one or more SSBs) may be associated with an index (e.g., a respective SSB index per each respective SSB), a cell indication of a candidate cell, and/or one or more resources (e.g., time and/or frequency resource(s)). The resource configuration (e.g., CSI resource configuration) may be applied for all candidate cells configured for the HO procedure (e.g., LTM). Accordingly, if the wireless device switches its PCell for an HO procedure (e.g., an initial and/or subsequent LTM procedure), the wireless device may obtain configuration information (e.g., RS configuration information), for example, for reporting, from the configuration information in the reference configuration. Using such jointly configured reference configurations may reduce signaling overhead in HO procedures (e.g., initial and/or subsequent LTM procedures). Additionally or alternatively, using such reference configurations may enable quicker HO among cells and may reduce HO latency, for example, the latency introduced for uplink synchronization, based on, for example, an early acquisition scheme (e.g., TA acquisition scheme) as described herein.

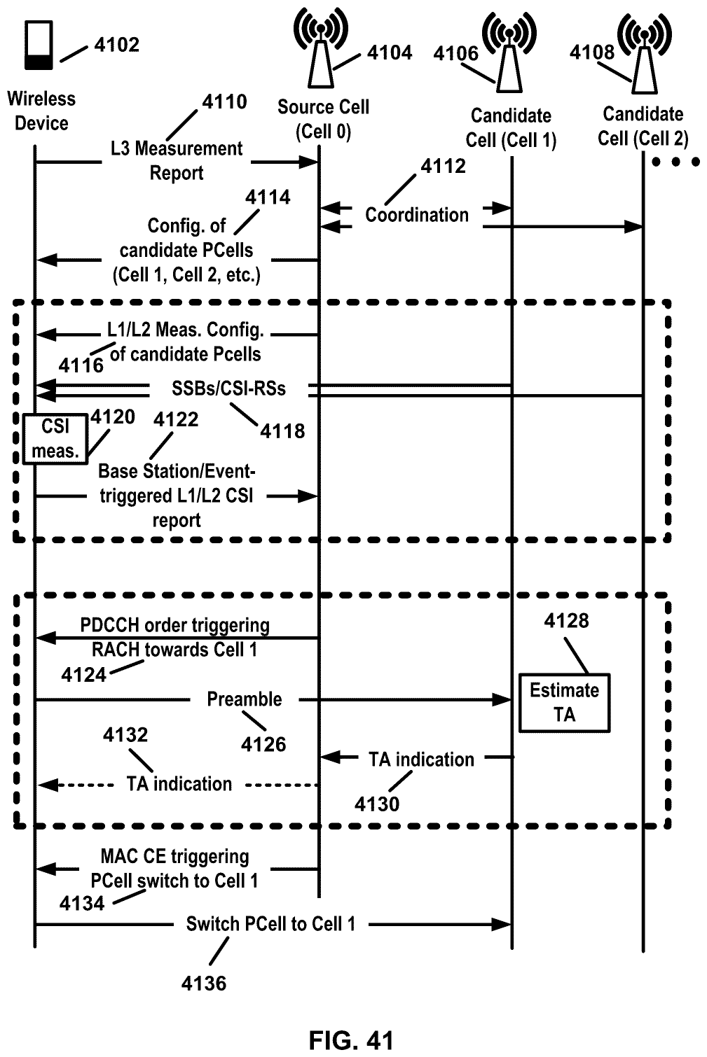

FIG. 41 shows an example of layer 1 or layer 2 triggered mobility with early CSI reporting. For example, FIG. 41 shows an example of early TA acquisition (or ETA)-based HO procedure. The network (e.g., a base station, a source gNB) may configure the wireless device 4102 to perform measurement reporting (e.g., layer 3 measurement reporting) (possibly including the configuration of MGs) for a plurality of neighbor cells (e.g., Cell 1 4106 from a candidate target base station 1, Cell 2 4108 from a candidate target base station 2, etc.), for example, as shown in FIG. 41. The measurement reporting may comprise a layer 3 reporting, different from layer 1 CSI reporting. At step 4110, the wireless device may send (e.g., transmit) one or more layer 3 measurement reports (e.g., in an RRC message) to the source base station (or source PCell, Cell 0 4104 in FIG. 41).

As shown in FIG. 41, at step 4112, the source base station may coordinate with the target base station(s). For example, the source base station may provide the target base station(s) with a list of best cells on each frequency for which measurement information is available, for example, based on the one or more measurement reports from the wireless device and in order of decreasing RSRP. The source base station may also include available measurement information for the cells provided in the list. The target base station may decide which cells are configured for use (e.g., as a target PCell, and/or one or more SCells), for example, after HO, which may include cells other than the ones indicated by the source base station.

The source base station may send (e.g., transmit) a HO request to the target base station (not shown in FIG. 41). The target base station may respond with a HO message. In the HO message, the target base station may indicate access stratum configuration (e.g., RRC configurations of the target cells) to be used in the target cell(s) for the wireless device.

At step 4114, the source base station may send (e.g., transmit), and/or the wireless device may receive, a layer 1 or layer 2 candidate PCell configuration message. For example, the source base station may configure a layer 1 or layer 2 signaling based HO (e.g., PCell switching/changing, mobility, LTM, etc.) procedure, different from a layer 3 based HO procedure (e.g., as shown in FIG. 34, FIG. 35, and/or FIG. 36) and/or a CHO procedure (e.g., as shown in FIG. 37 and/or FIG. 38), by comprising a layer 1 or layer 2 candidate PCell configuration message (e.g., a newly defined candidates-L1L2-Config IE) in an RRC reconfiguration message (e.g., config. of candidate PCells (Cell 1, Cell 2, etc.) as shown in FIG. 41) of the source base station. The layer 1 or layer 2 candidate PCell configuration message may comprise a list of candidate target PCells. Each candidate target PCell may be associated with dedicated RACH resources for the RA procedure, for example, in case a layer 1 or layer 2 signaling based HO is trigged by a layer 1 or layer 2 signaling and executed to the candidate target PCell, etc. There may be multiple options for parameter configurations of a candidate target PCell.

For example, as a first option for the parameter configuration, for each candidate target PCell, the RRC reconfiguration message sent (e.g., transmitted) from the source base station may comprise a (capsuled) RRC reconfiguration message (e.g., RRCReconfiguration), of a candidate target base station, received by the source base station from a candidate target base station, for example, via X2/Xn interface. The (capsuled) RRC reconfiguration message, of the candidate target base station, may reuse the same signaling structure of the RRC reconfiguration message of the source base station, as shown, for example, in FIG. 35 and/or FIG. 36.

As a second option for the parameter configuration, for each candidate target PCell, the RRC reconfiguration message sent (e.g., transmitted) from the source base station may comprise a (capsuled) cell group configuration message (e.g., CellGroupConfig), of a candidate target base station, received by the source base station from a candidate target base station, for example, via X2/Xn interface. The (capsuled) cell group configuration message, of the candidate target base station, may reuse the same signaling structure of the cell group configuration message of the source base station, for example, as shown in FIG. 35 and/or FIG. 36. The second option may reduce signaling overhead of the parameter configuration of a candidate target PCell compared with the first option.

As a third option for the parameter configuration, for each candidate target PCell, the RRC reconfiguration message sent (e.g., transmitted) from the source base station may comprise a (capsuled) SpCell configuration message (e.g., SpCellConfig), of a candidate target base station, received by the source base station from a candidate target base station, for example, via X2/Xn interface. The (capsuled) SpCell configuration message, of the candidate target base station, may reuse the same signaling structure of the SpCell configuration message of the source base station, for example, as shown in FIG. 35 and/or FIG. 36. The third option may reduce signaling overhead of the parameter configuration of a candidate target PCell compared with the second option.

For each candidate target PCell, the source base station may indicate, for example, in the RRC reconfiguration message, cell common and/or wireless device (e.g., UE) specific parameters (e.g., SSBs/CSI-RSs, BWPs, RACH resources, PDCCH/PDSCH/PUCCH/PUSCH resources etc.).

Cell 0, Cell 1 and/or Cell 2 may belong to a same base station-DU (e.g., gNB-DU), in which case, Cell 1 and/or Cell 2 may be configured as a part of Cell 0 (e.g., a serving cell). The radio resources (e.g., PDCCH, PDSCH etc.) of Cell 0 may be shared with Cell 1 and/or Cell 2. Cell 1 and/or Cell 2 may send (e.g., transmit) SSBs different from SSBs sent (e.g., transmitted) via Cell 0 (e.g., based on examples of FIG. 40). A base station-DU may be implemented based on examples described herein with respect to FIG. 1A and/or FIG. 1B.

Cell 0, Cell 1 and/or Cell 2 may belong to different base station-DUs (which may be associated with a same base station-CU (e.g., gNB-CU) or associated with different base station-CUs), in which case, Cell 1 and/or Cell 2 may be configured as sperate cells (non-serving cell) from Cell 0. The radio resources (e.g., PDCCH, PDSCH etc.) of Cell 0 may, in some configurations, not be shared with Cell 1 and/or Cell 2. Cell 1 and/or Cell 2 may send (e.g., transmit) SSBs different from SSBs sent (e.g., transmitted) via Cell 0 (e.g., based on examples of FIG. 40). A base station-DU and/or a base station-CU may be implemented based on examples described herein, for example, with respect to FIG. 1A and/or FIG. 1B.

The wireless device in FIG. 41 may perform layer 1 or layer 2 measurement reporting (e.g., CSI/beam) for the list of candidate target PCells and/or the current PCell. The layer 1 or layer 2 measurement report may comprise, for example, layer 1 RSRP, layer 1 RSRQ, PMI, RI, layer 1 SINR, CQI, etc., which may be different from layer 3 (e.g., L3) measurements as described herein. At step 4116, the base station may send (e.g., transmit) RRC configuration messages comprising configuration parameters of layer 1 or layer 2 measurements for one or more candidate cells, for example, in order to facilitate the wireless device to perform layer 1 or layer 2 measurements. The one or more candidate cells may be a subset of a plurality of candidate cells for which the wireless device reports L3 measurements to the base station.

The RRC configuration messages, for example, comprising configuration parameters of layer 1 or layer 2 measurements for one or more candidate cells, may be the same as the RRC messages used for L3 measurement configuration or be the same as the RRC configuration messages for the candidate PCell configuration as described herein. Additionally or alternatively, the RRC configuration messages, for example, comprising configuration parameters of layer 1 or layer 2 measurements for one or more candidate cells, may be separate and/or independent from the RRC configuration messages for the candidate PCell configuration as described herein. Additionally or alternatively, the RRC configuration messages, for example, comprising the configuration parameters of layer 1 or layer 2 measurements, may be the same as an RRC message configuring a serving cell (e.g., Cell 0 as shown in FIG. 41), which may comprise layer 1 or layer 2 measurement configurations of the serving cell.

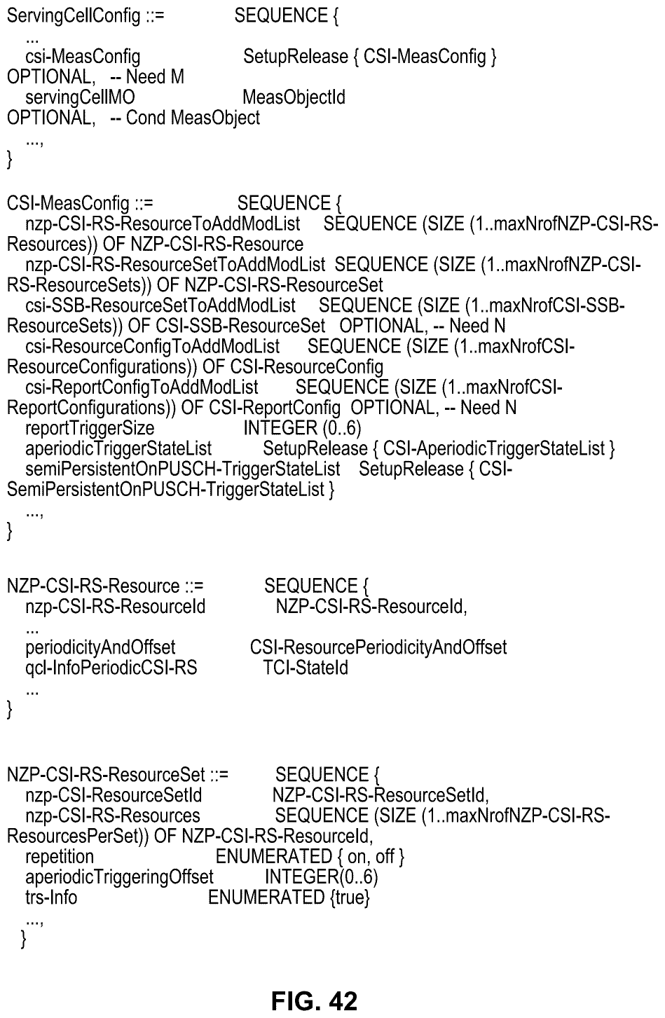

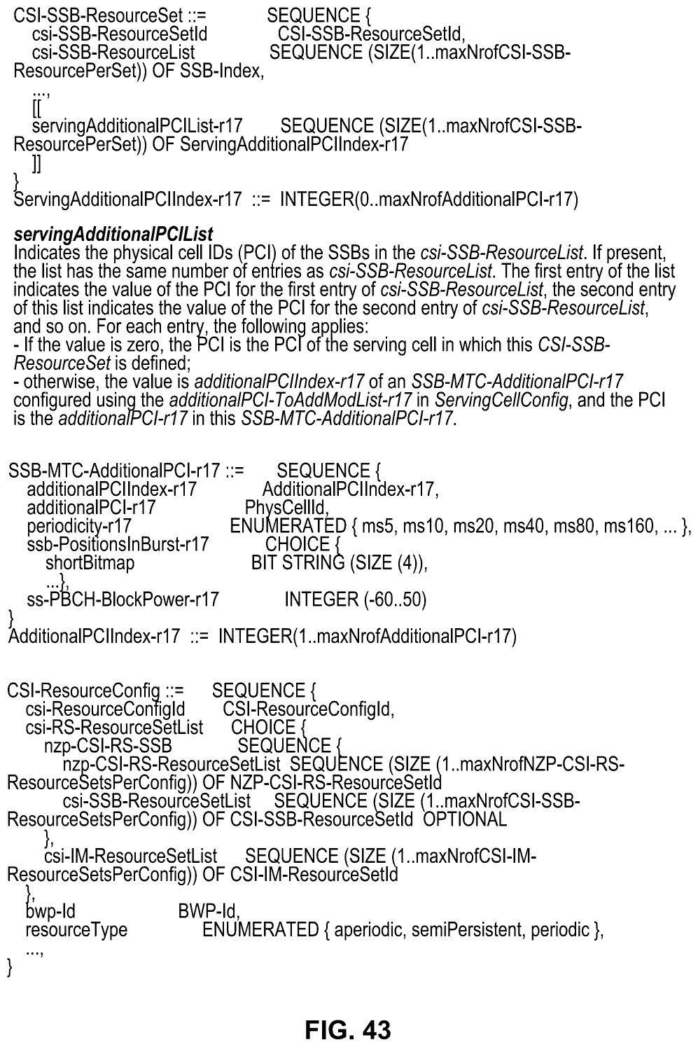

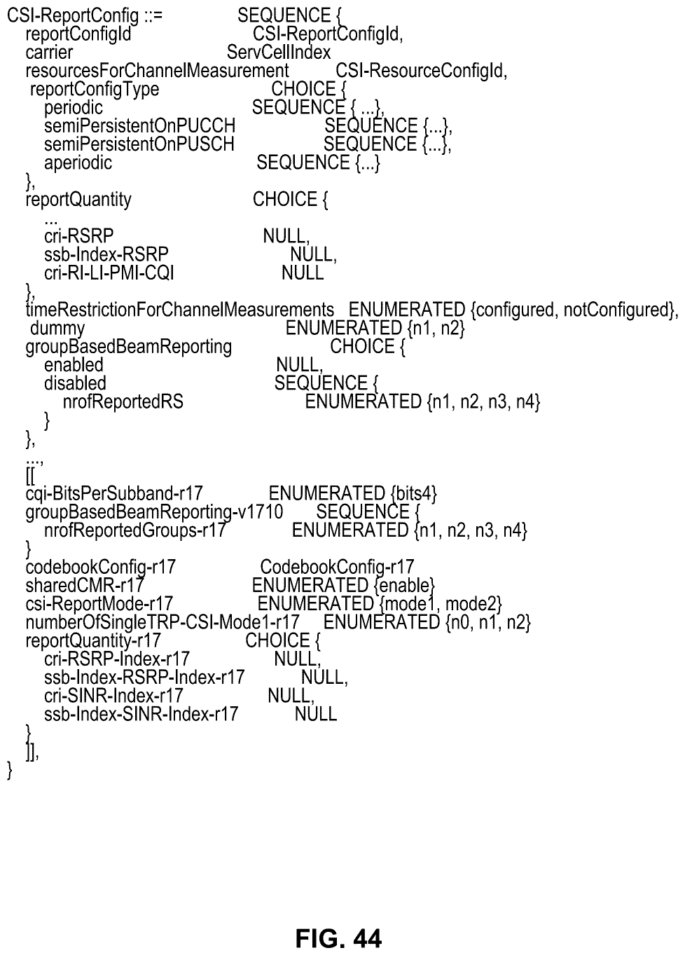

Layer 1 or layer 2 measurement configurations of a serving cell may be implemented based on, for example, examples of FIG. 42, FIG. 43, and/or FIG. 44 which are described herein. The layer 1 or layer 2 measurement configuration of the serving cell may comprise a plurality of SSB resource sets (e.g., CSI-SSB-ResourceSets) for CSI (e.g., CQI/PMI/RI/L1-RSRP/L1-SINR etc.) measurements. A CSI-SSB-ResourceSet may be identified by a CSI-SSB-Resource set identifier (ID) and may comprise a list of SSB indexes. Each SSB index may be associated with a ServingAdditionalPCIIndex indicating a physical cell ID of the SSB, among multiple SSBs associated with the ServingAdditionalPCIInex. If a value of the ServingAdditionalPCIIndex is zero, the PCI of the SSB index may be the PCI of the serving cell (e.g., Cell 0). If a value of the ServingAdditionalPCIIndex is not zero, the ServingAdditionalPCIIndex may indicate an additionalPCIIndex of an SSB-MTC-AdditionalPCI configured using the additionalPCI-ToAddModList in ServingCellConfig, and the PCI may be the additionalPCI (e.g., PCI of Cell 1, PCI of Cell 2, etc.) in the SSB-MTC-AdditionalPCI. A PCI of a cell may comprise a cell identifier uniquely identifying the cell in a wireless communication system. In an example, a CSI-SSB-Resourceset of Cell 0 may indicate SSB 0 from Cell 0, SSB 1 from Cell 1, SSB 2 from Cell 2, etc.

At step 4120, the wireless device may measure CSI (e.g., CQI/PMI/L1-RSRP/L1-RSRQ/L1-SINR) of each SSB of the SSBs configured in the CSI-SSB-ResourceSet of Cell 0, for example, based on the layer 1 or layer 2 measurement configurations of the serving cell (e.g., Cell 0).Each SSB may be from different cells (or different PCIs). The wireless device may measure SSB 0 from Cell 0, SSB 1 from Cell 1 and SSB 2 from Cell 2 for the L1/L2 CSI/beam measurement for the LTM procedure, for example, if a CSI-SSB-Resourceset of Cell 0 indicates SSB 0 is from Cell 0, SSB 1 is from Cell 1, SSB 2 is from Cell 2, etc. . . . The wireless device may measure CSI based on, for example, examples of FIG. 43, which are described herein.

The wireless device may trigger a layer 1 or layer 2 measurement report, for example, based on the measuring CSI of each SSB of the SSBs configured in the CSI-SSB-ResourceSet of Cell 0. The triggering the layer 1 or layer 2 measurement report may be based on a triggering indication of the base station and/or a triggering event occurring at the wireless device.

The layer 1 or layer 2 measurement report may be triggered by a measurement event, for example, if the measurement of the CSI of a candidate target PCell (e.g., Cell 1, Cell 2 etc.) is greater than a threshold, or (amount of offset) greater than the current PCell (Cell 0), etc. Additionally or alternatively, the layer 1 or layer 2 measurement report may be triggered by receiving a triggering indication (e.g., a DCI or a MAC CE) indicating to report the layer 1 or layer 2 measurement of one or more candidate target PCells (e.g., Cell 1, Cell 2, etc.). At step 3922, the wireless device may (e.g., after performing the layer 1 or layer 2 measurement) send (e.g., transmit) the layer 1 or layer 2 measurement report indicating whether at least one candidate target PCell has better CSI measurement than the current PCell, for example, based on (e.g., after or in response to) receiving the triggering indication. The wireless device may skip sending (e.g., transmitting) the layer 1 or layer 2 measurement of candidate target PCell (e.g., Cell 1, Cell 2, etc.) or may send (e.g., transmit) only layer 1 or layer 2 CSI measurement of the serving cell (Cell 0), for example, based on (e.g., after or in response to) no candidate target PCell having better CSI measurement than the current PCell after receiving the triggering indication.

The layer 1 or layer 2 measurement report may be sent (e.g., transmitted) with a periodicity configured by the source base station. The layer 1 or layer 2 measurement report may be contained in a UCI, for example, via PUCCH/PUSCH, or a MAC CE (e.g., event-triggered, associated with a configured SR for the transmission of the MAC CE).

The layer 1 or layer 2 measurement and/or reporting of a candidate target PCell, for example, before actually switching to the candidate target PCell as a serving PCell, may be referred to as an early CSI report for a candidate target PCell, which may be different from a CSI report of a serving PCell. Early CSI reporting for a candidate target PCell, for example, before the wireless device performs a LTM procedure to switch to the candidate target PCell as the serving PCell, may enable the base station to obtain correct beam information, for example, in terms of which SSB can be used as beam reference for downlink sending (e.g., transmission) for the candidate target PCell. The latency (e.g., the HO latency) of the PCell switching may be improved, for example, if the wireless device later switches to the candidate target PCell as the serving PCell, for example, without waiting for beam management after the switching.

The wireless device may determine, for example, that Cell 1 has better channel quality (e.g., L1-RSRP/L1-SINR/L1-RSRQ, etc.) than Cell 0. The wireless device may send (e.g., transmit) the layer 1 or layer 2 measurement report indicating that Cell 1 has better channel quality than Cell 0.

The source base station and/or the target base station may determine which cell is used as the target PCell. The source base station may coordinate with the candidate target base station regarding whether Cell 1 could be used as a candidate target PCell for one or more future HOs, for example, upon receiving the layer 1 or layer 2 measurement report. This coordination (e.g., following step 3922) may be similar in some respects to the coordination described above in step 3912.

At step 4124, the source base station (e.g., according to the request of the target base station if there is no time alignment obtained before for Cell 1) may send (e.g., transmit), from Cell 0 (or, e.g., an activated SCell of the wireless device), a first layer 1 or layer 2 command (e.g., a DCI/MAC CE/RRC message comprising PDCCH order as shown, for example, in FIG. 41) triggering a preamble sending (e.g., transmission) (e.g., RACH, or other uplink signals like SRS) towards Cell 1, for example, based on a determination that Cell 1 is to be used as the target PCell for one or more future HOs. The DCI may be based on a PDCCH order in at least some technology.

At step 4126, the wireless device may send (e.g., transmit) the preamble (or SRS which is not shown in FIG. 39) to the target PCell (Cell 1), for example, based on (e.g., upon) receiving the first layer 1 or layer 2 command. At step 3928, the target base station may monitor PRACH occasion for receiving the preamble to estimate (e.g., determine) the TA used for future uplink sending (e.g., transmissions) from the wireless device, for example, after the wireless device switches the PCell from Cell 0 to Cell 1.

At step 4130, the target base station may forward the estimated TA for Cell 1 to the source base station. Further, at step 3932, the source base station may send (e.g., transmit) the forwarded TA to the wireless device, for example, via an RAR message, or via a TAC MA CE. The wireless device may monitor PDCCH (e.g., on Cell 0) for receiving the RAR message (e.g., based on examples described herein with respect to FIG. 13A, FIG. 13B, and/or FIG. 13C). The wireless device may maintain a TAT for a TAG associated with Cell 1. The wireless device may maintain Cell 1 as a non-serving cell. The TAC MAC CE may indicate (e.g., one or more bitfields of the MAC CE) whether the TAC is for a serving cell (or a TAG associated with the serving cell) or for a non-serving cell (e.g., Cell 1).

The source base station may skip sending (e.g., transmitting) the forwarded TA to the wireless device. Instead, the source base station may indicate the TA together with a second layer 1 or layer 2 command indicating/triggering PCell switching, for example, from Cell 0 to Cell 1. In this case, the wireless device may skip monitoring PDCCH (e.g., on Cell 0) for receiving the RAR message.

The sending (e.g., transmission) of a preamble to a candidate target PCell, for example, before receiving a (P) Cell switch command (with or without comprising a TA estimated by the target base station for the target PCell) indicating to switch the PCell to the target PCell, may be referred to herein as an early TA acquisition (ETA) procedure/process/feature/scheme. By implementing the ETA, for example, before the wireless device performs the HO, the target base station may obtain the TA to be used by the wireless device, for example, after performing the HO to the target PCell. The TA for the target PCell may be sent (e.g., transmitted) in an RAR or combined together with the layer 1 or layer command, for example, indicating the PCell switching. The ETA procedure may reduce the latency for uplink synchronization with the target PCell upon performing a HO procedure (or a PCell switching procedure).

At step 4134, the wireless device may receive a second L1/L2 command (e.g., MAC CE as shown in FIG. 41) indicating the PCell switching from Cell 0 to Cell 1. The second layer 1 or layer 2 command may further indicate the TA (e.g., forwarded from the target base station to the source base station and used for the target PCell in future), for example, if the TA is not received before receiving the second layer 1 or layer 2 command. The second layer 1 or layer 2 command may further indicate a beam information (e.g., a TCI state and/or an SSB index, which may be obtained, for example, in the early CSI report as described herein) to be used for downlink reception and/or uplink sending (e.g., transmission) over Cell 1. At step 3936, the wireless device may switch the PCell from Cell 0 to Cell 1 and send (e.g., transmit) PUSCH/PUCCH via Cell 1 based on the TA, for example, based on (e.g., after or in response to) receiving the second layer 1 or layer 2 command. The wireless device may receive downlink signals and send (e.g., transmit) uplink signals based on the indicated beam information. Switching the PCell from Cell 0 to Cell 1 may comprise at least one of: using RRC configuration parameters of Cell 1, stopping use of the RRC configuration parameters of Cell 0, resetting/reconfiguring MAC entity, receiving RRC messages/MIB/SSBs/SIBs/PDCCHs/PDSCHs from Cell 1 and stopping receiving RRC messages/MIB/SSBs/SIBs/PDCCHs/PDSCHs from Cell 0. A PCell switch procedure based on an layer 1 or layer 2 command (e.g., combined with an early CSI report and/or an ETA procedure) may be referred to as an LTM procedure, for example, based on examples described herein with respect to FIG. 39.

FIG. 42, FIG. 43 and FIG. 44 show examples of RRC messages for layer 1 or layer 2 CSI measurement and/or reporting configuration. A base station may send (e.g., transmit) to a wireless device, an RRC message of a serving cell (e.g., ServingCellConfig IE in FIG. 42) comprising configuration parameters of layer 1 or layer 2 measurements (e.g., csi-MeasConfig IE) and layer 3 measurements (e.g., servingCellMO IE). A csi-MeasConfig IE may indicate a list of non-zero power CSI-RS resource (e.g., nzp-CSI-RS-ResourceToAddModList), a list of non-zero power CSI-RS resource sets (e.g., nzp-CSI-RS-ResourceSetToAddModList), a list of SSB resource sets (e.g., csi-SSB-ResourceSetToAddList), a list of CSI resource configurations (e.g., csi-ResourceConfigToAddList), a list of CSI report configurations (e.g., csi-ReportConfigToAddList) and/or etc. A non-zero power CSI resource (e.g., NZP-CSI-RS-Resource) may be identified by an NZP-CSI-RS-Resourceld and may be configured with a periodicity and offset parameter (CSI-ResourcePeriodicityAndOffset) and a QCL configuration (e.g., TCI-stateld), etc. A CSI-RS resource may be implemented based on, for example, examples described herein with respect to FIG. 11B. A non-zero power CSI resource set may be identified by an NZP-CSI-RS-ResourceSetld and may comprise a list of non-zero power CSI-RS resources.

As shown in FIG. 43, a csi-SSB-ResourceSet may be identified by a CSI-SSB-ResourceSetld and may comprise a list of SSB indexes. Each SSB index may be associated with a respective ServingAdditionalPCIIndex of a list of additional PCIs (servingAdditionalPCIList). The servingAdditionalPCIList may indicate the physical cell IDs (PCIs) of the SSBs in the csi-SSB-ResourceList. If the servingAdditionalPCIList is present in the csi-SSB-ResourceSet, the list may have the same number of entries as csi-SSB-ResourceList. The first entry of the list may indicate the value of the PCI for the first entry of csi-SSB-ResourceList, the second entry of this list may indicate the value of the PCI for the second entry of csi-SSB-ResourceList, and so on. For each entry of the servingAdditionalPCIList, if the value is zero, the PCI may comprise the PCI of the serving cell in which this CSI-SSB-ResourceSet is defined, otherwise, the value may comprise additionalPCIIndex-r17 of an SSB-MTC-AdditionalPCI-r17 configured using the additionalPCI-ToAddModList-r17 in ServingCellConfig, and the PCI may comprise the additionalPCI-r17 in this SSB-MTC-AdditionalPCI-r17.

As shown in FIG. 43, based on the list of NZP-CSI-RS-ResourceSets and the list of csi-SSB-ResourceSets, the base station may configure, for each CSI resource configuration (e.g., CSI-ResourceConfig) identified by CSI-ResourceConfigld, a list of CSI-RS resource sets (csi-RS-ResourceSetList) comprising a list of non-zero power CSI-RS resource sets (e.g., nzp-CS-RS-ResourceSetList) and/or a list of csi-SSB-ResourceSets (e.g., csi-SSB-ResourceSetList) for CSI measurement, or comprising a list of csi-IM-Resource sets (e.g., csi-IM-ResourceSetList) for interference measurements. Each CSI resource of a CSI resource configuration may be located in the DL BWP identified by the higher layer parameter BWP-id of the CSI resource configuration, and all CSI Resource lists linked to a CSI Report Setting may have the same DL BWP.

As shown in FIG. 44, based on the CSI resource configurations described herein with respect to FIG. 42 and/or FIG. 43, the base station may configure, for each CSI report configuration (e.g., CSI-ReportConfig) identified by a CSI report configuration identifier (e.g., CSI-ReportConfigId), a serving cell index indicating the serving cell in which the CSI-ResourceConfig are to be found (if the field is absent, the resources are on the same serving cell as this report configuration), a CSI-ResourceConfigld indicating CSI resources for channel measurement, a report type indication indicating whether the CSI report is periodic, semi-persistent CSI report on PUCCH, semi-persistent CSI report on PUSCH, or aperiodic, a report quantity indication indicating a report quantity (e.g., CRI-RSRP, SSB-index-RSRP, etc.) (e.g., wherein SSB-index-RSRP may be referred to as layer 1 RSRP (L1-RSRP) herein), a time domain restriction indication for channel measurements (e.g., time RestrictionForChannelMeasurements), etc. A semi-persistent CSI report on PUCCH may be triggered, for example, by a SP CSI activation/deactivation MAC CE. A semi-persistent CSI report on PUSCH may be triggered, for example, by a DCI with CRC being scrambled by SP-CSI-RNTI. An aperiodic CSI report may be indicated by a DCI scheduling a PUSCH transmission and comprising an aperiodic CSI request field.

The wireless device may measure and send (e.g., transmit) a CSI report, for example, based on the configurations of CSI measurement and reports via RRC messages of FIG. 42, FIG. 43, and/or FIG. 44. For beam measurements, the wireless device may send (e.g., transmit) an L1-RSRP report.

For example, a wireless device may be configured (e.g., based on examples described herein with respect to FIG. 42, FIG. 43, and/or FIG. 44) with CSI-RS resources, SS/PBCH block resources or both CSI-RS and SS/PBCH block resources, if resource-wise quasi co-located with ‘type C’ and ‘type D’ if applicable. The wireless device may be configured with CSI-RS resource setting up to 16 CSI-RS resource sets having up to 64 resources within each set. The total number of different CSI-RS resources over all resource sets may be no more than 128.

For L1-RSRP reporting, if the higher layer parameter nrofReportedRS in CSI-ReportConfig is configured to be one, the reported L1-RSRP value may be defined by a 7-bit value in the range [−140,−44] dBm with 1 dB step size. If the higher layer parameter nrofReportedRS is configured to be larger than one, or if the higher layer parameter groupBasedBeamReporting is configured as ‘enabled’, or if the higher layer parameter groupBasedBeamReporting-r17 is configured, the wireless device may use differential L1-RSRP based reporting, where the largest measured value of L1-RSRP may be quantized to a 7-bit value in the range [−140,−44] dBm with 1 dB step size, and the differential L1-RSRP may be quantized to a 4-bit value. The differential L1-RSRP value may be computed with 2 dB step size with reference to the largest measured L1-RSRP value which may comprise part of the same L1-RSRP reporting instance. If the higher layer parameter groupBasedBeamReporting-r17 in CSI-ReportConfig is configured, the wireless device may indicate the CSI Resource Set associated with the largest measured value of L1-RSRP, and for each group, CRI or SSBRI of the indicated CSI Resource Set may be present first.

If the wireless device is configured with SSB-MTC-AdditionalPCI, a CSI-SSB-ResourceSet configured for L1-RSRP reporting may include one set of SSB indices and one set of PCI indices, where each SSB index may be associated with a PCI index, for example, as described herein with respect to FIG. 43. If the wireless device is configured with a CSI-ReportConfig with the higher layer parameter reportQuantity set to ‘cri-RSRP-Capability [Set] Index’ or ‘ssb-Index-RSRP-Capability [Set] Index’, an index of wireless device capability value set, for example, indicating the maximum supported number of SRS antenna ports, may be reported along with the pair of SSBRI/CRI and L1-RSRP. If a wireless device is configured with the higher layer parameter SSB-MTC-AdditionalPCI, the wireless device may be allowed to report in a single reporting instance up to four SS/PBCH Block Resource indicators (SSBRIs) for each report setting, where SSB resources are associated with PCI indices referring to the PCI of the serving cell and PCI(s) different from the PCI of the serving cell within the set of PCIs configured.

Layer 1 CSI reporting for inter-cell multi-TRP may be supported and specified in at least some wireless communications (e.g., as shown in FIG. 33B and/or FIG. 43) (e.g., such as in 3GPP NR Release17 (Rel.17 or R17)) by configuring an SSB/CSI-RS with additional PCI different from PCI of a serving cell and configuring CSI reporting, of the serving cell, associated with the SSB/CSI-RS. In at least some wireless communications (e.g., such as in 3GPP NR Rel.17), the L1 CSI reporting for inter-cell multi-TRP specified may have limitations which comprise: the SSB of the (non-serving) cell with different PCI from a serving cell being completely contained in the active BWP or associated with initial downlink BWP of the wireless device; the SSB of the (non-serving) cell with different PCI from the serving cell having the same SCS and center frequency as the SSB of the serving cell in frequency domain; and in time domain: the SSB of the (non-serving) cell with different PCI from the serving cell having the same sfn-SSB-Offset in time domain; the timing difference of arrival at the wireless device between the SSBs of the serving cell and the (non-serving) cell with different PCI being less than CP length of the corresponding SCS; and the wireless device having sent a valid L3 measurement report within the last 5 seconds. Otherwise, the L1-RSRP measurements for a (non-serving) cell with different PCI from the serving cell is not supported by the wireless device and/or the base station in at least some wireless communications (e.g., such as in 3GPP NR Rel.17).

For L3 beam/cell measurement supported in at least some wireless communications (e.g., such as in 3GPP NR Rel. 15˜17), inter-frequency measurement and intra-frequency measurement are characterized as follow, where the intra-frequency measurement requires the center frequency of the SSB of the serving cell indicated for measurement and the center frequency of the SSB of the non-serving cell are the same, and the subcarrier spacing of the two SSBs are also the same, otherwise, the measurement is categorized as inter-frequency measurement (e.g., as specified in section 9.3 of TS38.133). The intra-frequency and inter-frequency measurement for CSI-RS based measurement are defined in section 9.10.2 and 9.10.3 of TS38.133, similarly as SSB-based measurement.

For example, for inter-frequency L3 measurement, the wireless device may be configured with a MG for measuring the non-serving cell or the candidate target cell. Additionally or alternatively, the wireless device may send (e.g., transmit) to the base station a wireless device capability parameter (e.g., interFrequencyMeas-NoGap-r16) indicating whether the wireless device can perform inter-frequency SSB based measurements without MGs if the SSB is completely contained in the active BWP of the wireless device (e.g., as specified in TS 38.133). If this parameter is indicated for FR1 and FR2 differently, each indication corresponds to the frequency range of cells to be measured. Additionally or alternatively, for intra-frequency L3 measurement, the wireless device may measure the non-serving cell or the target cell without using the MG.

The early CSI reporting for a candidate cell and a serving cell may be considered as inter-frequency measurement in at least some wireless communications (e.g., such as in 3GPP Rel.18 LTM), which may be different from inter-cell multi-TRP based measurement in at least some other wireless communications (e.g., such as in 3GPP Rel. 17). The serving cell and the non-serving cell may belong to the same DU (as examples herein with respect to FIG. 33B, and/or such as in for 3GPP Rel. 17 inter-cell multi-TRP), which may be referred to as intra-DU inter-cell deployment. However, the serving cell and the non-serving cell in at least some wireless communications (e.g., such as in 3GPP Rel.18 LTM) may belong to the same DU (which may be considered as intra-frequency deployment) or may not belong to the same DU which may be referred to as inter-DU inter-cell deployment (which may be considered as inter-frequency deployment). The examples not included in intra-frequency (e.g., such as for 3GPP Rel.18 LTM) may be regarded as inter-frequency, which may include, for example, at least the following examples: the frequency of the measured RS of a candidate cell is not covered by any of the active BWPs of SpCell and SCells configured for a wireless device, but are covered by some of the configured BWPs of SpCell and SCells configured for a wireless device; and the frequency of the measured RS of a candidate cell is not covered by any of the configured BWPs of SpCell and SCells configured for a wireless device. If the wireless device performs the layer 1 or layer 2 CSI measurement and/or reporting for a candidate target cell for at least some wireless communications (e.g., such as for 3GPP Rel. 18 LTM), the time difference between the downlink signals from the serving (source) cell and the candidate target cell may be above CP which may be different from the measurements for at least some other wireless communications (e.g., such as for a 3GPP Rel.17 inter-cell multi-TRP example).

Given that the frequency deployment of a candidate target cell in at least some wireless communications (e.g., such as in 3GPP Rel.18 LTM) may be different from at least some other wireless communications (e.g., such as in 3GPP Rel.17 inter-cell multi-TRP) and the time difference of a serving cell and the candidate target cell may be above CP, an MG may be desired for L1/L2 CSI measurement and reporting for the candidate target cell in at least some wireless communications (e.g., such as in 3GPP Rel.18 LTM). The MG for L1/L2 CSI measurement and reporting may be shorter than the MG for L3 inter-frequency measurement in at least some wireless communications (e.g., such as in 3GPP Rel.18 LTM).

In at least some technologies, network energy saving operation may comprise limiting performance of one or more operations. For example, network energy saving operation may comprise shutting down some cells or reducing periodicity of downlink signals (e.g., SSBs/CSI-RSs/system information block (SIBx)) with or without beam sweeping, which may be different from the power saving operations (e.g., a DRX operation as described above with respect to FIG. 30, FIG. 31, FIG. 32A and/or FIG. 32B) for a wireless device. Shutting down cells (entirely or partially) may lead to negative impact on data transmission latency and/or power consumption during the access process. Another option may comprise modifying existing SSB towards a lighter version by carrying no or minimal info, such as PSS for example, which may be called as “light SSB”. This “light SSB” may be combined with other techniques such as less frequent SSB transmission (e.g., with a periodicity >20 msec), or with “on-demand SSB”; where “on-demand SSB” may be the SSB transmission that is triggered by wireless device via an UL trigger signal. A base station may send (e.g., transmit) this “light SSB”. The wireless devices may react by sending (e.g., transmitting) an uplink trigger signal, for example, if there are wireless devices monitoring this “light SSB” and trying to access the network. Upon reception of the uplink trigger signal, the base station may start sending (e.g., transmitting) the full-blown SSB. The network may adjust the SSB transmission configuration to respond to the wireless device's indication after receiving the uplink trigger signal.

In at least some technologies, network energy saving operation may comprise periodically turning a cell on and off for downlink transmission. The base station, in a cell on duration, may send (e.g., transmit) downlink signals normally (without limitation) if the network energy saving operation is not performed. The base station, in a cell off duration, may stop sending (e.g., transmitting) some downlink signals/channels (e.g., persistent/semi-persistent (P/SP), CSI-RSs, positioning reference signal (RS), semi-persistent scheduling physical downlink shared channel (SPS PDSCH), physical downlink control channel (PDCCH) with wireless device specific radio network temporary identifiers (RNTIs), PDCCH in type 3 common search spaces, etc.). A type 3 common search space may be configured by SearchSpace in PDCCH-Config with searchSpaceType=common for DCI formats with Cyclic redundancy check (CRC) scrambled by INT-RNTI, SFI-RNTI, TPC-PUSCH-RNTI, TPC-PUCCH-RNTI, TPC-SRS-RNTI, or CI-RNTI and, only for the primary cell, C-RNTI, MCS-C-RNTI, CS-RNTI(s), or PS-RNTI, or configured by SearchSpace in pdcch-ConfigMulticast for DCI formats with CRC scrambled by G-RNTI, or G-CS-RNTI, or configured by searchSpaceMCCH and searchSpaceMTCH on a secondary cell for a DCI format 4_0 with CRC scrambled by a MCCH-RNTI or a G-RNTI for broadcast. The base station may avoid scheduling dynamic PDSCHs (or A-CSI-RSs) addressed to wireless device specific RNTIs (or may not send/transmit dynamic PDSCHs) on the cell. The base station, in the cell off duration, may keep sending (e.g., transmitting) some important/common downlink signals (e.g., SSBs, SIBx, paging/PEI, RAR, etc.). The periodically turning the cell on and off (or partially off) may be referred to as a cell DTX (or C-DTX) operation, in this specification, which may comprise a time period when the cell is turned on and a time period when the cell is turned off (or partially off). A time period when the cell is turned on for the cell DTX operation may be referred to as a cell DTX on duration, a cell DTX active duration, or a cell DTX on period. A time period when the cell is turned off (or partially off) for the cell DTX operation may be referred to as a cell DTX off duration/period, a cell DTX inactive (or non-active) duration/period or the like in this specification.

Network energy saving operation may comprise periodically turning a cell on and off for uplink reception. The base station, in a cell on duration, may receive uplink signals normally (without limitation) if the network energy saving operation is not performed. The base station, in a cell off duration, may stop receiving some uplink signals/channels (e.g., SR, P/SP CSI report, P/SP SRS, CG-PUSCH, etc.). The base station may avoid scheduling dynamic PUSCHs (and/or A-SRS) addressed to wireless device specific RNTIs (or may not receive dynamic PUSCHs), in addition to stopping receiving the above uplink signals/channels. The base station, in the cell off duration, may keep receiving some important uplink signals (e.g., preambles, wake-up signals, etc.). The periodically turning the cell on and off (or partially off) for uplink reception may be referred to as a cell DRX (or C-DRX) operation, in this specification, which may comprise a time period when the cell is turned on and a time period when the cell is turned off (or partially off). A time period when the cell is turned on for the cell DRX operation may be referred to as a cell DRX on duration, a cell DRX active duration, or a cell DRX on period. A time period when the cell is turned off (or partially off) for the cell DRX operation may be referred to as a cell DRX off duration, a cell DRX inactive (or non-active) duration, or a cell DRX off period. A C-DTX operation and a C-DRX operation may be exchangeable in terms of applications of one or more example embodiments.

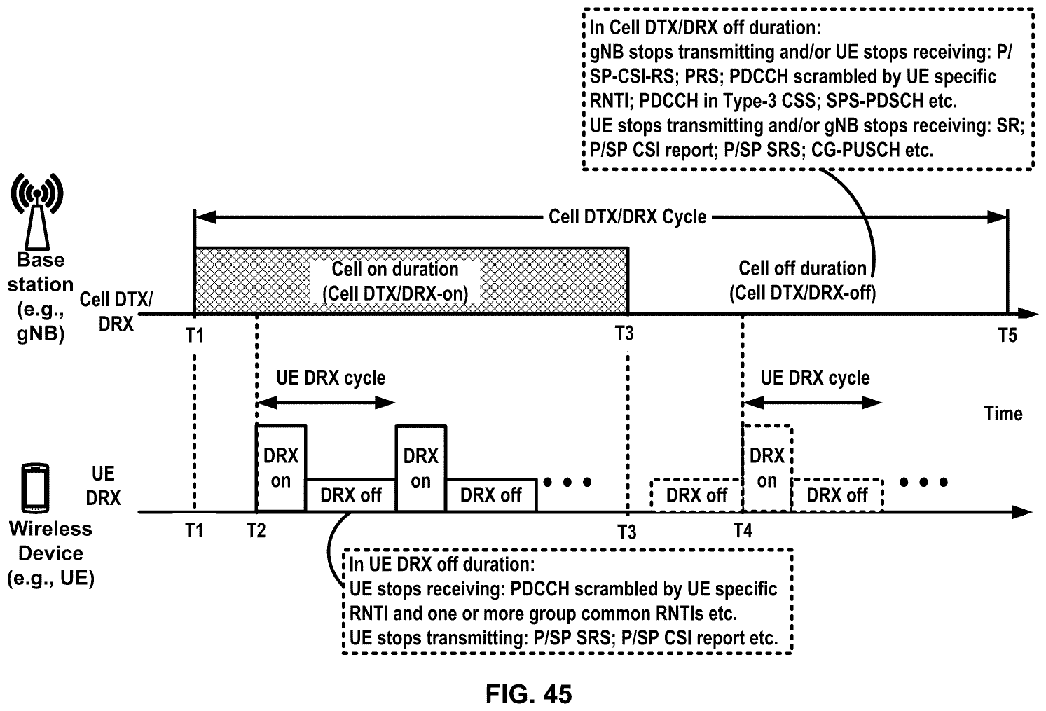

FIG. 45 shows an example of Cell-DTX/DRX-based network energy saving (NES) operation. In an example, network energy saving operation may comprise a cell DTX/DRX configuration/mode/state/operation, (e.g., similar to wireless device DRX configuration, where a wireless device DRX configuration is described above with respect to FIG. 30, FIG. 31, FIG. 32A and/or FIG. 32B). The wireless device DRX operation may be referred to as U-DRX, compared with C-DTX/DRX for the Cell DTX/DRX configuration in this specification. The base station, during a cell DTX/DRX operation, may (periodically) power-on a cell (or a plurality of cells) for a first time duration (e.g., Cell DTX/DRX on duration) and then power-off the cell for a second time duration (e.g., Cell DTX/DRX off duration).

A base station, as shown in FIG. 45, may send (e.g., transmit) downlink signals/channels (without limitation), for example, if the C-DTX/DRX is not configured on the cell and/or a cell is in the C-DTX/DRX on duration. The base station may stop sending (e.g., transmitting), and/or wireless device(s) may stop receiving, P/SP CSI-RSs, positioning RS, SPS PDSCH, PDCCH with wireless device specific RNTIs, PDCCH in type 3 common search spaces, dynamic PDSCHs scheduled by DCIs addressed to wireless device specific RNTIs, etc, for example, if the cell is in the C-DTX/DRX off duration. The base station may stop receiving, and/or wireless device(s) may stop sending (e.g., transmitting) SR, P/SP CSI report, P/SP SRS, CG-PUSCH, dynamic PUSCHs scheduled by DCIs addressed to wireless device specific RNTIs, etc, for example, if the cell is in the C-DTX/DRX off duration.

A U-DRX operation, as shown in FIG. 45, may be configured for a wireless device on top of the C-DTX/DRX configuration. A U-DRX operation may be implemented based on example embodiments described above with respect to FIG. 30, FIG. 31, FIG. 32A and/or FIG. 32B. The U-DRX configuration may be aligned with the C-DTX/DRX configuration.

A starting point (e.g., T2 in FIG. 45) of a U-DRX cycle, based on the U-DRX configuration being aligned with the C-DTX/DRX configuration, may be within a C-DTX/DRX on duration (e.g., from T1 to T3 in FIG. 45). The wireless device, in a C-DTX/DRX on duration of a C-DTX/DRX cycle (e.g., with a length in time domain from T1 to T5 in FIG. 45), may perform DRX operation normally based on example described above with respect to FIG. 30, FIG. 31, FIG. 32A and/or FIG. 32B.

A wireless device, as shown in FIG. 45, may monitor PDCCH for the MAC entity (of the wireless device)'s C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI in a U-DRX on duration (e.g., based on examples of FIG. 30, FIG. 31, FIG. 32A and/or FIG. 32B) of a U-DRX cycle, and may stop monitoring those PDCCHs in a U-DRX off duration (e.g., based on examples of FIG. 30, FIG. 31, FIG. 32A and/or FIG. 32B) of the U-DRX cycle, for example, if the wireless device performs DTX operation within the C-DTX/DRX on duration of the C-DTX/DRX cycle. In an example, a length of U-DRX cycle for a specific wireless device may be shorter than a length of C-DTX/DRX cycle for a cell. Different wireless devices may be configured with different starting points of a U-DRX configuration. Different wireless devices may be configured with different lengths of a U-DRX cycle of a U-DRX configuration. A U-DRX configuration may be utilized for power saving of a specific wireless device. A C-DTX/DRX configuration may be utilized for network energy saving for a specific cell (which may serve multiple wireless devices).

A wireless device, as shown in FIG. 45, may monitor PDCCH for the MAC entity (of the wireless device)'s C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI in a U-DRX on duration of a U-DRX cycle, and may stop monitoring those PDCCHs in a U-DRX off duration of the U-DRX cycle. The length of U-DRX cycle for a specific wireless device may be shorter than the length of C-DTX/DRX cycle for a cell, for example, if the wireless device performs DTX operation within the C-DTX/DRX on duration of the C-DTX/DRX cycle.

A wireless device, as shown in FIG. 45, may skip PDCCH monitoring (for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI) in the U-DRX on duration of the U-DRX cycle and/or may skip PDCCH monitoring on type 3 common search space, for example, if a U-DRX cycle of the wireless device is located outside of the C-DTX/DRX on duration of the C-DTX/DRX cycle (or inside of a C-DTX/DRX off duration of the C-DTX/DRX cycle, e.g., the duration between T3 and T5 in FIG. 45). The wireless device may skip PDCCH monitoring in the U-DRX off duration of the U-DRX cycle if a U-DRX cycle of the wireless device is located outside of the C-DTX/DRX on duration of the C-DTX/DRX cycle (or inside a C-DTX/DRX off duration of the C-DTX/DRX cycle.

A base station may enable a NES operation (e.g., a C-DTX/DRX configuration based on the example described above with respect to FIG. 45). The C-DTX/DRX configuration for a cell, which is applied for all wireless devices (e.g., in RRC Connected state/mode) served by the cell, may be different from a U-DRX configuration configured for a specific wireless device, e.g., based on examples of FIG. 45. A U-DTX configuration may be configured by wireless device specific RRC messages and indicated by a MAC CE (e.g., a DRX MAC CE for a (long) DRX command, e.g., based on example embodiments described above with respect to FIG. 19), based on the examples described above with respect to FIG. 30, FIG. 31, FIG. 32A and/or FIG. 32B. The U-DRX configuration may be per-cell-group configured, in which case the wireless device may apply the same U-DRX pattern for all cells in the same cell group. Different cell groups may be configured with different U-DRX configurations.

In at least some technologies, a wireless device may send (e.g., transmit), to a base station, wireless device capability parameters indicating whether the wireless device supports a U-DRX configuration/operation (e.g., a short DRX cycle, a long DRX cycle, a secondary DRX (cell) group, etc.) so that the base station may configure a proper U-DRX configuration for the wireless device. However, the wireless device that supports a wireless device specific DRX configuration/operation may not support a cell specific C-DTX/DRX configuration/operation, because the wireless device may have different transmission/reception requirements in the wireless device-specific DRX operation and the cell-specific C-DTX/DRX operation, such as described with respect to FIG. 45. Some wireless devices may support only per cell group configured U-DRX operation. Some wireless devices may support only per cell configured C-DTX/DRX operation. Some wireless devices may support both U-DTX operation and C-DTX/DRX operation. A base station, without knowledge of whether C-DTX/DRX is supported on a specific cell by a wireless device, may incorrectly configure a C-DTX/DRX for the wireless device who may support U-DTX only. As described herein, advantages may be provided by enabling a base station to correctly configure U-DRX and/or C-DTX/DRX to a wireless device, such as for power saving of a wireless device and/or network energy saving for a cell.

In at least some technologies, a cell (a source cell and/or one or more candidate cells) may be enabled with a NES/C-DTX/DRX operation, wherein the enabling may be via an RRC message. The cell may be enabled with a NES/C-DTX/DRX configuration (and/or from a plurality of C-DTX/DRX configurations), wherein the plurality of C-DTX/DRX configurations may be configured by the base station in RRC message(s) and the C-DTX/DRX configuration may be enabled by a MAC CE and/or DCI. However, at least some technologies may not support both operations (C-DTX/DRX configured/enabled by RRC message and C-DTX/DRX configured by RRC message and enabled by MAC CE/DCI). For example, a base station, may lose the flexibility to configure/enable a C-DTX/DRX for a cell. As described herein, advantages may result by supporting C-DTX/DRX configuration flexibility for a base station and/or a wireless device.

As described herein, a wireless device may send (e.g., transmit) and/or a base station may receive one or more first capability parameters (of the wireless device) indicating wireless device capability. The wireless device capability indicted in the one or more first capability parameters may comprise at least one of: whether the wireless device supports (per cell)C-DTX/DRX configuration for a cell; whether the wireless device supports an RRC-configured/enabled C-DTX/DRX configuration for a cell; whether the wireless device supports an RRC-configured and MAC CE/DCI-enabled C-DTX/DRX configuration for a cell. The one or more first capability parameters may be per wireless device, per cell, per cell group, per frequency band, per frequency band combination, or per frequency range indicated. The one or more first capability parameters may be separately and/or independently indicated from one or more second capability parameters (of the wireless device) used to indicate whether a U-DRX configuration is supported by the wireless device (e.g., whether a short DRX cycle is supported, whether a long DRX cycle is supported, and/or whether a secondary DRX group is supported.). The base station, based on the one or more first capability parameters and/or the one or more second capability parameters, may configured/indicate the C-DTX/DRX configuration and/or the U-DRX configuration to the wireless device for power saving of the wireless device and network energy saving of the cell.

As described herein, a base station may send (e.g., transmit) and/or a wireless device may receive one or more RRC messages comprising configuration parameters of a C-DTX/DRX pattern of a cell where the configuration parameters comprise a parameter indicating whether a MAC CE/DCI is used to enable the C-DTX/DRX pattern, or an enabling/disabling state of the C-DTX/DRX pattern upon the one or more RRC messages are received by the wireless device or sent (e.g., transmitted) by the base station.

As described herein, a base station may send (e.g., transmit) and/or a wireless device may receive one or more RRC messages comprising first configuration parameters of C-DTX/DRX configurations of a plurality of serving cells, each serving cell being associated with a respective C-DTX/DRX configuration. The one or more RRC messages may comprise second configuration parameters of U-DRX configuration. The U-DRX configuration may per cell group configured, wherein different cell groups may be configured with different U-DRX configurations associated with different configuration parameters. There may be only one DRX group and all serving cells belong to that one DRX group, for example, if RRC does not configure a secondary DRX group. Each serving cell may be uniquely assigned to either of the two groups, for example, if two DRX groups are configured. The wireless device, based on the first configuration parameters of a C-DTX/DRX configuration for a first cell and the second configuration parameters of the U-DRX for a cell group, may jointly apply the C-DTX/DRX operation and the U-DRX operation based on (e.g., in response to) the cell group comprising the first cell (or the first cell belonging to the cell group). The wireless device, based on (e.g., in response to) the cell group comprising the first cell (or the first cell belonging to the cell group), may determine whether to monitor a PDCCH on the first cell in a time duration based on whether the time duration is within both a C-DTX/DRX on duration of a C-DTX cycle of the first cell and a U-DRX on duration of a U-DRX cycle of the cell group. In an example, the wireless device may determine whether to monitor PDCCH based on whether a part of the U-DRX on duration which overlaps with the C-DTX/DRX on duration is longer than a time duration threshold for the PDCCH monitoring, for example, if a U-DRX on duration is not fully within a C-DTX/DRX on duration of a C-DTX cycle. The time duration threshold may be configured by the base station in the one or more RRC messages or predefined as a fixed value.

Configuration parameters of a C-DTX/DRX configuration for a cell may comprise at least one of: a C-DTX cycle length/periodicity (e.g., TC-DTX), a subframe/slot offset defining the subframe/slot where the C-DTX cycle starts (e.g., c-dtx-StartOffset), a C-DTX on duration timer (e.g., c-dtx-onDurationTimer) which may define the duration at the beginning of the C-DTX cycle, and/or a delay before starting the c-dtx-onDuration Timer (e.g., c-dtx-SlotOffset), etc. A C-DTX cycle length may be equivalent to the periodicity of a C-DTX configuration. One or more configuration parameters of different C-DTX/DRX configurations for different cells may be different.

Configuration parameters of a U-DRX configuration for a cell group may be configured with a U-DRX cycle length (e.g., TU-DRX), an offset defining the subframe where the U-DRX cycle starts (e.g., drx-StartOffset), a U-DRX on duration timer (e.g., drx-onDurationTimer) which may define the duration at the beginning of the U-DRX cycle, and/or a delay before starting the drx-onDuration Timer (e.g., drx-SlotOffset). The U-DRX may be configured with one or more HARQ retransmission timers (e.g., drx-RetransmissionTimerDL, drx-RetransmissionTimerUL, drx-HARQ-RTT-TimerDL, drx-HARQ-RTT-TimerUL, etc.).

As described herein, a base station may send (e.g., transmit) and/or a wireless device may receive one or more RRC messages comprising first configuration parameters of C-DTX/DRX configurations of a plurality of cells, wherein each cell is associated with a respective C-DTX/DRX configuration. The one or more RRC messages may comprise second configuration parameters of U-DRX configuration. The second configuration parameters may comprise a U-DRX cycle length (e.g., TU-DRX), an offset defining the subframe, relative to a starting point of a C-DTX/DRX configuration of a cell, where the U-DRX cycle starts (e.g., drx-StartOffset), a U-DRX on duration timer (e.g., drx-onDurationTimer) which defines the duration at the beginning of the U-DRX cycle, and/or a delay before starting the drx-onDurationTimer (e.g., drx-SlotOffset), within a C-DTX on duration of a C-DTX cycle of a cell. In at least some technologies of U-DRX configuration, the U-DRX configuration may be per wireless device configured (not per cell group configured), in which case, the same U-DRX configuration is applied on different cells, even if each cell of the different cells is associated with different C-DTX/DRX configurations. The U-DRX cycle length may be the same for the U-DRX operations on different cells. The starting point of the U-DRX configuration for different cells may be relative to the starting point of C-DTX/DRX configurations for different cells, not relative to an absolute subframe/slot quantity (e.g., number) in a system frame. Examples described herein may resolve one or more of these and/or other problems. For example, the base station may implement the C-DTX/DRX configurations of a plurality of cells for the wireless device.

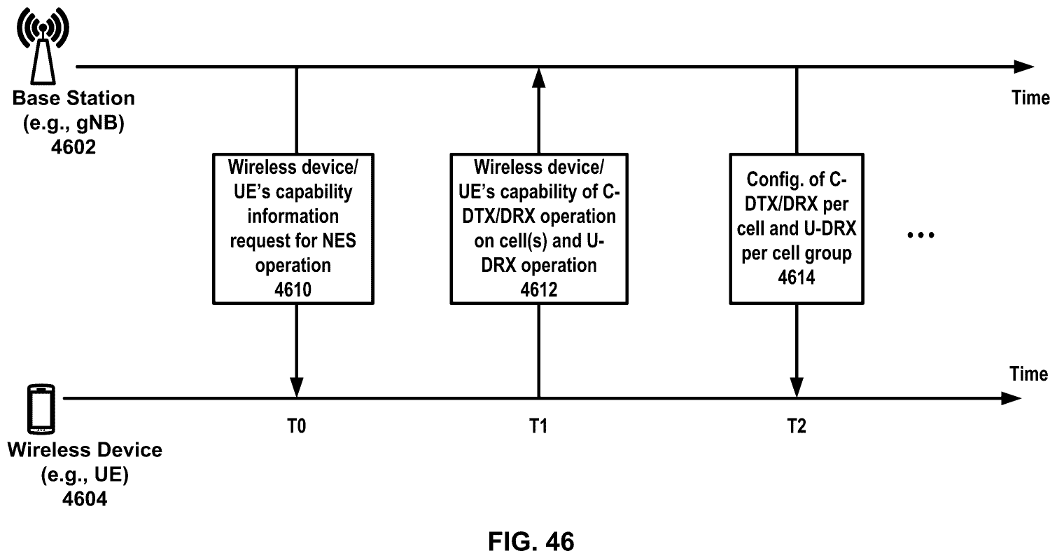

FIG. 46 shows an example of C-DTX/DRX configuration for a wireless device. The wireless device (e.g., wireless device 4604) may receive from a base station (e.g., base station 4602), at TO, a wireless device's capability information request 4610 (e.g., for a NES operation and/or a power saving operation of the wireless device). The wireless device's capability information request 4612 may be sent (e.g., transmitted) by the base station in one or more first RRC messages. The wireless device, based on (e.g., in response to) receiving the wireless device's capability information request, may send (e.g., transmit) to the base station, at T2, a wireless device's capability information of C-DTX/DRX operation on cell(s) and U-DRX operation 4614. The wireless device's capability information may be sent (e.g., transmitted) by the wireless device in one or more second RRC messages.

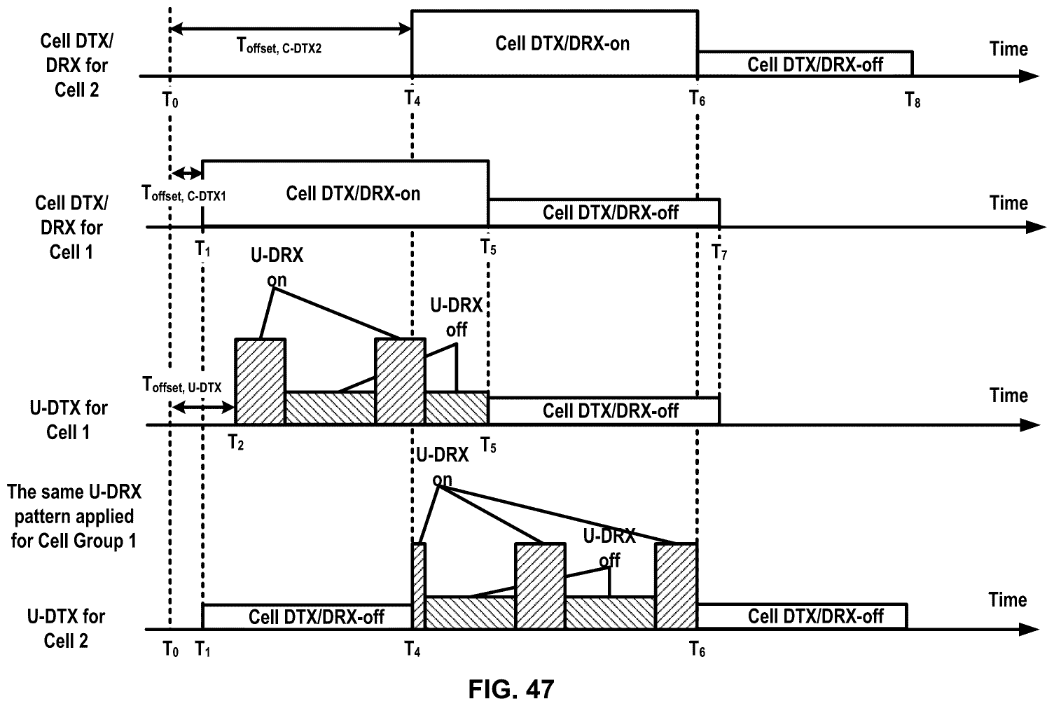

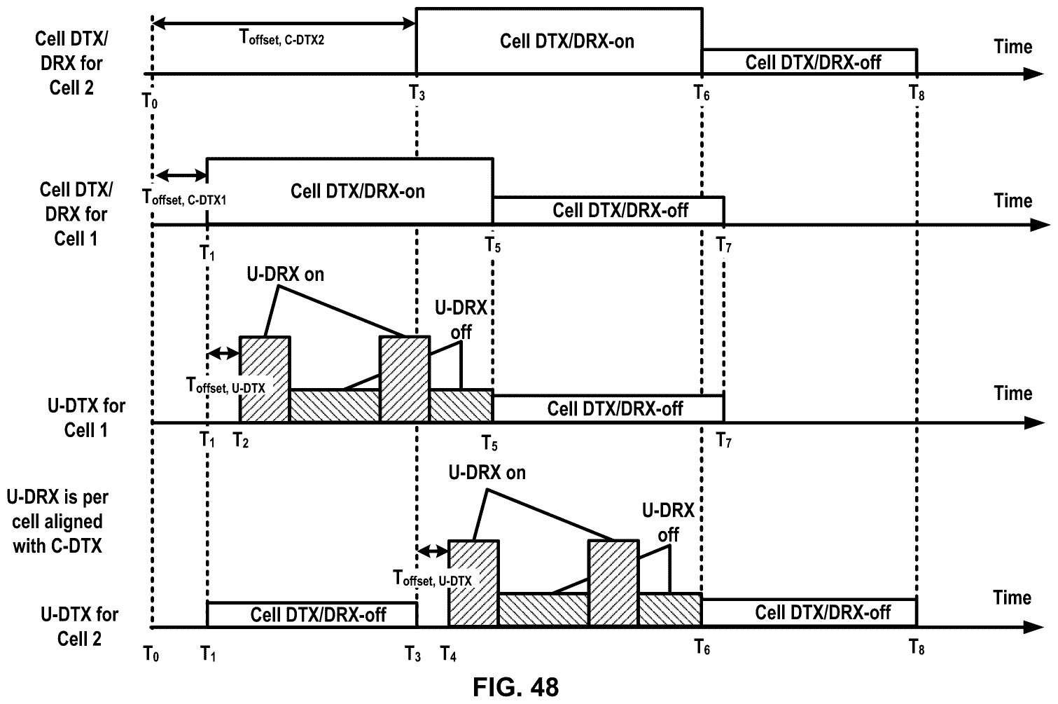

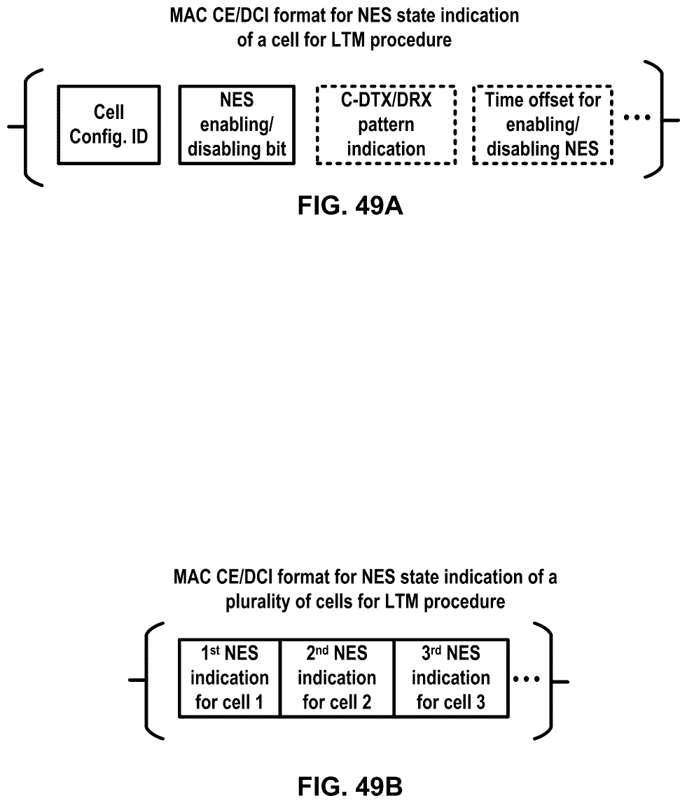

Wireless device's capability information sent (e.g., transmitted) from the wireless device in FIG. 46 to the base station may comprise first parameter(s) indicating whether the wireless device supports (per cell)C-DTX/DRX configuration for a cell; second parameter(s) indicating whether the wireless device supports an RRC-configured/enabled C-DTX/DRX configuration for a cell and/or whether the wireless device supports an RRC-configured and MAC CE/DCI-enabled C-DTX/DRX configuration for a cell. The first/second parameter(s) may be separately and/or independently indicated from one or more third parameters (of the wireless device) used to indicate whether a U-DRX configuration is supported by the wireless device (e.g., whether a short DRX cycle is supported, whether a long DRX cycle is supported, and/or whether a secondary DRX group is supported.). The base station, based on the first parameter(s), the second parameter(s) and the one or more third parameters indicated in the wireless device's capability information, may configure/indicate, at T3, the C-DTX/DRX configuration and/or the U-DRX configuration to the wireless device for power saving of the wireless device and network energy saving of the cell(s). The base station may configure the C-DTX/DRX configuration and the U-DRX configuration based on examples of FIG. 47, FIG. 48, FIG. 49A and/or FIG. 49B, which will be described later in this specification.

As described herein, first parameter(s) and/or second parameter(s) may be per wireless device indicated, wherein the wireless device may support C-DTX/DRX operations for all serving cells. The first and/or second parameters may reduce signaling overhead of capability indication for the C-DTX/DRX operation.

As described herein, first parameter(s) and/or second parameter(s) may be per cell indicated, wherein the wireless device may support C-DTX/DRX operations for a first cell and may not support C-DTX/DRX operations for a second cell. Separately indicating capability of C-DTX/DRX operation for different cells may allow the base station to enable/disable C-DTX/DRX operation for a specific cell.

As described herein, first parameter(s) and/or second parameter(s) may be per cell group indicated, wherein the wireless device may support C-DTX/DRX operations for a first cell group and may not support C-DTX/DRX operations for a second cell group. Separately indicating capability of C-DTX/DRX operation for different cell groups may allow the base station to enable/disable C-DTX/DRX operation for a specific cell. Indicating the capability per cell group instead of per cell may reduce signaling overhead for the capability indication.

As described herein, first parameter(s) and/or second parameter(s) may be per frequency range indicated, wherein the wireless device may support C-DTX/DRX operations for a first frequency range (e.g., FR2) and may not support C-DTX/DRX operations for a second frequency range (e.g., FR1). Separately indicating capabilities of C-DTX/DRX operation for different frequency ranges may allow the base station to enable/disable C-DTX/DRX operation for one or more cells deployed in a specific frequency range.

As described herein, first parameter(s) and/or second parameter(s) may be per frequency band indicated, wherein the wireless device may support C-DTX/DRX operations for a first frequency band (e.g., associated with a band number 256, 260, etc.,) and may not support C-DTX/DRX operations for a second frequency band. One or more frequency bands may be comprised in a frequency range. Separately indicating capabilities of C-DTX/DRX operation for different frequency bands may allow the base station to enable/disable C-DTX/DRX operation for one or more cells deployed in a specific frequency band.

As described herein, first parameter(s) and/or second parameter(s) may be per frequency band combination indicated, in which case, the wireless device may support C-DTX/DRX operations for a first frequency band combination (e.g., band number 256 and 260 etc.,) and may not support C-DTX/DRX operations for a second frequency band combination. Separately indicating capabilities of C-DTX/DRX operation for different frequency band combination may allow the base station to enable/disable C-DTX/DRX operation for one or more cells deployed in a specific frequency band combination.

A base station may send (e.g., transmit) to the wireless device the C-DTX/DRX configuration for the cell, for example, if the first parameter(s) indicates that the wireless device supports C-DTX/DRX configuration for a cell. The base station may not send (e.g., transmit) to the wireless device the C-DTX/DRX configuration for the cell in one or more RRC messages (e.g., wireless device-specific RRC messages), for example, if the first parameter indicates that the wireless device does not support C-DTX/DRX configuration for a cell.

A base station may send (e.g., transmit) to the wireless device the C-DTX/DRX configuration for the cell in one or more RRC messages (e.g., wireless device-specific RRC messages), for example, if the second parameter(s) indicate that the wireless device (only) supports RRC-configured/enabled C-DTX/DRX configuration for a cell (e.g., based on the first parameter(s) indicating that the wireless device supports C-DTX/DRX configuration for a cell), wherein the C-DTX/DRX configuration may be automatically enabled/activated without additional and/or explicit enabling/activation command (e.g., MAC CE and/or DCI).

A base station may send (e.g., transmit) the C-DTX/DRX configuration for the cell in one or more RRC messages (e.g., wireless device-specific RRC messages) and may enable/activate the C-DTX/DRX configuration for the cell by a MAC CE/DCI, if the second parameter(s) indicate that the wireless device (only) supports an RRC-configured and MAC CE/DCI-enabled C-DTX/DRX configuration for a cell (e.g., based on the first parameter(s) indicating that the wireless device supports C-DTX/DRX configuration for a cell), wherein the C-DTX/DRX configuration may be explicitly enabled/activated by an enabling/activation command (e.g., MAC CE and/or DCI).

A base station may send (e.g., transmit) the C-DTX/DRX configuration for the cell in one or more RRC messages, for example, if the second parameter(s) indicate that the wireless device supports both an RRC configured/enabled C-DTX/DRX configuration and an RRC-configured and MAC CE/DCI-enabled C-DTX/DRX configuration for a cell (e.g., based on the first parameter(s) indicating that the wireless device supports C-DTX/DRX configuration for a cell). The C-DTX/DRX configuration may be associated with a plurality of C-DTX/DRX parameters comprising a first parameter indicating an enabling/activation method/state of the C-DTX/DRX configuration.

A first parameter of the C-DTX/DRX configuration, being set to a first value (e.g., “RRC configured/enabled” or “enabled”), may indicate that the C-DTX/DRX configuration indicated in the one or RRC messages may be (automatically) enabled/activated (e.g., without additional/explicit enabling/activation command (e.g., MAC CE/DCI)), wherein the wireless device may apply the C-DTX/DRX operation automatically upon receiving the one or more RRC messages. The first parameter, of the C-DTX/DRX configuration, being set to a second value (e.g., “MAC CE enabler” or “DCI enabler”), may indicate that the C-DTX/DRX configuration indicated in the one or RRC messages need to be enabled/activated with additional/explicit enabling/activation command (e.g., MAC CE/DCI), wherein the wireless device may apply the C-DTX/DRX operation based on (e.g., in response to) receiving the enabling/activation command after receiving the one or more RRC messages. The first parameter of the C-DTX/DRX configuration, being set to a third value (e.g., “disabled/inactivated”), may indicate that the C-DTX/DRX configuration indicated in the one or RRC messages is disabled/inactivated upon the wireless device receiving the one or RRC messages, wherein the wireless device may determine that the C-DTX/DRX is not enabled/activated on the cell.

A wireless device in FIG. 46 may send (e.g., transmit) wireless device's capability information regarding whether the wireless device supports C-DTX/DRX, whether the wireless device supports RRC-configured/enabled C-DTX/DRX, whether the wireless device supports RRC-configured and MAC CE/DCI enabled C-DTX/DRX. The base station, based on the wireless device's capability information, may appropriately configure a C-DTX/DRX operation to the wireless device on a specific cell.

FIG. 47 shows an example of C-DTX/DRX and U-DRX configuration for a wireless device configured with multiple cells, based on examples described above with respect to FIG. 46. In an example, a wireless device may receive from a base station, one or more RRC messages comprising configuration parameters of C-DTX configurations for a first cell (Cell 1) and a second cell (Cell 2) and U-DRX configuration for a cell group. The cell group may comprise at least Cell 1 and Cell 2. The U-DRX configuration may be implemented based on example embodiments described above with respect to FIG. 30 and/or FIG. 31.

Different cells (Cell 1 and Cell 2) in FIG. 47 may be associated with different C-DTX/DRX configuration parameters. The first C-DTX/DRX configuration of Cell 1 may be associated with a first offset (Toffset, C-DTX1) defining a slot/subframe where a C-DTX/DRX cycle of the first C-DTX/DRX configuration may start, a first DTX cycle length/periodicity (e.g., TC-DTX1), a first C-DTX on duration timer defining the duration at the beginning of the first C-DTX/DRX cycle, and/or a first delay (e.g., c-dtx-SlotOffset1) before starting the first C-DTX on duration timer etc. The second C-DTX/DRX configuration of Cell 2 may be associated with a second offset (Toffset, C-DTX2) defining a slot/subframe where a C-DTX/DRX cycle of the second C-DTX/DRX configuration may start, a second DTX cycle length/periodicity (e.g., TC-DTX2), a second C-DTX on duration timer defining the duration at the beginning of the second C-DTX/DRX cycle, and/or a second delay (e.g., c-dtx-SlotOffset2) before starting the second C-DTX on duration timer etc.

A wireless device may start the first C-DTX on duration timer for Cell 1 after the first delay (if it is configured) from the beginning of a subframe (or a slot, wherein examples described below can be applied for the time unit being defined as a slot), for example, if the first C-DTX/DRX configuration is enabled/configured (e.g., based on example embodiments described above with respect to FIG. 46) on Cell 1, wherein the subframe may be determined if a subframe quantity (e.g., number) (nsubframe) of the subframe satisfies the condition: [(SFN×10)+nsubframe] modulo (TC-DTX1)=(Toffset, C-DTX1) modulo (TC-DTX1). SFN may be the system frame quantity (e.g., number) where the subframe may be in. TO in FIG. 47 may be the start/beginning of a system frame. The wireless device may perform downlink receptions (SSB/CSI-RSs/PDCCHs/PDSCHs) and/or uplink transmissions (RACH/SRS/PUCCH/PUSCH) on Cell 1 as it does when C-DTX/DRX operation is not configured on Cell 1, for example, if the first C-DTX on duration timer is running (e.g., between T1 and T5 in FIG. 47) in a C-DTX/DRX cycle of the first C-DTX/DRX configuration. P/SP CSI-RSs, PRSs, CG-PDSCHs, PDCCH with wireless device specific RNTIs, PDCCH in type 3 common may search spaces and/or may stop sending (e.g., transmitting), via Cell 1, P/SP SRSs, P/SP CSI reports, CG-PUSCHs, SR and etc, for example, if the first C-DTX on duration timer expires (e.g., between T5 and T7 in FIG. 47) on Cell 1 in the C-DTX/DRX cycle, the wireless device may stop receiving, from Cell 1.

A wireless device may start the second C-DTX on duration timer for Cell 2 after the second delay from the beginning of a subframe, for example, if the second C-DTX/DRX configuration is enabled/configured (e.g., based on example embodiments described above with respect to FIG. 46) on Cell 2, wherein the subframe may be determined if a subframe quantity/number (nsubframe) of the subframe satisfies the condition: [(SFN×10)+nsubframe] modulo (TC-DTX2)=(Toffset, C-DTX2) modulo (TC-DTX2). SFN may be the system frame quantity (e.g., number) where the subframe is in. TO in FIG. 47 may be the start/beginning of a system frame. The wireless device may perform downlink receptions (SSB/CSI-RSs/PDCCHs/PDSCHs) and/or uplink transmissions (RACH/SRS/PUCCH/PUSCH) on Cell 2 as it does when C-DTX/DRX operation is not configured on Cell 2, for example, if the second C-DTX on duration timer is running (e.g., between T4 and T6 in FIG. 47) in a C-DTX/DRX cycle of the second C-DTX/DRX configuration. The wireless device may stop receiving, from Cell 2, P/SP CSI-RSs, PRSs, CG-PDSCHs, PDCCH with wireless device specific RNTIs, PDCCH in type 3 common may search spaces and/or stop sending (e.g., transmitting), via Cell 2, P/SP SRSs, P/SP CSI reports, CG-PUSCHs, SR and etc, for example, if the second C-DTX on duration timer expires (e.g., between T6 and T8 in FIG. 47) on Cell 2 in the C-DTX/DRX cycle.

Configuration parameters of U-DRX configuration in FIG. 47 may comprise at least one of: a DRX cycle length (e.g., TU-DRX), an offset defining the subframe where the U-DRX cycle may start (e.g., Toffset, U-DRX), a U-DRX on duration timer (e.g., drx-onDurationTimer) which may define the duration at the beginning of the U-DRX cycle, and/or a delay before starting the drx-onDurationTimer (e.g., drx-SlotOffset). The U-DRX may be configured with one or more HARQ retransmission timers (e.g., drx-RetransmissionTimerDL, drx-RetransmissionTimerUL, drx-HARQ-RTT-TimerDL, drx-HARQ-RTT-TimerUL, etc.). The wireless device may start the U-DRX on duration timer for all serving cells in the cell group (e.g., comprising Cell 1 and Cell 2) after the delay from the beginning of a subframe, for example, if the U-DRX configuration is indicated (e.g., via a DRX MAC CE), wherein the subframe may be determined if a subframe quantity (e.g., number) (nsubframe) of the subframe satisfies the condition: [(SFN×10)+nsubframe] modulo (TU-DRX)=(Toffset, U-DRX) modulo (TU-DRX). SFN may be the system frame quantity (e.g., number) where the subframe is in. TO in FIG. 47 may be the start/beginning of a system frame. The wireless device may perform downlink receptions and/or uplink transmissions on all serving cells in the cell group, for example, if U-DRX operation is not configured and/or if the U-DRX on duration timer is running in a U-DRX cycle of the U-DRX configuration. The wireless device may stop monitoring PDCCHs on all serving cells (for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI etc.), for example, if the U-DRX on duration timer expires in a U-DRX cycle of the U-DRX configuration. The wireless device may perform U-DRX operation based on examples described above with respect to FIG. 30 and/or FIG. 31.

Each serving cell is uniquely assigned to one of the one or more groups, for example, if one or more U-DRX groups are configured. The wireless device, based on the first configuration parameters of a C-DTX/DRX configuration for a cell and the second configuration parameters of the U-DRX for a cell group, may jointly apply the C-DTX/DRX operation and the U-DRX operation based on (e.g., in response to) the cell group comprising the cell. Two U-DRX groups (Cell Group 1 and Cell Group 2) may be configured with each U-DRX group being associated with a respective U-DRX configuration. Cell 1 and Cell 2 in FIG. 47 may belong to Cell group 1 associated with the first U-DRX configuration.

A wireless device may determine whether to monitor a PDCCH in a time duration based on whether the time duration is within both a C-DTX/DRX on duration of a C-DTX cycle of the cell and a U-DRX on duration of a U-DRX cycle configured for the cell group (or the U-DRX group), based on (e.g., in response to) a cell being comprised in a cell group (or a U-DRX group) of a plurality of cell groups (or U-DRX groups). The wireless device may perform C-DTX operation only on the cell (and may not perform U-DRX operation on the cell), based on (e.g., in response to) the cell not being comprised in the cell group.

Cell 1 and Cell 2 in FIG. 47 may belong to Cell Group 1 (or DRX group 1). A wireless device may determine whether to receive downlink signals/channels and/or send (e.g., transmit) uplink signals/channels on Cell 1 in a time period based on whether the time period is within a C-DTX on duration of a C-DTX cycle of the first C-DTX configuration for Cell 1 and the time period is within a U-DRX on duration of a U-DRX cycle of the U-DRX configuration for Cell Group 1.

A wireless device, within the C-DTX on duration (between T1 and T5) of the C-DTX cycle of the first C-DTX configuration in FIG. 47, may discontinuously monitor PDCCHs on Cell 1 in a U-DRX on duration (e.g., U-DRX on in FIG. 47) of a U-DRX cycle and may stop monitoring the PDCCHs in a U-DRX off duration (e.g., U-DRX off in FIG. 47) according to the configuration parameters (e.g., TU-DRX, Toffset, U-DRX, drx-onDurationTimer, drx-SlotOffset, etc.) of the U-DRX configuration, based on the example in FIG. 30. The wireless device, outside of the C-DTX on duration (between T5 and T7) of the C-DTX cycle of the first C-DTX configuration, may apply, on Cell 1, the wireless device behavior defined according to the C-DTX off duration of the C-DTX cycle and may not apply the wireless device behavior defined according to the U-DRX operation. The wireless device, during the time period outside of the C-DTX on duration (between T5 and T7) of the C-DTX cycle of the first C-DTX configuration, may stop receiving, from Cell 1, P/SP CSI-RSs, PRSs, CG-PDSCHs, PDCCH with wireless device specific RNTIs, PDCCH in type 3 common may search spaces and/or may stop sending (e.g., transmitting), via Cell 1, P/SP SRSs, P/SP CSI reports, CG-PUSCHs, SR and etc.

A wireless device, within the C-DTX on duration (between T4 and T6) of the C-DTX cycle of the second C-DTX configuration as shown in the example of FIG. 47, may discontinuously monitor PDCCHs on Cell 2 in a U-DRX on duration (e.g., U-DRX on in FIG. 47) of a U-DRX cycle and may stop monitoring the PDCCHs in a U-DRX off duration (e.g., U-DRX off in FIG. 47) according to the configuration parameters (e.g., TU-DRX, Toffset, U-DRX, drx-onDurationTimer, drx-SlotOffset, etc.) of the U-DRX configuration, based on example in FIG. 30. The wireless device, outside of the C-DTX on duration (between T6 and T8) of the C-DTX cycle of the second C-DTX configuration, may apply, on Cell 2, the wireless device behavior defined according to the C-DTX off duration of the C-DTX cycle and may not apply the wireless device behavior defined according to the U-DRX operation. The wireless device, during the time period outside of the C-DTX on duration (between T6 and T8) of the C-DTX cycle of the second C-DTX configuration, may stop receiving, from Cell 2, P/SP CSI-RSs, PRSs, CG-PDSCHs, PDCCH with wireless device specific RNTIs, PDCCH in type 3 common search spaces and/or may stop sending (e.g., transmitting), via Cell 2, P/SP SRSs, P/SP CSI reports, CG-PUSCHs, SR and etc.

A U-DRX on duration, as shown in FIG. 47, may not be fully contained in a C-DTX/DRX on duration, due to the U-DRX configuration being per cell group configured and the C-DTX/DRX configuration being per cell configured. The U-DRX on duration (around T4) on Cell, as shown in FIG. 47, may be truncated (or shortened) due to the beginning part of the U-DRX on duration overlapping with a C-DTX/DRX off duration of the C-DTX/DRX cycle of the second C-DTX/DRX configuration for Cell 2. The U-DRX on duration (around T6) on Cell 2 may similarly be truncated (or shortened) due to the ending part of the U-DRX on duration overlapping with a C-DTX/DRX off duration of the C-DTX/DRX cycle of the second C-DTX/DRX configuration for Cell 2.

A wireless device may determine whether to monitor PDCCHs based on whether a time duration of the U-DRX on duration, which overlaps with the C-DTX/DRX on duration, is longer than a time duration threshold for the PDCCH monitoring, for example, if a U-DRX on duration is not fully within a C-DTX/DRX on duration of a C-DTX cycle. The time duration threshold may be configured by the base station in one or more RRC messages or predefined as a fixed value. The wireless device, based on (e.g., in response to) the time duration overlapping with the C-DTX/DRX on duration being longer than the time duration threshold, may monitor PDCCHs accordingly. The wireless device may skip PDCCH monitoring in the time duration.

A wireless device may determine whether to monitor PDCCH based on whether a ratio between a first time duration of the U-DRX on duration, which overlaps with the C-DTX/DRX on duration, and a second time duration, of the U-DRX on duration, which does not overlap with the C-DTX/DRX on duration, is greater than a threshold for the PDCCH monitoring, for example, if a U-DRX on duration is not fully within a C-DTX/DRX on duration of a C-DTX cycle. The threshold may be configured by the base station in one or more RRC messages or predefined as a fixed value. The wireless device, based on (e.g., in response to) the ratio being greater than the threshold, may monitor PDCCHs accordingly. The wireless device may skip PDCCH monitoring in the first time duration.

A wireless device, based on the example of FIG. 47, may apply the same U-DRX operation (e.g., without adjusting a starting point of a U-DRX cycle) on multiple cells wherein each cell may be associated with different C-DTX/DRX operations. The example may reduce power consumption of the wireless device, in addition to network energy saving for the base station. The example may simplify implementation of C-DTX/DRX and U-DRX operation on multiple cells.

FIG. 48 shows an example of C-DTX/DRX and U-DTX configuration for a wireless device configured with multiple cells, based on the example described above with respect to FIG. 46. In an example, a wireless device may receive from a base station, one or more RRC messages comprising configuration parameters of C-DTX configurations for a first cell (Cell 1) and a second cell (Cell 2) and U-DRX configuration for a cell group. The cell group may comprise at least Cell 1 and Cell 2.

Different cells (Cell 1 and Cell 2) in FIG. 48 may be associated with different C-DTX/DRX configuration parameters. The base station and/or the wireless device may implement C-DTX/DRX configurations on Cell 1 and Cell 2 based on example embodiments described above with respect to FIG. 47.

In the example of FIG. 48 different from FIG. 47, a U-DRX configuration may be configured commonly for all serving cells, wherein a starting point of the U-DRX configuration is relative to a corresponding starting point of a C-DTX/DRX cycle of a specific cell. The configuration parameters of U-DRX configuration, in the example of FIG. 48, may comprise at least one of: a DRX cycle length (e.g., TU-DRX), an offset defining the subframe/slot where the U-DRX cycle may start (e.g., Toffset, U-DRX), a U-DRX on duration timer (e.g., drx-onDurationTimer) which defines the duration at the beginning of the U-DRX cycle, and/or a delay before starting the drx-onDuration Timer (e.g., drx-SlotOffset).

An offset (Toffset, U-DRX) in FIG. 48 may be defined relative to a starting slot/subframe of a C-DTX/DRX cycle associated with a cell. The offset (Toffset, U-DRX), different from FIG. 47, may not be defined relative to a subframe/slot in a system frame. In an example, for Cell 1, the U-DRX cycle on Cell 1 may start at T2 wherein the time gap between T1 and T2 is the configured Toffset, U-DRX, for example, if a C-DTX/DRX cycle starts at T1 on Cell 1 (wherein T1 is after TO determined based on Toffset, C-DTX1 by implementing examples described above with respect to FIG. 46 and/or FIG. 47). For Cell 2, the U-DRX cycle on Cell 2 may start at T4 wherein the time gap between T3 and T4 may be the same configured Toffset, U-DRX used for Cell 1, for example, if a C-DTX/DRX cycle starts at T3 on Cell 2 (wherein T3 is after TO determined based on Toffset, C-DTX2 by implementing example embodiments described above with respect to FIG. 46 and/or FIG. 47).

A wireless device may start the U-DRX on duration timer for Cell 1 after a delay from the beginning of a subframe/slot, for example, if the U-DRX configuration is indicated (e.g., via a DRX MAC CE), wherein the subframe/slot may be a quantity (e.g., number) of slots/subframes (Toffset, U-DRX) after a first subframe/slot where the C-DTX/DRX cycle may start for Cell 1. The first subframe/slot may be determined if a subframe/slot quantity (e.g., number) (nsubframe) of the first subframe/slot satisfies the condition: [(SFN×10)+nsubframe] modulo (TC-DTX1)= (Toffset, C-DTX1) modulo (TC-DTX1). SFN may be the system frame quantity (e.g., number) where the first subframe/slot is in. The wireless device may determine whether to monitor PDCCHs based on whether the U-DRX on duration timer is running for Cell 1, based on examples described above with respect to FIG. 30 and/or FIG. 31.

A wireless device may start the U-DRX on duration timer for Cell 2 after a delay from the beginning of a subframe/slot, for example, if the U-DRX configuration is indicated (e.g., via a DRX MAC CE), wherein the subframe/slot may be a quantity (e.g., number) of slots/subframes (Toffset, U-DRX) after a first subframe/slot where the C-DTX/DRX cycle starts for Cell 2. The first subframe/slot may be determined if a subframe/slot quantity (e.g., number) (nsubframe) of the first subframe/slot satisfies the condition: [(SFN×10)+nsubframe] modulo (TC-DTX2)=(Toffset, C-DTX2) modulo (TC-DTX2). SFN may be the system frame quantity (e.g., number) where the first subframe/slot is in. The wireless device may determine whether to monitor PDCCHs based on whether the U-DRX on duration timer is running for Cell 2, based on examples described above with respect to FIG. 30 and/or FIG. 31.

A U-DRX configuration applied for a cell may be implicitly and/or automatically (e.g., without receiving additional DRX MAC CE in legacy system) enabled for the cell based on (e.g., in response to) the C-DTX/DRX configuration being enabled/activated on the cell. The wireless device, in FIG. 48, may automatically perform U-DRX operations on Cell 1 (and/or Cell 2) within a C-DTX/DRX on duration of a C-DTX/DRX cycle of the C-DTX/DRX configuration of Cell 1 (and/or Cell 2) upon the C-DTX/DRX configuration being enabled/activated for Cell 1 (and/or Cell 2).

A wireless device, based on an example of FIG. 48, may start a full U-DRX on duration of a U-DRX cycle within a C-DTX/DRX on duration of a C-DTX/DRX cycle on a cell, due to a fixed time offset between the starting point of the U-DRX cycle and the starting point of the C-DTX/DRX cycle regardless on which cell the C-DTX/DRX is enabled/activated. The example may reduce power consumption of the wireless device and/or improve data transmission latency, in addition to network energy saving for the base station. The wireless device, based on examples of FIG. 47 and/or FIG. 48, may efficiently perform U-DRX and C-DTX on different cells. The examples may reduce power consumption of the wireless device and/or the base station.

A base station, in an existing LTM procedure (e.g., based on example described above with respect to FIG. 41), may request a L1/2 CSI report for a source cell and one or more candidate cells for early CSI report procedure to facilitate a LTM procedure, based on the example described above with respect to FIG. 41. The L1/2 CSI report may be requested by the base station in a MAC CE and/or a DCI. The wireless device, upon receiving the request, may send (e.g., transmit) the L1/2 CSI report comprising L1-RSRP report indicating at least one of the one or more candidate cells have a higher RSRP value than that of the source cell (or have a value an offset higher than a threshold), as described above with respect to FIG. 41.

In at least some technologies, an L1/2 CSI report request may be independently and/or separately indicated from a C-DTX/DRX enabling/disabling indication. Separating the L1/2 CSI report request indication and the C-DTX/DRX enabling/disabling indication may increase signaling overhead and power consumption of the wireless device to receive both indications. There is a need to jointly indicate a L1/2 CSI report request and a C-DTX/DRX enabling/disabling.

As described herein, a base station may send (e.g., transmit) and/or a wireless device may receive a MAC CE and/or a DCI comprising a first bit field indicating a cell configuration ID identifying a candidate cell (or a source cell) and a second bit field comprising a NES/non-NES state enabling/disabling bit. The second bit field may indicate a NES/non-NES state of the candidate cell identified by the cell configuration ID. The bit of the second bit field being set to a first value may indicate that the candidate cell is in (or switched to) the non-NES state (e.g., if the C-DTX/DRX is not configured/enabled on the candidate cell). The bit being set to a second value may indicate that the candidate cell is in (or switched to) the NES state (e.g., if the C-DTX/DRX is configured/enabled on the candidate cell). The cell configuration ID being set to a predefined value (e.g., 0) may indicate the source cell in which case, the second bit field indicates whether the source cell is in (or switched to) the NES state or in the non-NES state. The MAC CE and/or the DCI may comprise a L1 CSI report request for the LTM procedure.

As described herein, a base station may send (e.g., transmit) and/or a wireless device may receive a MAC CE and/or a DCI comprising a bitmap indicating an enabling/disabling NES/non-NES state for a plurality of candidate cells (and/or the source cell), each bit of the bitmap, corresponding to a respective cell of a plurality of candidate cells (and/or the source cell) configured for the LTM procedure. The association between a bit and a cell may be implicitly determined based on an order (ascending order or descending order) of the cell configuration IDs of the plurality of candidate cells (and/or the source cell). The first bit (e.g., the rightmost, or the leftmost) of the bitmap may correspond to the source cell, the second bit (e.g., the second rightmost, or the second leftmost) of the bit may correspond to the first candidate cell with the lowest cell configuration ID, the third bit may correspond to the second candidate cell with the second lowest cell configuration ID, etc. The MAC CE and/or the DCI may comprise a L1 CSI report request for the LTM procedure, in which case, each bit of the bitmap may correspond to a candidate cell (or the source cell) of a subset of the plurality of candidate cells configured for L1 CSI measurement, from the plurality of candidate cells configured for the LTM procedure.

FIG. 49A and FIG. 49B show examples of C-DTX/DRX enabling/disabling for a source cell and/or a candidate/neighbor cell for a HO/CHO/LTM procedure, based on examples described above with respect to FIG. 46, FIG. 47 and/or FIG. 48. A base station, in FIG. 49A, may send (e.g., transmit) to a wireless device a MAC CE/DCI indicating an enabling/activation of a C-DTX/DRX configuration (of a plurality of C-DTX/DRX configurations). The C-DTX/DRX configuration (and/or the plurality of C-DTX/DRX configurations) for a cell may be implemented based on examples described above with respect to FIG. 46, FIG. 47 and/or FIG. 48. Different cells may be configured with different C-DTX/DRX configurations.

MAC CE/DCI in the example of FIG. 49A may be sent (e.g., transmitted) with a MAC CE/DCI format indicating a NES state for a cell (e.g., a source cell, a PCell, a SCell, and/or a candidate cell for LTM procedure, etc.). The MAC CE/DCI format may comprise at least one of: a cell configuration ID which may identify the cell, a NES enabling/disabling (or activation/deactivation) bit indicating whether a NES operation (e.g., C-DTX/DRX operation, cell off operation, etc.) is enabled/activated on the cell. The MAC CE/DCI format may comprise a C-DTX/DRX pattern indication indicating a C-DTX/DRX pattern from a plurality of C-DTX/DRX patterns configured on the cell. The C-DTX/DRX pattern may be identified by a pattern ID and may be associated with a C-DTX/DRX cycle length, a starting indication of the C-DTX/DRX cycle length, a C-DTX/DRX on duration of the C-DTX/DRX cycle, a delay for starting a C-DTX/DRX on duration timer at the beginning of the C-DTX/DRX cycle, etc. The MAC CE/DCI format may comprise a time offset for enabling/disabling the C-DTX/DRX operation. The wireless device may enable/disable the C-DTX/DRX operation at an interval occurring at a quantity (e.g., number) of symbols/slots/subframes, indicated by the time offset, after the end of the slot where the MAC CE/DCI is received.

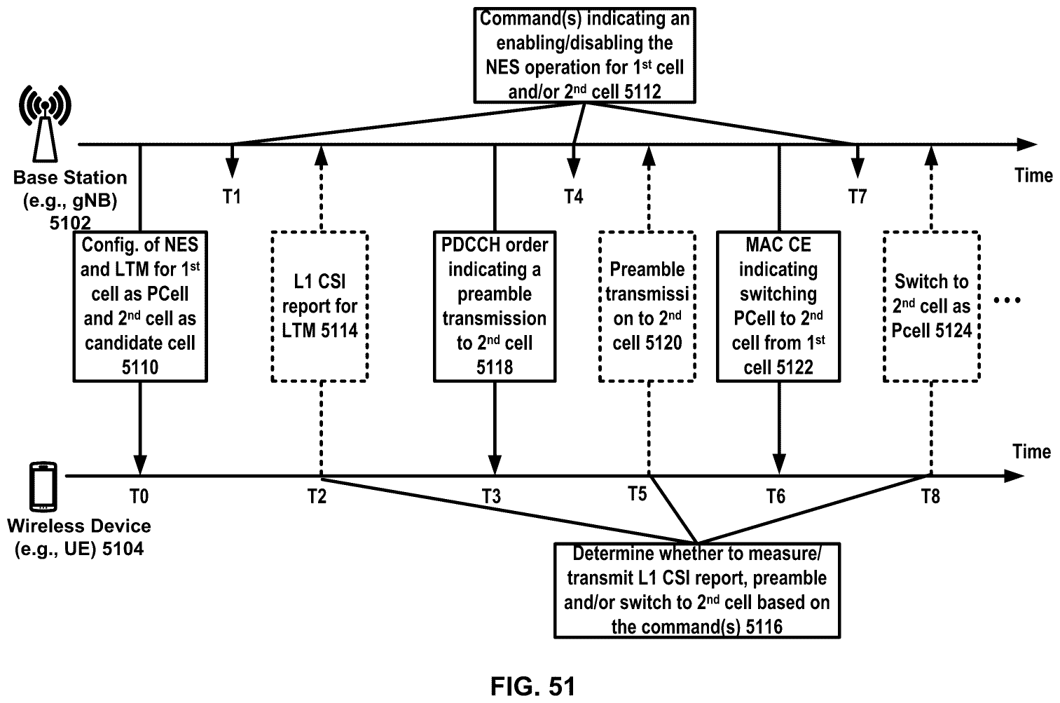

A wireless device, based on the example of FIG. 49A, by receiving a MAC CE/DCI indicating a NES state of a cell (e.g., a serving cell, a non-serving cell, etc.), may determine whether a cell is enabled/disabled with a C-DTX/DRX pattern and if the Cell is enabled/disabled with the C-DTX/DRX pattern. The wireless device, based on the determining, may correctly perform channel measurements (e.g., based on example embodiments of FIG. 51 which will be described later in this specification) for L3 cell/beam report (for HO/CHO), L1 CSI report (for carrier aggregation and/or a LTM procedure), may monitor PDCCHs, may send (e.g., transmit) uplink signals/channels and/or may receive downlink signals/channels via the cell.

A base station, by implementing example described above with respect to FIG. 49A, may enable/disable a NES state for a cell in a time. NES states may be enabled/disabled for multiple cells, for example, if multiple cells are configured (e.g., for carrier aggregation, for layer 3 HO/CHO, for layer 1/2 triggered mobility, etc.). FIG. 49B may show an example of enabling/disabling NES states for multiple cells.

The MAC CE/DCI format, in the example of FIG. 49B, may comprise a plurality of NES indications, wherein each NES indication may be associated with a corresponding cell of a plurality of cells. The plurality of cells may be configured for CA/DC operation, based on example described above with respect to FIG. 10A and/or FIG. 10B. The plurality of cells may be configured for HO/CHO/LTM procedure, based on examples described above with respect to FIG. 34, FIG. 37 and/or FIG. 39. The association between a NES indication of the plurality of NES indications and a cell of the plurality of cells may be implicitly determined based on an order (ascending order or descending order) of the cell configuration IDs of the plurality of cells.

A first NES indication (e.g., the rightmost, or the leftmost) of the plurality of NES indications may correspond to the first cell (e.g., a source cell for HO/CHO/LTM procedure, a PCell for CA configuration), the second NES indication (e.g., the second rightmost, or the second leftmost) of the plurality of NES indications may correspond to the first candidate cell with the lowest cell configuration ID for HO/CHO/LTM procedure, or the first (configured/activated) SCell with the lowest SCell index for CA/DC configuration, and the third NES indication may correspond to the second candidate cell with the second lowest cell configuration ID for HO/CHO/LTM procedure or the second (configured/activated) SCell with the second lowest SCell index for CA/DC configuration, etc.

Each NES indication may be a bit, wherein the plurality of NES indications may be a bitmap, and each bit may be associated with a corresponding cell of the plurality of cells configured above. The bit being set to a first value may indicate that a C-DTX/DRX configuration (configured on a corresponding cell) is enabled/activated on the cell. The bit being set to a second value may indicate that the C-DTX/DRX configuration is disabled/deactivated on the cell.

Each NES indication may comprise at least one of: a bit indicating whether a C-DTX/DRX operation is enabled/disabled on the corresponding cell, a C-DTX/DRX pattern indication (if multiple C-DTX/DRX patterns are configured on the cell), a time offset for enabling/disabling the C-DTX/DRX pattern on the cell, etc.

MAC CE/DCI, for a LTM procedure, indicating a NES state of a cell (a source cell and/or a neighbor cell), may be separately and/or independently sent (e.g., transmitted) by the base station from a second MAC CE/DCI triggering a L1/2 CSI report for the LTM procedure. The L1/2 CSI report for the LTM procedure may be implemented based on example embodiments described above with respect to FIG. 41.

MAC CE/DCI, for a LTM procedure, indicating a NES state of a cell (a source cell and/or a neighbor cell), may be sent (e.g., transmitted) by the base station jointly with a L1/2 CSI report request for the LTM procedure. The L1/2 CSI report for the LTM procedure may be implemented based on example described above with respect to FIG. 41.

MAC CE/DCI format may comprise a L1/2 CSI report request bitmap for the LTM procedure, in which case, each bit of the bitmap may correspond to a candidate cell of a plurality of candidate cells configured for L1 CSI measurement. A bit being set to a first value (e.g., 0) may indicate that the wireless device does not measure/report L1/2 CSI for a cell corresponding to the bit and/or a C-DTX/DRX operation is enabled/activated on the cell. A bit being set to a second value (e.g., 1) may indicate that the wireless device measure/report L1/2 CSI for the cell and the C-DTX/DRX operation is disabled/deactivated on the cell.

A first bit of the bitmap (for L1/2 CSI report request), e.g., the leftmost or the rightmost bit of the bitmap, may correspond to a source cell (or PCell). The first bit being set to a first value may indicate that the C-DTX/DRX operation is enabled/activated on the source cell and/or the wireless device does not measure/report L1/2 CSI for the source cell. The first bit being set to a second value may indicate that the C-DTX/DRX operation is disabled/deactivated on the source cell and/or the wireless device measures/report L1/2 CSI for the source cell.

A base station, based on examples of FIG. 49A and/or FIG. 49B, may dynamically control which cells (a source cell and/or one or more candidate cells) the wireless device may measure L1/2 CSI report for a LTM procedure based on dynamically enabling/disabling a C-DTX/DRX operations. The examples may reduce signaling overhead for the L1/2 CSI report request and C-DTX/DRX enabling/disabling indications. The examples may reduce power consumption of the wireless device for L1/2 CSI report for LTM procedure if a C-DTX/DRX configuration is enabled/disabled by a MAC CE/DCI.

Dynamic indication of enabling/disabling C-DTX/DRX operation on a candidate cell by a MAC CE and/or a DCI may require short latency of information exchange between a source cell and the candidate cell. This may be possible if the source cell and the candidate cell belong to the same DU of a CU. Dynamical indication of enabling/disabling C-DTX/DRX operation on the candidate cell may not be possible, for example, if the source cell and the candidate cell belong to different DUs of a CU, or different CUs. The indication of C-DTX/DRX enabling/disabling for a candidate cell may be via RRC message. The RRC messages configuring configuration parameters of a candidate cell (e.g., based on example embodiments described above respect to FIG. 41) may further comprise a parameter (e.g., a priority value, a C-DTX/DRX operation enabling/disabling indicator, etc.) indicating a NES/C-DTX/DRX enabling/disabling state for the candidate cell. The wireless device, based on the parameter associated with the candidate cell, may determine whether to measure L3 CSI/beam report and/or L1-CSI report, trigger wireless device-based TA measurement, etc., e.g., based on example of FIG. 51 which will be described later in this specification.

In at least some technologies, a wireless device may measure channel qualities of a source cell and one or more candidate cells for HO/CHO/LTM procedure, during which the base station may enable a NES operation (e.g., C-DTX/DRX etc.) on the source cell and/or the one or more candidate cells. The wireless device may incorrectly report channel qualities for a cell which may be enabled with the NES operation.

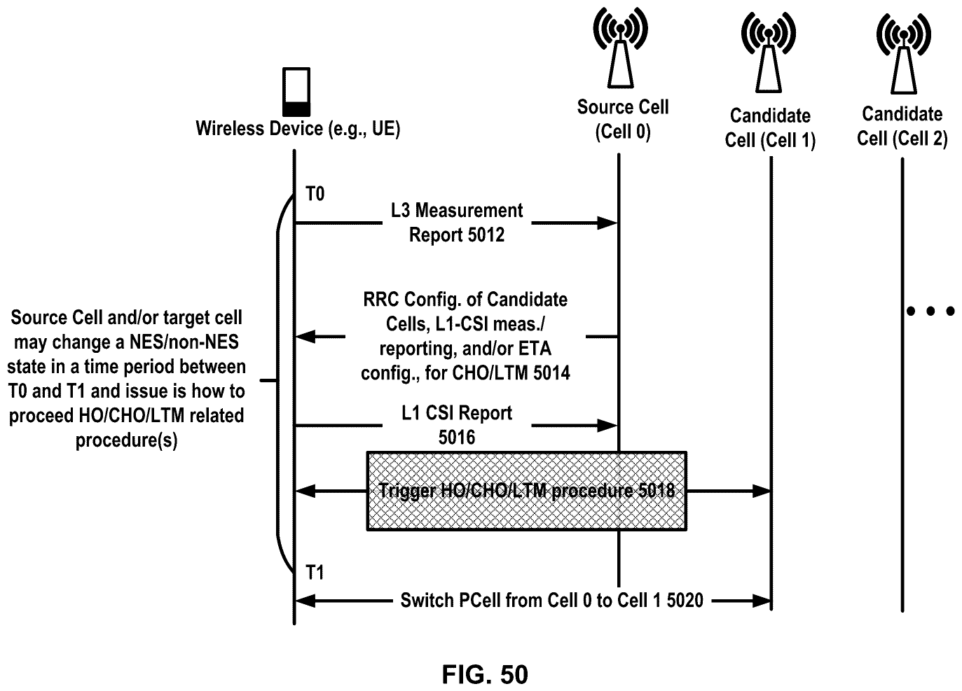

FIG. 50 shows an issue of HO/CHO/LTM procedure if a NES operation is enabled on a cell. As shown in FIG. 50, a wireless device, in an existing L3 based HO and/or CHO procedure (e.g., based on example embodiments described above with respect to FIG. 34 and/or FIG. 37), may send (e.g., transmit) L3 measurement report 5012 (e.g., L3 beam/cell report) to the base station. The L3 measurement report may comprise L3 RSRP/RSRQ/SINR report of one or more candidate cells configured for the HO/CHO procedure. The wireless device may obtain the L3 RSRP/RSRQ/SINR report based on filtering L1 RSRP/RSRQ/SINR values measured over SSBs of the one or more candidate cells. The L3 beam/cell report may indicate that the one or more candidate cells have better channel quality than the source cell.

A base station, similarly in an existing LTM procedure (e.g., based on the example described above with respect to FIG. 41), may request a L1/2 CSI report (e.g., by RRC Config. of Candidate Cells, L1-CSI meas./reporting, and/or ETA config., for CHO/LTM) 5014 for a source cell and one or more candidate cells for early CSI report procedure to facilitate a LTM procedure, based on the example described above with respect to FIG. 41. The L1/2 CSI report may be requested by the base station in a MAC CE and/or a DCI. The wireless device, upon receiving the request, may send (e.g., transmit) the L1/2 CSI report comprising L1-RSRP report 5016 indicating at least one of the one or more candidate cells have a higher RSRP value than that of the source cell (or have a value an offset higher than a threshold), as described above with respect to FIG. 41. In an example, instead of triggered by a L1/2 CSI report request from the base station, the wireless device may trigger a L1/2 CSI report based on a measurement event, e.g., based on example described above with respect to FIG. 41.

A cell (the source cell and/or the one or more candidate cells), as shown in FIG. 50, may be enabled with a C-DTX/DRX operation (or NES operation), wherein the enabling may be via an RRC message, a MAC CE and/or a DCI from the base station. The base station may enable the NES operation at any time between T0 and T1, during which, the wireless device may measure L3 beam/cell report for a candidate cell, measure L1 CSI report for the LTM procedure, trigger a HO/CHO/LTM procedure 5018, etc. The triggering the HO/CHO/LTM procedure may comprise evaluating RRC reconfiguration conditions for the CHO procedure, initiating RACH procedure towards the target cell, sending (e.g., transmitting) a preamble to the target cell based on (e.g., in response to) receiving a PDCCH order for ETA procedure, monitoring PDCCH for RAR, measuring TA of the target cell, starting/restarting a time alignment timer (TAT) associated with the target cell, switching PCell from Cell 0 to Cell 1, etc. The wireless device may not have the knowledge regarding if the source cell and/or the one or more candidate cells are enabled with the C-DTX/DRX operation (or NES operations) and what's the C-DTX/DRX pattern (e.g., a length of the C-DTX/DRX cycle, a starting point of the C-DTX/DRX cycle, a C-DTX/DRX on duration length of the C-DTX/DRX cycle, etc.). A cell, if enabled with the C-DTX/DRX operation, may not be suitable to be accessible by a new wireless device. The wireless device may be in the process of performing the HO/CHO/LTM procedure on the source cell and/or the candidate cells during which the NES/non-NES state may be changed on the source cell and/or the candidate cells. The wireless device, by implementing existing technologies, may have difficulties in determining how to proceed with the ongoing L3 beam/cell measurement, L1 CSI measurement/report, HO/CHO/LTM procedure, etc.

A wireless device, taking L1/2 CSI report for the LTM procedure as an example, may send (e.g., transmit) to the base station a L1/2 CSI report for a cell (either the source cell or the one or more candidate cells) while the cell may be enabled with the C-DTX/DRX cycle. The L1/2 CSI report comprising L1-RSRP report of a cell being enabled with C-DTX/DRX operation may be useless for the base station to make a decision (regarding which cell is the future target PCell for the LTM) for LTM process, since the cell being enabled with C-DTX/DRX operation is not supposed to be accessible by a new wireless device for the purpose of network energy saving. At least some technologies may waste transmission power of the wireless device for the L1/2 CSI report since a NES state of a cell (the source cell and/or the one or more candidate cells) is not available at the wireless device. There is a need to improve L1/2 CSI report for the LTM procedure if a NES operation is supported for the source cell and/or the one or more candidate cells.

A wireless device may skip/stop reporting L1/2 CSI (and/or L3 CSI/beam) for a candidate cell, even if L1-RSRP (and/or L3 CSI/beam) of the candidate cell is better than a serving cell or a configured threshold, based on (e.g., in response to) a NES/C-DTX/DRX operation being enabled/activated on the candidate cell. The wireless device may skip/stop measuring L1/2 CSI report (and/or L3 CSI/beam) for the candidate cell based on (e.g., in response to) the NES/C-DTX/DRX operation being enabled/activated on the candidate cell. The wireless device may stop/cancel a (wireless device-event) triggered CSI report for the candidate cell based on (e.g., in response to) the NES/C-DTX/DRX operation being enabled/activated on the candidate cell. The wireless device may start/resume measuring/reporting L1/2 CSI (and/or L3 CSI/beam) for the candidate cell based on (e.g., in response to) the NES/C-DTX/DRX operation being disabled/deactivated on the candidate cell. Examples described herein may resolve one or more of these and/or other problems. For example, skipping/stopping reporting L1/2 CSI (and/or L3 CSI/beam) for a candidate cell may conserve the transmission power of the wireless device.

A wireless device may send (e.g., transmit) a L1/2 CSI (and/or L3 CSI/beam) for a candidate cell (not enabled/activated with NES/C-DTX/DRX operation) with a L1-RSRP value (and/or L3 CSI/beam) greater than a first threshold, even if the L1-RSRP (and/or L3 CSI/beam) of the source cell is better than a second threshold and if the NES/C-DTX/DRX is enabled/activated on the source cell. The wireless device may trigger a L1/2 CSI (and/or L3 CSI/beam) measurement/reporting for a candidate cell based on (e.g., in response to) the NES/C-DTX/DRX operation being enabled/activated on a source cell.

A wireless device may measure a L1/2 CSI value (and/or L3 CSI/beam) for a candidate cell in a C-DTX/DRX off duration of a C-DTX/DRX cycle of a source cell and/or reporting the L1/2 CSI value (and/or L3 CSI/beam) for the candidate cell in a C-DTX/DRX on duration of the C-DTX/DRX cycle of the source cell. The wireless device may report a L1/2 CSI value (and/or L3 CSI/beam) for a candidate cell and/or a source PCell via a PUCCH SCell/sSCell if the source PCell is in a NES state (or if the L1/2 CSI report (and/or L3 CSI/beam) occasion is in a C-DTX/DRX off duration of a C-DTX/DRX cycle of the PCell).

A wireless device may stop/abort/cancel an ongoing LTM procedure (or HO/CHO procedure) for a candidate cell based on (e.g., in response to) a NES/C-DTX/DRX operation being enabled on the candidate cell. A wireless device may stop/abort/cancel a triggered wireless device-based TA measurement for a candidate cell based on (e.g., in response to) a NES/C-DTX/DRX operation being enabled on the candidate cell.

FIG. 51 shows an example of HO/CHO/LTM procedure with NES operation, based on examples described above with respect to FIG. 46, FIG. 47, FIG. 48, FIG. 49A and/or FIG. 49B. A base station (e.g., base station 5102 as shown in FIG. 51) may send (e.g., transmit) to a wireless device (e.g., wireless device 5104), at TO, configuration parameters of a NES operation 5110 (e.g., C-DTX/DRX operation based on examples described above with respect to FIG. 45, FIG. 46, FIG. 47 and/or FIG. 48). The configuration parameters may be comprised in one or more RRC messages. The one or more RRC messages may comprise configuration parameters of an LTM procedure on a source cell (e.g., 1st cell) and one or more candidate cells (e.g., 2nd cell). The configuration parameters of the LTM procedure may be implemented based on the example described above with respect to FIG. 41.

A wireless device, as shown in FIG. 51, may perform the LTM procedure after receiving the configuration parameters of the LTM procedure at TO, based on the example described above with respect to FIG. 41. The wireless device, by performing the LTM procedure, may perform at least one of: early CSI report for candidate cell(s) (e.g., measuring/sending/transmitting L1/2 CSI report 5114 for the candidate cell(s) at T2), early TA acquisition for the candidate cell(s) comprising receiving a PDCCH order 5118 (e.g., at T3) from 1st cell indicating to send (e.g., transmit) a preamble to 2nd cell, sending (e.g., transmitting) the preamble to 2nd cell 5120 and/or monitoring PDCCH for receiving a RAR for the preamble, receiving (e.g., at T6) an MAC CE 5122 indicating a PCell switching from 1st cell to 2nd cell, switching (e.g., at T8) the PCell from 1st cell to 2nd cell 5124. The measuring/sending/transmitting L1/2 CSI report for the candidate cell(s) may be triggered by receiving a L1/2 CSI report request from the base station and/or by a measurement event (without explicit triggering from the base station), e.g., based on example embodiments described above with respect to FIG. 41.

A base station, as shown in FIG. 51, may enable/activate a C-DTX/DRX operation on 1st cell and/or 2nd cell based on examples described above with respect to FIG. 46, FIG. 49A and/or FIG. 49B. The base station may enable/activate the C-DTX/DRX operation on 1st cell and/or 2nd cell e.g., at T1 which is after the one or more RRC messages 5112 are sent (e.g., transmitted) to the wireless device and the wireless device is in measuring L1/2 CSI report for 1st cell and/or 2nd cell.

A base station may enable/activate the C-DTX/DRX operation on 1st cell and/or 2nd cell e.g., at T4 which is after the PDCCH order is sent (e.g., transmitted) to the wireless device and before the wireless device sends (e.g., transmits) s the preamble to 2nd cell. The base station may enable/activate the C-DTX/DRX operation on 1st cell and/or 2nd cell e.g., at T7 which is after the MAC CE is sent (e.g., transmitted) to the wireless device and before the wireless device switch the PCell from 1st cell to 2nd cell. The C-DTX/DRX operation may be enabled/activated in a cell group common command, which may be applied for all wireless devices in RRC_CONNECTED state/mode. The cell group common command 5112 may be sent (e.g., transmitted) by the base station at T1, T4 and/or T7 as shown in FIG. 51.

A wireless device may receive the C-DTX/DRX enabling/disabling command at T1/T4/T7 during which the wireless device may be performing L1/2 CSI measurement/report (triggered by the base station and/or triggered by a measurement event) for 1st cell and/or 2nd cell for the LTM procedure 5116. The wireless device may determine that C-DTX/DRX operation is not enabled on 1st cell and 2nd cell before receiving the C-DTX/DRX enabling/disabling command at T1. The C-DTX/DRX enabling/disabling command at T1/T4/T7 may indicate a C-DTX/DRX operation is enabled on 1st cell and/or 2nd cell.

A wireless device, based on (e.g., in response to) receiving the C-DTX/DRX enabling/disabling command indicating that C-DTX/DRX is enabled on 2nd cell (and/or the C-DTX/DRX is disabled on 1st cell), may stop/skip measuring L1/2 CSI report for 2nd cell and/or may stop/skip reporting L1/2 CSI value(s) for 2nd cell. The wireless device may cancel/suspend the triggered L1/2 CSI measurement/report for 2nd cell, for example, if C-DTX/DRX is enabled on 2nd cell and/or if the L1/2 CSI report is triggered by a measurement event. Stopping measuring/reporting L1/2 CSI report for 2nd cell on which C-DTX/DRX is enabled may allow the wireless device to measure/report other candidate cells on which C-DTX/DRX is not enabled and/or may allow the base station not to use 2nd cell as the target cell for the LTM procedure. The wireless device may waste power for the measuring/reporting, for example, if the wireless device keeps measuring/reporting L1/2 CSI values for 2nd cell, because the 2nd cell is not supposed to be used as a target PCell if the 2nd cell is enabled with the C-DTX/DRX operation for network energy saving and/or if the L1/2 CSI measurement (e.g., L1-RSRP measured based on SSBs of 2nd cell) is greater than that of 1st cell or greater than a threshold. The operation by wireless device may reduce power consumption of the wireless device for L1/2 CSI measurement/reporting for a candidate cell if the candidate cell is enabled with a C-DTX/DRX operation.

A wireless device may receive a second command indicating that the C-DTX/DRX is disabled on 2nd cell. The wireless device, based on (e.g., in response to) receiving the second command indicating that the C-DTX/DRX is disabled on 2nd cell, may resume L1/2 CSI measurement/reporting for 2nd cell. The wireless device may restart/resume the triggered L1/2 CSI measurement/report for 2nd cell, for example, if C-DTX/DRX is disabled on 2nd cell and/or if the L1/2 CSI report is triggered by a measurement event.

A wireless device, based on (e.g., in response to) receiving the C-DTX/DRX enabling/disabling command indicating that C-DTX/DRX is enabled on 1st cell (and/or the C-DTX/DRX is disabled on 2nd cell), may stop measuring/reporting L1/2 CSI value for 1st cell and/or may measure/report L1/2 CSI value(s) for 2nd cell. The wireless device may report L1/2 CSI values for 2nd cell (if the L1-RSRP value measured on SSBs of 2nd cell is greater than a first threshold) and may not report L1/2 CSI values for 1st cell even if L1-RSRP value measured on SSBs of 1st cell is greater than that of 2nd cell or if L1-RSRP value of 1st cell is greater than a second threshold. The wireless device may allow quickly indicating/identifying a target cell for LTM procedure in case the source cell is switching to a NES state, instead of the wireless device, by implementing at least some technologies, prolonging the NES state transition of the source PCell, which may reduce energy efficiency of the base station.

A wireless device, based on (e.g., in response to) receiving the C-DTX/DRX enabling/disabling command indicating that C-DTX/DRX is enabled on 1st cell (and/or the C-DTX/DRX is disabled on 2nd cell), may (automatically) trigger a L1/2 CSI measurement/report for 2nd cell (and/or one or more candidate cells configured for the LTM procedure). The C-DTX/DRX enabling/disabling command may automatically trigger the L1/2 CSI measurement/report for candidate cell(s), different from receiving an explicit L1/2 CSI report request upon which the wireless device may trigger the L1/2 CSI measurement/report. The wireless device may wait for receiving the explicit L1/2 CSI report request to start the L1/2 CSI measurement/report after the wireless device receives the C-DTX/DRX enabling/disabling command, which may prolong the NES state transition of the base station and/or the LTM procedure.

A C-DTX/DRX operation may comprise a C-DTX on duration and a C-DTX off duration in a C-DTX/DRX cycle, based on examples described above with respect to FIG. 45, FIG. 47 and/or FIG. 48. A wireless device may stop measuring L1/2 CSI report for 1st cell in a C-DTX off duration of a C-DTX/DRX cycle of the C-DTX/DRX operation and/or may measure L1/2 CSI report for 2nd cell in the C-DTX off duration, for example, if the C-DTX/DRX operation is enabled/activated on 1st cell and/or the C-DTX/DRX operation is not enabled/activated on 2nd cell. Measuring L1/2 CSI report for 2nd cell in the C-DTX off duration of 1st cell may reduce connection interruption of the wireless device via 1st cell. A wireless device may be forced to temporarily break the connection with the base station via 1st cell for retuning RF chains to 2nd cell for the measurement, for example, if the wireless device measures L1/2 CSI report for 2nd cell in the C-DTX on duration of 1st cell.

A wireless device may report L1/2 CSI measurements for 1st cell and/or 2nd cell in a C-DTX on duration of a C-DTX cycle of 1st cell. The wireless device may stop reporting L1/2 CSI measurements for 1st cell and/or 2nd cell in a C-DTX off duration of a C-DTX cycle of 1st cell.

A wireless device may send (e.g., transmit) L1/2 CSI reports for 1st cell and/or 2nd cell via a PUCCH-SCell, or a PUCCH-sSCell (PUCCH switching SCell), for example, if the C-DTX/DRX operation is not enabled on the PUCCH-SCell and/or the PUCCH-sSCell, and/or if the C-DTX/DRX operation is enabled on 1st cell.

A wireless device, as shown in FIG. 51, may receive a C-DTX/DRX enabling/disabling (or NES enabling/disabling) command at T4, after the wireless device receives a PDCCH order indicating to send (e.g., transmit) a preamble to 2nd cell and before the wireless device starts to send (e.g., transmit) the preamble, wherein the C-DTX/DRX enabling/disabling command may indicate that C-DTX/DRX operation is enabled on 2nd cell and/or 1st cell. The PDCCH order may be implemented based on example described above with respect to FIG. 41. The wireless device, based on (e.g., in response to) the C-DTX/DRX operation being enabled on 2nd cell, may stop/skip sending (e.g., transmitting) the preamble to 2nd cell. The wireless device may cancel the RA procedure (e.g., complete the RA procedure without sending (e.g., transmitting) the preamble) triggered by the PDCCH order based on (e.g., in response to) the C-DTX/DRX operation (or NES operation) being enabled on 2nd cell. The C-DTX/DRX enabling/disabling (or NES enabling/disabling) command may be a LTM stop/abort command. The wireless device may stop/abort an ongoing LTM procedure for a target cell (e.g., early CSI report, early TA acquisition, MAC CE triggered PCell switching, etc.) based on (e.g., in response to) receiving the LTM stop/abort command (e.g., comprising a NES enabling or C-DTX/DRX enabling command indicating the NES/C-DTX/DRX operation is enabled on the target cell, etc.).

A wireless device may receive a C-DTX/DRX enabling/disabling (or NES enabling/disabling) command, for example, if the wireless device sends (e.g., transmits) s the preamble and before the wireless device receives a RAR corresponding to the preamble. The RAR may be received based on examples described above with respect to FIG. 13A, FIG. 13B and/or FIG. 13C. The wireless device may skip monitoring PDCCH (via 1st cell and/or 2nd cell) for the RAR corresponding to the preamble sent (e.g., transmitted) from the wireless device to 2nd cell, based on (e.g., in response to) the NES/C-DTX/DRX operation being enabled on 2nd cell (and/or 1st cell).

A wireless device, as shown in FIG. 51, may receive a C-DTX/DRX enabling/disabling (or NES enabling/disabling) command at T7, after the wireless device receives a MAC CE indicating to switch from 1st cell to 2nd cell as the PCell and before the wireless device starts the switching, wherein the C-DTX/DRX enabling/disabling command may indicate that C-DTX/DRX operation may be enabled on 2nd cell. The MAC CE may be implemented based on example described above with respect to FIG. 41. A wireless device, based on (e.g., in response to) the C-DTX/DRX operation being enabled on 2nd cell, may not switch from 1st cell to 2nd cell as the PCell. The wireless device may maintain 1st cell as the PCell.

A wireless device may trigger a wireless device-based TA measurement, instead of the early TA acquisition triggered by a PDCCH order sent (e.g., transmitted) by the base station (e.g., based on example embodiments described above with respect to FIG. 41). The wireless device, by implementing the wireless device-based TA measurement, may measure an arrival time difference between first SSB(s)/CSI-RS(s) sent (e.g., transmitted) from 1st cell and second SSB(s)/CSI-RS(s) sent (e.g., transmitted) from 2nd cell and determine an uplink transmission timing adjustment based on the arrival time difference. The wireless device may be performing the wireless device-based TA measurement during which the wireless device may receive a NES/C-DTX/DRX enabling/disabling command indicating that the NES/C-DTX/DRX operation is enabled on 2nd cell. The wireless device, based on (e.g., in response to) the NES/C-DTX/DRX operation being enabled on 2nd cell, may cancel/stop the wireless device-based TA measurement on 2nd cell. Cancelling/stopping the wireless device-based TA measurement for a C-DTX/DRX enabled candidate cell may improve power consumption of the wireless device for the TA measurement for a LTM procedure.

A wireless device may select a first candidate cell (which is not in NES state, or which is not configured/enabled with C-DTX/DRX operation), from a plurality of candidate cells, to perform a wireless device-based TA measurement for the first candidate cell. The wireless device may not select a second candidate cell which is in the NES state or which is configured/enabled with C-DTX/DRX operation, to perform a wireless device-based TA measurement for the second candidate cell. Selecting a C-DTX/DRX-disabled candidate cell for wireless device-based TA measurement may improve power consumption of the wireless device for the TA measurement for a LTM procedure.

A wireless device may determine whether to select the candidate cell to perform L3 beam/CSI measurement/report, perform wireless device-based TA measurement, etc, for example, if RRC messages configuring configuration parameters of a candidate cell (e.g., based on example embodiments described above respect to FIG. 41) comprises a parameter (e.g., a priority value, a C-DTX/DRX operation enabling/disabling indicator, etc.) indicating a NES/C-DTX/DRX enabling/disabling state for the candidate cell, as described above with respect to FIG. 49A and/or FIG. 49B. The wireless device, based on (e.g., in response to) the parameter indicating the NES/C-DTX/DRX is configured/enabled/activated on the candidate cell (e.g., a first priority value if the parameter is a priority, or a first value if the parameter is a bit indicating a NES/C-DTX/DRX enabling/disabling state, etc.), may skip/stop measuring/reporting CSI (L1/2/3) values (and/or triggering a wireless device-based TA measurement) for the candidate cell. The wireless device may select a candidate cell from a plurality of candidate cells for the CSI measurement/reporting (and/or a wireless device-based TA measurement) based on the parameter associated with the candidate cell indicating that the NES/C-DTX/DRX is not configured/enabled/activated on the candidate cell (e.g., a second priority value if the parameter is a priority, or a second value if the parameter is a bit indicating a NES/C-DTX/DRX enabling/disabling state, etc.).

A wireless device, according to examples described above with respect to FIG. 46, FIG. 47, FIG. 48, FIG. 49A, FIG. 49B and/or FIG. 51, may receive from a base station RRC messages comprising first parameters of a first cell and a second cell for a layer 1/2 triggered mobility (LTM) procedure, wherein the first cell is a serving primary cell (PCell) and the second cell is a candidate PCell and second parameters of a cell discontinuous transmission (C-DTX) operation. The wireless device may trigger a LTM procedure. The wireless device may receive a command indicating to enable the C-DTX operation for at least one of the first cell and the second cell. The wireless device may cancel the triggered LTM procedure based on (e.g., in response to) the enabling the C-DTX operation. The cancelling may comprise at least one of: stopping one or more timers associated with the LTM procedure, stopping sending (e.g., transmitting) a preamble for the second cell, stopping measuring timing advance (TA) for the second cell and/or stopping switching the PCell from the first cell to the second cell.

A base station, in a C-DTX off duration of the C-DTX operation, may stop a transmission of at least one of: SPS PDSCH, PDCCH scrambled by a wireless device specific RNTI, a PDCCH via a type 3 common search space, periodic or semi-persistent CSI-RSs and/or PRS. The base station, in a C-DTX on duration of the C-DTX operation, may send (e.g., transmit) at least one of: SPS PDSCH, a PDCCH scrambled by a wireless device specific RNTI, a PDCCH via a type 3 common search space, periodic or semi-persistent CSI-RSs and/or PRS. The base station, in a C-DTX off duration of the C-DTX operation, may stop receiving uplink signals. The uplink signals may comprise ate least one of: SR, Periodic/Semi-persistent CSI report, Periodic/Semi-persistent SRS and/or CG-PUSCH. The command may comprise at least one of: a MAC CE and/or a DCI.

One or more RRC messages may comprise configuration parameters of a search space for sending (e.g., transmitting) the DCI indicating to enable the C-DTX operation. In an example, the search space may be a type 0 common search space, wherein the configuration parameters may be comprised in master information block (MIB) message, wherein the base station may send (e.g., transmit) the MIB message via a physical broadcast channel (PBCH) and may indicate system information of the base station. The search space may be a type 0 common search space, wherein the configuration parameters may be comprised in system information block 1 (SIB1) message, wherein the base station may send (e.g., transmit) the SIB1 message, scheduled by a physical downlink control channel, indicating at least one of: information for evaluating if a wireless device is allowed to access a cell of the base station, information for scheduling of other system information, radio resource configuration information that is common for all wireless devices and barring information applied to access control. The search space may be a type 2 common search space, wherein the type 2 common search space may be further used for downlink paging message transmission. The search space may be a type 3 common search space, wherein the type 3 common search space may be further used for transmission, via a cell, of a second group common DCI with CRC bits scrambled by at least one of INT-RNTI, SFI-RNTI, CI-RNTI, TPC-PUSCH-RNTI, TPC-PUCCH-RNTI, TPC-SRS-RNTI. Based on (e.g., in response to) the cell being a primary cell of a plurality of cells of the base station, the type 3 common search space may be further used for transmission of a second DCI with CRC bits scrambled by at least one of: PS-RNTI, C-RNTI, MCS-C-RNTI and CS-RNTI.

Configuration parameters may comprise a radio network temporary identifier (RNTI) for a transmission of the DCI, wherein the DCI may be a group common DCI. The wireless device may receive the DCI based on cyclic redundancy check (CRC) bits of the DCI being scrambled by the RNTI. The DCI may have a same DCI format as a DCI format 1_0. The RNTI associated with the DCI may be different from a C-RNTI identifying a specific wireless device. The DCI may have the same DCI format as at least one of: DCI format 2_0/2_1/2_2/2_3/2_4 and/or DCI format 2_6. The RNTI associated with the DCI is different from a slot format indication RNTI (SFI-RNTI) associated with the DCI format 2_0, an interruption RNTI (INT_RNTI) associated with DCI format 2_1, a TPC-PUSCH-RNTI associated with a DCI format 2_2 for indication of transmission power control (TPC) commands for PUCCH and PUSCH, a TPC-PUCCH-RNTI associated with a DCI format 2_3 for indication of TPC commands for SRS transmissions, a cancellation RNTI (CI-RNTI) associated with the DCI format 2_4 and/or a power saving RNTI (PS-RNTI) associated with the DCI format 2_6.

Second parameters comprise at least one of: a time offset indicating a starting slot of a DTX period of the DTX, a length indication of a DTX on duration of the DTX period and/or a length indication of a DTX off duration of the DTX period. A wireless device may receive the CSI-RSs in a DTX on duration of the DTX period of the DTX. The wireless device may stop receiving the CSI-RSs in a DTX off duration of the DTX period of the DTX.

A wireless device, according to examples described above with respect to FIG. 46, FIG. 47, FIG. 48, FIG. 49A, FIG. 49B and/or FIG. 51, may trigger a channel state information (CSI) report procedure based on measuring reference signals (RSs) of a first cell and a second cell, wherein the first cell may be a source cell and the second cell may be a candidate cell. The wireless device may cancel, in a non-active time of a cell discontinuous transmission (C-DTX) period, the triggered CSI report procedure based on (e.g., in response to) determining that the C-DTX period is enabled. The cancelling may comprise at least one of: stopping measuring reference signals of the second cell based on (e.g., in response to) the second cell being in the C-DTX period; and/or stopping sending (e.g., transmitting) to the first cell, the CSI report of the second cell based on (e.g., in response to) the second cell being in the C-DTX period. Examples described herein may resolve one or more of these and/or other problems. For, example, cancelling the CS report for NES cell may reduce power consumption of the wireless device. Without cancelling the CSI report, the wireless device may continue the CSI report for the cell if the cell is switched to NES state, and the base station may not use the CSI report for the cell in the NES state.

Non-active time of the C-DTX period may be outside of a C-DTX active/on period of the C-DTX period. The non-active time of the C-DTX period may be an off duration of the C-DTX period.

CSI report comprises at least one of: a layer 3 CSI report and/or a layer 1 CSI report. A wireless device may trigger the CSI report for a layer 1/2 triggered mobility (LTM) procedure and/or a layer 3 handover procedure.

A wireless device, according to example described above with respect to FIG. 46, FIG. 47, FIG. 48, FIG. 49A, FIG. 49B and/or FIG. 51, may receive messages comprising first parameters of a first cell and a second cell for a layer 1/2 triggered mobility (LTM) procedure, wherein the first cell may be a serving primary cell (PCell) and the second cell may be a candidate PCell and second parameters of a cell discontinuous transmission (C-DTX) operation. The wireless device may trigger a layer 1 channel state information (CSI) report procedure for the LTM procedure based on measuring reference signals (RSs) of the first cell and the second cell. The wireless device may receive a command indicating to enable the C-DTX operation. The wireless device may cancel the triggered layer 1 CSI report procedure for the LTM procedure based on (e.g., in response to) enabling the C-DTX operation.

A wireless device, according to examples described above with respect to FIG. 46, FIG. 47, FIG. 48, FIG. 49A, FIG. 49B and/or FIG. 51, may receive first message comprising a wireless device capability request. The wireless device may send (e.g., transmit) second message comprising: first parameters indicating whether the wireless device supports a cell specific DTX/DRX configuration on a cell and second parameters indicating whether the wireless device supports a wireless device specific DRX configuration for a plurality of cells. The wireless device may receive, based on the second message, third message comprising: third parameters of a cell specific DTX/DRX configuration on a first cell and fourth parameters of a wireless device specific DRX configuration for the plurality of cells. The third message may comprise the third parameters based on (e.g., in response to) the wireless device supporting the cell specific DTX/DRX configuration. The third message may comprise the fourth parameters based on (e.g., in response to) the wireless device supporting the wireless device specific DRX configuration. The first parameters may be indicated per cell, per cell group, per frequency range, per frequency band, and/or per frequency band combination.

A wireless device may perform a method comprising multiple operations. The wireless device may receive a first message comprising a request associated with a wireless device capability. The wireless device may send a second message indicating a capability of the wireless device, wherein the second message may comprises: a first parameter indicating whether the wireless device supports a cell discontinuous transmission (DTX) configuration by radio resource control (RRC) messaging; and a second parameter indicating whether the wireless device supports an activation of the cell DTX configuration by downlink control information (DCI). The wireless device may receive an RRC message comprising configuration parameters of the cell DTX configuration. The wireless device may receive the DCI indicating activation of the cell DTX configuration. The wireless device may receive at least one third message comprising: third parameters of a first cell and a second cell associated with a layer 1/2 triggered mobility (LTM) procedure, wherein the first cell may be a serving primary cell (PCell) and the second cell is a candidate PCell; and fourth parameters of a cell DTX operation; may trigger, based on receiving the at least one third message, the LTM procedure; may receive a command indicating to enable the cell DTX operation associated with at least one of: the first cell; or the second cell; and may cancel, based on the enabling the cell DTX operation, the LTM procedure. The wireless device may trigger a channel state information (CSI) report procedure based on measurements of at least one reference signal of a first cell and at least one reference signal of a second cell, wherein the first cell may be a source cell and the second cell may be a candidate cell; and may cancel, in a non-active time of a cell DTX period and based the cell DTX period being enabled, the triggered CSI report procedure. The wireless device may, based on the DCI indicating activation of the cell DTX configuration, initiate a network energy saving (NES) operation, wherein the second message may further comprise: an indication of a second capability of the wireless device; wherein the second capability may be associated with a power saving operation of the wireless device; and a third parameter may indicate whether the wireless device supports a wireless device-specific discontinuous reception (DRX) configuration for a plurality of cells; wherein: the RRC message may further comprise a wireless device-specific discontinuous reception (DRX) configuration for the plurality of cells; wherein: the configuration parameters of the cell DTX configuration may comprise at least one parameter indicating that the cell DTX configuration may be at least one of: activated by DCI; or deactivated by DCI; wherein: the DCI indicating activation may be a group common DCI addressed to a plurality of wireless devices comprising the wireless device; wherein: the RRC message may further comprise an index of a search space for the DCI associated with the activation of the cell DTX configuration; wherein the RRC message may further comprise a radio network temporary identifier (RNTI) for the DCI associated with the activation of the cell DTX configuration; wherein the configuration parameters of the cell DTX configuration may comprise at least one of: a length of the cell DTX active time period of a cell DTX cycle; a value of a periodicity of the cell DTX cycle; or a starting offset of the cell DTX cycle; wherein the first parameters may be indicated per cell, per cell group, per frequency range, per frequency band, and/or per frequency band combination; wherein the search space may be a type 3 common search space. The wireless device may, based on activating the cell DTX configuration, receive downlink signals in a cell DTX active time period of the cell DTX configuration; and may stop receiving the downlink signals in a cell DTX inactive time period of the cell DTX configuration, wherein the downlink signals may comprise at least one of: periodic channel state information reference signals (CSI-RSs); physical downlink shared channels (PDSCHs); and physical downlink control channels (PDCCHs); wherein in a C-DTX off duration of the C-DTX operation, the wireless device may stop a receiving of at least one of: semi-persistent scheduling (SPS) PDSCH; a physical downlink control channel (PDCCH) scrambled by a wireless device specific RNTI; a PDCCH via a type 3 common search space; periodic or semi-persistent CSI-RSs; and PRS; wherein in a C-DTX on duration of the C-DTX operation, the wireless device may send at least one of: SPS PDSCH; a PDCCH scrambled by a wireless device specific RNTI; a PDCCH via a type 3 common search space; periodic or semi-persistent CSI-RSs; and PRS; wherein the uplink signals may comprise ate least one of: SR; Periodic/Semi-persistent CSI report; Periodic/Semi-persistent SRS; and CG-PUSCH; wherein the command may comprise at least one of: a MAC CE; and a DCI; wherein the search space may be a type 2 common search space, wherein the type 2 common search space may further be used for downlink paging message transmission; wherein the search space may be a type 3 common search space, wherein the type 3 common search space may be further used for transmission, via a cell, of a second group common DCI with CRC bits scrambled by at least one of: INT-RNTI; SFI-RNTI; CI-RNTI; TPC-PUSCH-RNTI; TPC-PUCCH-RNTI; and TPC-SRS-RNTI; wherein based on the cell being a primary cell of a plurality of cells of the base station, the type 3 common search space may be further used for transmission of a second group common DCI with CRC bits scrambled by at least one of: PS-RNTI; C-RNTI; MCS-C-RNTI; and CS-RNTI; wherein the configuration parameters may comprise a radio network temporary identifier (RNTI) for a transmission of the DCI, wherein the DCI may be a group common DCI; wherein the wireless device may receive the DCI based on cyclic redundancy check (CRC) bits of the DCI being scrambled by the RNTI; wherein the DCI may have a same DCI format as a DCI format 1_0; wherein the RNTI associated with the DCI may be different from a C-RNTI identifying a specific wireless device; wherein the DCI may have a same DCI format as at least one of: DCI format 2_0; DCI format 2_1; DCI format 2_2; DCI format 2_3; DCI format 2_4; and DCI format 2_6; wherein the RNTI associated with the DCI may be different from: a slot format indication RNTI (SFI-RNTI) associated with the DCI format 2_0; an interruption RNTI (INT_RNTI) associated with DCI format 2_1; a TPC-PUSCH-RNTI associated with a DCI format 2_2 for indication of transmission power control (TPC) commands for PUCCH and PUSCH; a TPC-PUCCH-RNTI associated with a DCI format 2_3 for indication of TPC commands for SRS transmissions; and a cancellation RNTI (CI-RNTI) associated with the DCI format 2_4; and a power saving RNTI (PS-RNTI) associated with the DCI format 2_6; wherein the second parameters may comprise at least one of: a time offset indicating a starting slot of a DTX period of the DTX; a length indication of a DTX on duration of the DTX period; and a length indication of a DTX off duration of the DTX period; wherein the wireless device may receive the CSI-RSs in a DTX on duration of the DTX period of the DTX; and may stop receiving the CSI-RSs in a DTX off duration of the DTX period of the DTX. The wireless device may receive a first command enabling the DTX of the cell, wherein the command may comprise at least one of: a medium access control element (MAC CE); and a downlink control information (DCI). The wireless device may receive a second command indicating the DRX for the wireless device, wherein the second command may comprise at least one of: a MAC CE; and a DCI; wherein the CSI report may comprise at least one of: a layer 3 CSI report; and a layer 1 CSI report; wherein the wireless device may trigger the CSI report: for a layer 1/2 triggered mobility (LTM) procedure; and for a layer 3 handover procedure. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, a message comprising a request associated with a wireless device capability. A computer-readable medium storing instructions that, when executed, cause performance of the described method, additional operations and/or include the additional elements.

A base station may perform a method comprising multiple operations. The base station may send a first message comprising a request associated with a wireless device capability; may receive a second message indicating a capability of a wireless device, wherein the second message may comprises: a first parameter indicating whether the wireless device supports a cell discontinuous transmission (DTX) configuration by radio resource control (RRC) messaging; and a second parameter indicating whether the wireless device supports an activation of the cell DTX configuration by downlink control information (DCI). The base station may send an RRC message comprising configuration parameters of the cell DTX configuration; may send the DCI indicating activation of the cell DTX configuration. The base station may, based on the DCI indicating activation of the cell DTX configuration, initiate a network energy saving (NES) operation, wherein the second message may further comprise: an indication of a second capability of the wireless device, wherein the second capability may be associated with a power saving operation of the wireless device; and a third parameter indicating whether the wireless device supports a wireless device-specific discontinuous reception (DRX) configuration for a plurality of cells; wherein: the RRC message may further comprise a wireless device-specific discontinuous reception (DRX) configuration for the plurality of cells; wherein: the configuration parameters of the cell DTX configuration may comprise at least one parameter indicating that the cell DTX configuration may be at least one of: activated by DCI; or deactivated by DCI; wherein: the DCI indicating activation may be a group common DCI addressed to a plurality of wireless devices comprising the wireless device; wherein: the RRC message may further comprise an index of a search space for the DCI associated with the activation of the cell DTX configuration; wherein the RRC message may further comprise a radio network temporary identifier (RNTI) for the DCI associated with the activation of the cell DTX configuration; wherein the configuration parameters of the cell DTX configuration may comprise at least one of: a length of the cell DTX active time period of a cell DTX cycle; a value of a periodicity of the cell DTX cycle; or a starting offset of the cell DTX cycle; wherein the first parameters may be indicated per cell, per cell group, per frequency range, per frequency band, and/or per frequency band combination; wherein the search space may be a type 3 common search space. The base station may, based on activating the cell DTX configuration, send downlink signals in a cell DTX active time period of the cell DTX configuration; and may stop sending the downlink signals in a cell DTX inactive time period of the cell DTX configuration, wherein the downlink signals may comprise at least one of: periodic channel state information reference signals (CSI-RSs); physical downlink shared channels (PDSCHs); and physical downlink control channels (PDCCHs); wherein in a C-DTX off duration of the C-DTX operation, the base station may stop sending of at least one of: semi-persistent scheduling (SPS) PDSCH; a physical downlink control channel (PDCCH) scrambled by a wireless device specific RNTI; a PDCCH via a type 3 common search space; periodic or semi-persistent CSI-RSs; and PRS; wherein in a C-DTX on duration of the C-DTX operation, the base station may receive at least one of: SPS PDSCH; a PDCCH scrambled by a wireless device specific RNTI; a PDCCH via a type 3 common search space; periodic or semi-persistent CSI-RSs; and PRS; wherein the uplink signals may comprise ate least one of: SR; Periodic/Semi-persistent CSI report; Periodic/Semi-persistent SRS; and CG-PUSCH; wherein the command may comprise at least one of: a MAC CE; and a DCI; wherein the search space may be a type 2 common search space, wherein the type 2 common search space may further be used for downlink paging message transmission; wherein the search space may be a type 3 common search space, wherein the type 3 common search space may be further used for transmission, via a cell, of a second group common DCI with CRC bits scrambled by at least one of: INT-RNTI; SFI-RNTI; CI-RNTI; TPC-PUSCH-RNTI; TPC-PUCCH-RNTI; and TPC-SRS-RNTI; wherein based on the cell being a primary cell of a plurality of cells of the base station, the type 3 common search space may be further used for transmission of a second group common DCI with CRC bits scrambled by at least one of: PS-RNTI; C-RNTI; MCS-C-RNTI; and CS-RNTI; wherein the configuration parameters may comprise a radio network temporary identifier (RNTI) for a transmission of the DCI, wherein the DCI may be a group common DCI; wherein the wireless device may receive the DCI based on cyclic redundancy check (CRC) bits of the DCI being scrambled by the RNTI; wherein the DCI may have a same DCI format as a DCI format 1_0; wherein the RNTI associated with the DCI may be different from a C-RNTI identifying a specific wireless device; wherein the DCI may have a same DCI format as at least one of: DCI format 2_0; DCI format 2_1; DCI format 2_2; DCI format 2_3; DCI format 2_4; and DCI format 2_6; wherein the RNTI associated with the DCI may be different from: a slot format indication RNTI (SFI-RNTI) associated with the DCI format 2_0; an interruption RNTI (INT_RNTI) associated with DCI format 2_1; a TPC-PUSCH-RNTI associated with a DCI format 2_2 for indication of transmission power control (TPC) commands for PUCCH and PUSCH; a TPC-PUCCH-RNTI associated with a DCI format 2_3 for indication of TPC commands for SRS transmissions; and a cancellation RNTI (CI-RNTI) associated with the DCI format 2_4; and a power saving RNTI (PS-RNTI) associated with the DCI format 2_6; wherein the second parameters may comprise at least one of: a time offset indicating a starting slot of a DTX period of the DTX; a length indication of a DTX on duration of the DTX period; and a length indication of a DTX off duration of the DTX period; wherein the base station may send the CSI-RSs in a DTX on duration of the DTX period of the DTX; and may stop receiving the CSI-RSs in a DTX off duration of the DTX period of the DTX. The base station may send a first command enabling the DTX of the cell, wherein the command may comprise at least one of: a medium access control element (MAC CE); and a downlink control information (DCI). The base station may send a second command indicating the DRX for the wireless device, wherein the second command may comprise at least one of: a MAC CE; and a DCI; wherein the CSI report may comprise at least one of: a layer 3 CSI report; and a layer 1 CSI report. A computing device may comprise: one or more processors; and memory storing instructions that, when executed by the one or more processors, cause the computing device to perform the described method, additional operations and/or include the additional elements. A system comprising: a base station configured to perform the described method, additional operations and/or include the additional elements; and a wireless device configured to receive, from the base station, a message comprising a request associated with a wireless device capability. A computer-readable medium storing instructions that, when executed, cause performance of the described method, additional operations and/or include the additional elements.

A wireless device may perform a method comprising multiple operations. The wireless device may receive at least one message comprising: first parameters of a first cell and a second cell associated with a layer 1/2 triggered mobility (LTM) procedure, wherein the first cell may be a serving primary cell (PCell) and the second cell is a candidate PCell; and second parameters of a cell discontinuous transmission (DTX) operation. The wireless device may trigger, based on receiving the at least one message, the LTM procedure; may receive a command indicating to enable the cell DTX operation associated with at least one of: the first cell; or the second cell; may cancel, based on the enabling the cell DTX operation, the LTM procedure. The wireless device may receive a first message comprising a request associated with a wireless device capability; may send a second message indicating a capability of the wireless device, wherein the second message may comprise: a third parameter indicating whether the wireless device supports a cell DTX configuration by radio resource control (RRC) messaging; and a fourth parameter indicating whether the wireless device supports an activation of the cell DTX configuration by downlink control information (DCI); may receive an RRC message comprising configuration parameters of the cell DTX configuration; and may receive the DCI indicating activation of the cell DTX configuration, wherein: the at least one message may comprise configuration parameters of a search space for sending downlink control information (DCI) indicating to enable the cell DTX operation; the search space may be a type 0 common search space; the configuration parameters may be comprised in a master information block (MIB) message; and the wireless device may receive the MIB message via a physical broadcast channel (PBCH), wherein the MIB may indicate system information of a base station. The wireless device may stop sending uplink signals in a cell DTX off duration of the cell DTX operation, wherein: the at least one message may comprise configuration parameters of a search space for sending downlink control information (DCI) indicating to enable the cell DTX operation; the search space may be a type 0 common search space; the configuration parameters may be comprised in a system information block 1 (SIB1) message; and the wireless device may receive the SIB1 message, wherein the SIB 1 message may be scheduled by a physical downlink control channel and may indicate at least one of: information for evaluating whether the wireless device is allowed to access a cell of a base station; information for scheduling of system information; radio resource configuration information that may be common for a plurality of wireless devices; or barring information applied to access control, wherein the first parameters may be indicated per cell, per cell group, per frequency range, per frequency band, and/or per frequency band combination; wherein the search space may be a type 3 common search space. The wireless device may, based on activating the cell DTX configuration, receive downlink signals in a cell DTX active time period of the cell DTX configuration; and may stop receiving the downlink signals in a cell DTX inactive time period of the cell DTX configuration, wherein the downlink signals may comprise at least one of: periodic channel state information reference signals (CSI-RSs); physical downlink shared channels (PDSCHs); and physical downlink control channels (PDCCHs); wherein in a C-DTX off duration of the C-DTX operation, the wireless device may stop a receiving of at least one of: semi-persistent scheduling (SPS) PDSCH; a physical downlink control channel (PDCCH) scrambled by a wireless device specific RNTI; a PDCCH via a type 3 common search space; periodic or semi-persistent CSI-RSs; and PRS; wherein in a C-DTX on duration of the C-DTX operation, the wireless device may send at least one of: SPS PDSCH; a PDCCH scrambled by a wireless device specific RNTI; a PDCCH via a type 3 common search space; periodic or semi-persistent CSI-RSs; and PRS; wherein the uplink signals may comprise ate least one of: SR; Periodic/Semi-persistent CSI report; Periodic/Semi-persistent SRS; and CG-PUSCH; wherein the command may comprise at least one of: a MAC CE; and a DCI; wherein the search space may be a type 2 common search space, wherein the type 2 common search space may further be used for downlink paging message transmission; wherein the search space may be a type 3 common search space, wherein the type 3 common search space may be further used for transmission, via a cell, of a second group common DCI with CRC bits scrambled by at least one of: INT-RNTI; SFI-RNTI; CI-RNTI; TPC-PUSCH-RNTI; TPC-PUCCH-RNTI; and TPC-SRS-RNTI; wherein based on the cell being a primary cell of a plurality of cells of the base station, the type 3 common search space may be further used for transmission of a second group common DCI with CRC bits scrambled by at least one of: PS-RNTI; C-RNTI; MCS-C-RNTI; and CS-RNTI; wherein the configuration parameters may comprise a radio network temporary identifier (RNTI) for a transmission of the DCI, wherein the DCI may be a group common DCI; wherein the wireless device may receive the DCI based on cyclic redundancy check (CRC) bits of the DCI being scrambled by the RNTI; wherein the DCI may have a same DCI format as a DCI format 1_0; wherein the RNTI associated with the DCI may be different from a C-RNTI identifying a specific wireless device; wherein the DCI may have a same DCI format as at least one of: DCI format 2_0; DCI format 2_1; DCI format 2_2; DCI format 2_3; DCI format 2_4; and DCI format 2_6; wherein the RNTI associated with the DCI may be different from: a slot format indication RNTI (SFI-RNTI) associated with the DCI format 2_0; an interruption RNTI (INT_RNTI) associated with DCI format 2_1; a TPC-PUSCH-RNTI associated with a DCI format 2_2 for indication of transmission power control (TPC) commands for PUCCH and PUSCH; a TPC-PUCCH-RNTI associated with a DCI format 2_3 for indication of TPC commands for SRS transmissions; and a cancellation RNTI (CI-RNTI) associated with the DCI format 2_4; and a power saving RNTI (PS-RNTI) associated with the DCI format 2_6; wherein the second parameters may comprise at least one of: a time offset indicating a starting slot of a DTX period of the DTX; a length indication of a DTX on duration of the DTX period; and a length indication of a DTX off duration of the DTX period; wherein the wireless device may receive the CSI-RSs in a DTX on duration of the DTX period of the DTX; and may stop receiving the CSI-RSs in a DTX off duration of the DTX period of the DTX. The wireless device may receive a first command enabling the DTX of the cell, wherein the command may comprise at least one of: a medium access control element (MAC CE); and a downlink control information (DCI). The wireless device may receive a second command indicating the DRX for the wireless device, wherein the second command may comprise at least one of: a MAC CE; and a DCI; wherein the CSI report may comprise at least one of: a layer 3 CSI report; and a layer 1 CSI report; wherein the wireless device may trigger the CSI report: for a layer 1/2 triggered mobility (LTM) procedure; and for a layer 3 handover procedure. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, a message comprising a request associated with a wireless device capability. A computer-readable medium storing instructions that, when executed, cause performance of the described method, additional operations and/or include the additional elements.

A base station may perform a method comprising multiple operations. The base station may send at least one message comprising: first parameters of a first cell and a second cell associated with a layer 1/2 triggered mobility (LTM) procedure, wherein the first cell may be a serving primary cell (PCell) and the second cell may be a candidate PCell; second parameters of a cell discontinuous transmission (DTX) operation; and wherein, the at least one message may trigger the LTM procedure. The base station may send a command indicating to enable the cell DTX operation associated with at least one of: the first cell; or the second cell; and wherein, the cell DTX operation may trigger cancelling the LTM procedure, wherein cancelling the LTM procedure may further comprise at least one of: stopping one or more timers associated with the LTM procedure; stopping sending a preamble for the second cell; may stop measuring timing advance for the second cell; or may stop switching the PCell from the first cell to the second cell, wherein the first parameters may be indicated per cell, per cell group, per frequency range, per frequency band, and/or per frequency band combination; wherein the search space may be a type 3 common search space. The base station may, based on activating the cell DTX configuration, send downlink signals in a cell DTX active time period of the cell DTX configuration; and may stop sending the downlink signals in a cell DTX inactive time period of the cell DTX configuration, wherein the downlink signals may comprise at least one of: periodic channel state information reference signals (CSI-RSs); physical downlink shared channels (PDSCHs); and physical downlink control channels (PDCCHs); wherein in a C-DTX off duration of the C-DTX operation, the base station may stop sending of at least one of: semi-persistent scheduling (SPS) PDSCH; a physical downlink control channel (PDCCH) scrambled by a wireless device specific RNTI; a PDCCH via a type 3 common search space; periodic or semi-persistent CSI-RSs; and PRS; wherein in a C-DTX on duration of the C-DTX operation, the base station may receive at least one of: SPS PDSCH; a PDCCH scrambled by a wireless device specific RNTI; a PDCCH via a type 3 common search space; periodic or semi-persistent CSI-RSs; and PRS; wherein the uplink signals may comprise ate least one of: SR; Periodic/Semi-persistent CSI report; Periodic/Semi-persistent SRS; and CG-PUSCH; wherein the command may comprise at least one of: a MAC CE; and a DCI; wherein the search space may be a type 2 common search space, wherein the type 2 common search space may further be used for downlink paging message transmission; wherein the search space may be a type 3 common search space, wherein the type 3 common search space may be further used for transmission, via a cell, of a second group common DCI with CRC bits scrambled by at least one of: INT-RNTI; SFI-RNTI; CI-RNTI; TPC-PUSCH-RNTI; TPC-PUCCH-RNTI; and TPC-SRS-RNTI; wherein based on the cell being a primary cell of a plurality of cells of the base station, the type 3 common search space may be further used for transmission of a second group common DCI with CRC bits scrambled by at least one of: PS-RNTI; C-RNTI; MCS-C-RNTI; and CS-RNTI; wherein the configuration parameters may comprise a radio network temporary identifier (RNTI) for a transmission of the DCI, wherein the DCI may be a group common DCI; wherein the wireless device may receive the DCI based on cyclic redundancy check (CRC) bits of the DCI being scrambled by the RNTI; wherein the DCI may have a same DCI format as a DCI format 1_0; wherein the RNTI associated with the DCI may be different from a C-RNTI identifying a specific wireless device; wherein the DCI may have a same DCI format as at least one of: DCI format 2_0; DCI format 2_1; DCI format 2_2; DCI format 2_3; DCI format 2_4; and DCI format 2_6; wherein the RNTI associated with the DCI may be different from: a slot format indication RNTI (SFI-RNTI) associated with the DCI format 2_0; an interruption RNTI (INT_RNTI) associated with DCI format 2_1; a TPC-PUSCH-RNTI associated with a DCI format 2_2 for indication of transmission power control (TPC) commands for PUCCH and PUSCH; a TPC-PUCCH-RNTI associated with a DCI format 2_3 for indication of TPC commands for SRS transmissions; and a cancellation RNTI (CI-RNTI) associated with the DCI format 2_4; and a power saving RNTI (PS-RNTI) associated with the DCI format 2_6; wherein the second parameters may comprise at least one of: a time offset indicating a starting slot of a DTX period of the DTX; a length indication of a DTX on duration of the DTX period; and a length indication of a DTX off duration of the DTX period; wherein the base station may send the CSI-RSs in a DTX on duration of the DTX period of the DTX; and may stop receiving the CSI-RSs in a DTX off duration of the DTX period of the DTX. The base station may send a first command enabling the DTX of the cell, wherein the command may comprise at least one of: a medium access control element (MAC CE); and a downlink control information (DCI). The base station may send a second command indicating the DRX for the wireless device, wherein the second command may comprise at least one of: a MAC CE; and a DCI; wherein the CSI report may comprise at least one of: a layer 3 CSI report; and a layer 1 CSI report. A computing device may comprise: one or more processors; and memory storing instructions that, when executed by the one or more processors, cause the computing device to perform the described method, additional operations and/or include the additional elements. A system comprising: a base station configured to perform the described method, additional operations and/or include the additional elements; and a wireless device configured to receive, from the base station, a message comprising a request associated with a wireless device capability. A computer-readable medium storing instructions that, when executed, cause performance of the described method, additional operations and/or include the additional elements.

A wireless device may perform a method comprising multiple operations. The wireless device may receive one or more radio resource control (RRC) messages comprising configuration parameters of a cell discontinuous transmission (DTX) configuration of a cell, wherein the configuration parameters may comprise a parameter indicating that the cell DTX configuration may be activated/deactivated by a downlink control information (DCI). The wireless device may receive, based on the parameter, the DCI comprising a field indicating an activation of the cell DTX configuration for the cell. The wireless device may, based on the activation of the cell DTX configuration, receive downlink signals via the cell during a cell DTX active period of a cell DTX cycle according to the cell DTX configuration; and may stop receiving the downlink signals via the cell during a cell DTX non-active period of the cell DTX cycle, wherein the first parameters may be indicated per cell, per cell group, per frequency range, per frequency band, and/or per frequency band combination; wherein the search space may be a type 3 common search space. The wireless device may, based on activating the cell DTX configuration, receive downlink signals in a cell DTX active time period of the cell DTX configuration; and may stop receiving the downlink signals in a cell DTX inactive time period of the cell DTX configuration, wherein the downlink signals may comprise at least one of: periodic channel state information reference signals (CSI-RSs); physical downlink shared channels (PDSCHs); and physical downlink control channels (PDCCHs); wherein in a C-DTX off duration of the C-DTX operation, the wireless device may stop a receiving of at least one of: semi-persistent scheduling (SPS) PDSCH; a physical downlink control channel (PDCCH) scrambled by a wireless device specific RNTI; a PDCCH via a type 3 common search space; periodic or semi-persistent CSI-RSs; and PRS; wherein in a C-DTX on duration of the C-DTX operation, the wireless device may send at least one of: SPS PDSCH; a PDCCH scrambled by a wireless device specific RNTI; a PDCCH via a type 3 common search space; periodic or semi-persistent CSI-RSs; and PRS; wherein the uplink signals may comprise ate least one of: SR; Periodic/Semi-persistent CSI report; Periodic/Semi-persistent SRS; and CG-PUSCH; wherein the command may comprise at least one of: a MAC CE; and a DCI; wherein the search space may be a type 2 common search space, wherein the type 2 common search space may further be used for downlink paging message transmission; wherein the search space may be a type 3 common search space, wherein the type 3 common search space may be further used for transmission, via a cell, of a second group common DCI with CRC bits scrambled by at least one of: INT-RNTI; SFI-RNTI; CI-RNTI; TPC-PUSCH-RNTI; TPC-PUCCH-RNTI; and TPC-SRS-RNTI; wherein based on the cell being a primary cell of a plurality of cells of the base station, the type 3 common search space may be further used for transmission of a second group common DCI with CRC bits scrambled by at least one of: PS-RNTI; C-RNTI; MCS-C-RNTI; and CS-RNTI; wherein the configuration parameters may comprise a radio network temporary identifier (RNTI) for a transmission of the DCI, wherein the DCI may be a group common DCI; wherein the wireless device may receive the DCI based on cyclic redundancy check (CRC) bits of the DCI being scrambled by the RNTI; wherein the DCI may have a same DCI format as a DCI format 1_0; wherein the RNTI associated with the DCI may be different from a C-RNTI identifying a specific wireless device; wherein the DCI may have a same DCI format as at least one of: DCI format 2_0; DCI format 2_1; DCI format 2_2; DCI format 2_3; DCI format 2_4; and DCI format 2_6; wherein the RNTI associated with the DCI may be different from: a slot format indication RNTI (SFI-RNTI) associated with the DCI format 2_0; an interruption RNTI (INT_RNTI) associated with DCI format 2_1; a TPC-PUSCH-RNTI associated with a DCI format 2_2 for indication of transmission power control (TPC) commands for PUCCH and PUSCH; a TPC-PUCCH-RNTI associated with a DCI format 2_3 for indication of TPC commands for SRS transmissions; and a cancellation RNTI (CI-RNTI) associated with the DCI format 2_4; and a power saving RNTI (PS-RNTI) associated with the DCI format 2_6; wherein the second parameters may comprise at least one of: a time offset indicating a starting slot of a DTX period of the DTX; a length indication of a DTX on duration of the DTX period; and a length indication of a DTX off duration of the DTX period; wherein the wireless device may receive the CSI-RSs in a DTX on duration of the DTX period of the DTX; and may stop receiving the CSI-RSs in a DTX off duration of the DTX period of the DTX. The wireless device may receive a first command enabling the DTX of the cell, wherein the command may comprise at least one of: a medium access control element (MAC CE); and a downlink control information (DCI). The wireless device may receive a second command indicating the DRX for the wireless device, wherein the second command may comprise at least one of: a MAC CE; and a DCI; wherein the CSI report may comprise at least one of: a layer 3 CSI report; and a layer 1 CSI report; wherein the wireless device may trigger the CSI report: for a layer 1/2 triggered mobility (LTM) procedure; and for a layer 3 handover procedure. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, a message comprising a request associated with a wireless device capability. A computer-readable medium storing instructions that, when executed, cause performance of the described method, additional operations and/or include the additional elements.

A wireless device may perform a method comprising multiple operations. The wireless device may trigger a channel state information (CSI) report procedure based on measurements of at least one reference signal of a first cell and at least one reference signal of a second cell, wherein the first cell may be a source cell and the second cell may be a candidate cell. The wireless device may cancel, in a non-active time of a cell discontinuous transmission (DTX) period and based on the cell DTX period being enabled, the triggered CSI report procedure. The wireless device may receive a first message comprising a request associated with a wireless device capability; may send a second message indicating a capability of the wireless device, wherein the second message may comprise: a first parameter indicating whether the wireless device supports a cell DTX configuration by radio resource control (RRC) messaging; and a second parameter indicating whether the wireless device supports an activation of the cell DTX configuration by downlink control information (DCI); may receive an RRC message comprising configuration parameters of the cell DTX configuration; and may receive the DCI indicating activation of the cell DTX configuration, wherein the cancelling may comprise at least one of: stopping, based on the second cell being in the cell DTX period, measurement of reference signals of the second cell; or stopping, based on the second cell being in the cell DTX period, transmission to the first cell the CSI report of the second cell; wherein the non-active time of the cell DTX period may be an off duration of the cell DTX period, wherein the first parameters may be indicated per cell, per cell group, per frequency range, per frequency band, and/or per frequency band combination; wherein the search space may be a type 3 common search space. The wireless device may, based on activating the cell DTX configuration, receive downlink signals in a cell DTX active time period of the cell DTX configuration; and may stop receiving the downlink signals in a cell DTX inactive time period of the cell DTX configuration, wherein the downlink signals may comprise at least one of: periodic channel state information reference signals (CSI-RSs); physical downlink shared channels (PDSCHs); and physical downlink control channels (PDCCHs); wherein in a C-DTX off duration of the C-DTX operation, the wireless device may stop a receiving of at least one of: semi-persistent scheduling (SPS) PDSCH; a physical downlink control channel (PDCCH) scrambled by a wireless device specific RNTI; a PDCCH via a type 3 common search space; periodic or semi-persistent CSI-RSs; and PRS; wherein in a C-DTX on duration of the C-DTX operation, the wireless device may send at least one of: SPS PDSCH; a PDCCH scrambled by a wireless device specific RNTI; a PDCCH via a type 3 common search space; periodic or semi-persistent CSI-RSs; and PRS; wherein the uplink signals may comprise ate least one of: SR; Periodic/Semi-persistent CSI report; Periodic/Semi-persistent SRS; and CG-PUSCH; wherein the command may comprise at least one of: a MAC CE; and a DCI; wherein the search space may be a type 2 common search space, wherein the type 2 common search space may further be used for downlink paging message transmission; wherein the search space may be a type 3 common search space, wherein the type 3 common search space may be further used for transmission, via a cell, of a second group common DCI with CRC bits scrambled by at least one of: INT-RNTI; SFI-RNTI; CI-RNTI; TPC-PUSCH-RNTI; TPC-PUCCH-RNTI; and TPC-SRS-RNTI; wherein based on the cell being a primary cell of a plurality of cells of the base station, the type 3 common search space may be further used for transmission of a second group common DCI with CRC bits scrambled by at least one of: PS-RNTI; C-RNTI; MCS-C-RNTI; and CS-RNTI; wherein the configuration parameters may comprise a radio network temporary identifier (RNTI) for a transmission of the DCI, wherein the DCI may be a group common DCI; wherein the wireless device may receive the DCI based on cyclic redundancy check (CRC) bits of the DCI being scrambled by the RNTI; wherein the DCI may have a same DCI format as a DCI format 1_0; wherein the RNTI associated with the DCI may be different from a C-RNTI identifying a specific wireless device; wherein the DCI may have a same DCI format as at least one of: DCI format 2_0; DCI format 2_1; DCI format 2_2; DCI format 2_3; DCI format 2_4; and DCI format 2_6; wherein the RNTI associated with the DCI may be different from: a slot format indication RNTI (SFI-RNTI) associated with the DCI format 2_0; an interruption RNTI (INT_RNTI) associated with DCI format 2_1; a TPC-PUSCH-RNTI associated with a DCI format 2_2 for indication of transmission power control (TPC) commands for PUCCH and PUSCH; a TPC-PUCCH-RNTI associated with a DCI format 2_3 for indication of TPC commands for SRS transmissions; and a cancellation RNTI (CI-RNTI) associated with the DCI format 2_4; and a power saving RNTI (PS-RNTI) associated with the DCI format 2_6; wherein the second parameters may comprise at least one of: a time offset indicating a starting slot of a DTX period of the DTX; a length indication of a DTX on duration of the DTX period; and a length indication of a DTX off duration of the DTX period; wherein the wireless device may receive the CSI-RSs in a DTX on duration of the DTX period of the DTX; and may stop receiving the CSI-RSs in a DTX off duration of the DTX period of the DTX. The wireless device may receive a first command enabling the DTX of the cell, wherein the command may comprise at least one of: a medium access control element (MAC CE); and a downlink control information (DCI). The wireless device may receive a second command indicating the DRX for the wireless device, wherein the second command may comprise at least one of: a MAC CE; and a DCI; wherein the CSI report may comprise at least one of: a layer 3 CSI report; and a layer 1 CSI report; wherein the wireless device may trigger the CSI report: for a layer 1/2 triggered mobility (LTM) procedure; and for a layer 3 handover procedure. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, a message comprising a request associated with a wireless device capability. A computer-readable medium storing instructions that, when executed, cause performance of the described method, additional operations and/or include the additional elements.

A wireless device may perform a method comprising multiple operations. The wireless device may trigger a channel state information (CSI) report procedure based on measurements of at least one reference signal of a first cell and at least one reference signal of a second cell, wherein the first cell may be a source cell and the second cell may be a candidate cell; and may cancel, in a non-active time of a cell discontinuous transmission (DTX) period and based on the cell DTX period being enabled, the triggered CSI report procedure. The wireless device may receive a first message comprising a request associated with a wireless device capability; may send a second message indicating a capability of the wireless device, wherein the second message may comprises: a first parameter indicating whether the wireless device supports a cell DTX configuration by radio resource control (RRC) messaging; and a second parameter indicating whether the wireless device supports an activation of the cell DTX configuration by downlink control information (DCI); may receive an RRC message comprising configuration parameters of the cell DTX configuration; and may receive the DCI indicating activation of the cell DTX configuration, wherein the cancelling may comprise at least one of: stopping, based on the second cell being in the cell DTX period, measurement of reference signals of the second cell; or stopping, based on the second cell being in the cell DTX period, transmission to the first cell the CSI report of the second cell, wherein the non-active time of the cell DTX period may be an off duration of the cell DTX period; wherein the first parameters may be indicated per cell, per cell group, per frequency range, per frequency band, and/or per frequency band combination; wherein the search space may be a type 3 common search space. The wireless device may, based on activating the cell DTX configuration, receive downlink signals in a cell DTX active time period of the cell DTX configuration; and may stop receiving the downlink signals in a cell DTX inactive time period of the cell DTX configuration, wherein the downlink signals may comprise at least one of: periodic channel state information reference signals (CSI-RSs); physical downlink shared channels (PDSCHs); and physical downlink control channels (PDCCHs); wherein in a C-DTX off duration of the C-DTX operation, the wireless device may stop a receiving of at least one of: semi-persistent scheduling (SPS) PDSCH; a physical downlink control channel (PDCCH) scrambled by a wireless device specific RNTI; a PDCCH via a type 3 common search space; periodic or semi-persistent CSI-RSs; and PRS; wherein in a C-DTX on duration of the C-DTX operation, the wireless device may send at least one of: SPS PDSCH; a PDCCH scrambled by a wireless device specific RNTI; a PDCCH via a type 3 common search space; periodic or semi-persistent CSI-RSs; and PRS; wherein the uplink signals may comprise ate least one of: SR; Periodic/Semi-persistent CSI report; Periodic/Semi-persistent SRS; and CG-PUSCH; wherein the command may comprise at least one of: a MAC CE; and a DCI; wherein the search space may be a type 2 common search space, wherein the type 2 common search space may further be used for downlink paging message transmission; wherein the search space may be a type 3 common search space, wherein the type 3 common search space may be further used for transmission, via a cell, of a second group common DCI with CRC bits scrambled by at least one of: INT-RNTI; SFI-RNTI; CI-RNTI; TPC-PUSCH-RNTI; TPC-PUCCH-RNTI; and TPC-SRS-RNTI; wherein based on the cell being a primary cell of a plurality of cells of the base station, the type 3 common search space may be further used for transmission of a second group common DCI with CRC bits scrambled by at least one of: PS-RNTI; C-RNTI; MCS-C-RNTI; and CS-RNTI; wherein the configuration parameters may comprise a radio network temporary identifier (RNTI) for a transmission of the DCI, wherein the DCI may be a group common DCI; wherein the wireless device may receive the DCI based on cyclic redundancy check (CRC) bits of the DCI being scrambled by the RNTI; wherein the DCI may have a same DCI format as a DCI format 1_0; wherein the RNTI associated with the DCI may be different from a C-RNTI identifying a specific wireless device; wherein the DCI may have a same DCI format as at least one of: DCI format 2_0; DCI format 2_1; DCI format 2_2; DCI format 2_3; DCI format 2_4; and DCI format 2_6; wherein the RNTI associated with the DCI may be different from: a slot format indication RNTI (SFI-RNTI) associated with the DCI format 2_0; an interruption RNTI (INT_RNTI) associated with DCI format 2_1; a TPC-PUSCH-RNTI associated with a DCI format 2_2 for indication of transmission power control (TPC) commands for PUCCH and PUSCH; a TPC-PUCCH-RNTI associated with a DCI format 2_3 for indication of TPC commands for SRS transmissions; and a cancellation RNTI (CI-RNTI) associated with the DCI format 2_4; and a power saving RNTI (PS-RNTI) associated with the DCI format 2_6; wherein the second parameters may comprise at least one of: a time offset indicating a starting slot of a DTX period of the DTX; a length indication of a DTX on duration of the DTX period; and a length indication of a DTX off duration of the DTX period; wherein the wireless device may receive the CSI-RSs in a DTX on duration of the DTX period of the DTX; and may stop receiving the CSI-RSs in a DTX off duration of the DTX period of the DTX. The wireless device may receive a first command enabling the DTX of the cell, wherein the command may comprise at least one of: a medium access control element (MAC CE); and a downlink control information (DCI). The wireless device may receive a second command indicating the DRX for the wireless device, wherein the second command may comprise at least one of: a MAC CE; and a DCI; wherein the CSI report may comprise at least one of: a layer 3 CSI report; and a layer 1 CSI report; wherein the wireless device may trigger the CSI report: for a layer 1/2 triggered mobility (LTM) procedure; and for a layer 3 handover procedure. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, a message comprising a request associated with a wireless device capability. A computer-readable medium storing instructions that, when executed, cause performance of the described method, additional operations and/or include the additional elements.

One or more of the operations described herein may be conditional. For example, one or more operations may be performed if certain criteria are met, such as in a wireless device, a base station, a radio environment, a network, a combination of the above, and/or the like. Example criteria may be based on one or more conditions such as wireless device and/or network node configurations, traffic load, initial system set up, packet sizes, traffic characteristics, a combination of the above, and/or the like. If the one or more criteria are met, various examples may be used. It may be possible to implement any portion of the examples described herein in any order and based on any condition.

A base station may communicate with one or more of wireless devices. Wireless devices and/or base stations may support multiple technologies, and/or multiple releases of the same technology. Wireless devices may have some specific capability (ies) depending on wireless device category and/or capability (ies). A base station may comprise multiple sectors, cells, and/or portions of transmission entities. A base station communicating with a plurality of wireless devices may refer to a base station communicating with a subset of the total wireless devices in a coverage area. Wireless devices referred to herein may correspond to a plurality of wireless devices compatible with a given LTE, 5G, 6G, or other 3GPP or non-3GPP release with a given capability and in a given sector of a base station. A plurality of wireless devices may refer to a selected plurality of wireless devices, a subset of total wireless devices in a coverage area, and/or any group of wireless devices. Such devices may operate, function, and/or perform based on or according to drawings and/or descriptions herein, and/or the like. There may be a plurality of base stations and/or a plurality of wireless devices in a coverage area that may not comply with the disclosed methods, for example, because those wireless devices and/or base stations may perform based on older releases of LTE, 5G, 6G, or other 3GPP or non-3GPP technology.

One or more parameters, fields, and/or Information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, 6G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
receiving, by a wireless device, a first message comprising a request associated with a wireless device capability;
sending a second message indicating a capability of the wireless device, wherein the second message comprises:
a first parameter indicating whether the wireless device supports a cell discontinuous transmission (DTX) configuration by radio resource control (RRC) messaging; and
a second parameter indicating whether the wireless device supports an activation of the cell DTX configuration by downlink control information (DCI);
receiving an RRC message comprising configuration parameters of the cell DTX configuration; and
receiving the DCI indicating activation of the cell DTX configuration.

2. The method of claim 1, further comprising:
receiving, by the wireless device, at least one third message comprising:
third parameters of a first cell and a second cell associated with a layer 1/2 triggered mobility (LTM) procedure, wherein the first cell is a serving primary cell (PCell) and the second cell is a candidate PCell; and
fourth parameters of a cell DTX operation;
triggering, based on receiving the at least one third message, the LTM procedure;
receiving a command indicating to enable the cell DTX operation associated with at least one of:
the first cell; or
the second cell; and
cancelling, based on the enabling the cell DTX operation, the LTM procedure.

3. The method of claim 1, comprising:
triggering, by the wireless device, a channel state information (CSI) report procedure based on measurements of at least one reference signal of a first cell and at least one reference signal of a second cell, wherein the first cell is a source cell and the second cell is a candidate cell; and
cancelling, in a non-active time of a cell DTX period and based on the cell DTX period being enabled, the triggered CSI report procedure.

4. The method of claim 1, further comprising: based on the DCI indicating activation of the cell DTX configuration, initiating a network energy saving (NES) operation.

5. The method of claim 1, wherein the second message further comprises:
an indication of a second capability of the wireless device, wherein the second capability is associated with a power saving operation of the wireless device; and
a third parameter indicating whether the wireless device supports a wireless device-specific discontinuous reception (DRX) configuration for a plurality of cells.

6. The method of claim 1, wherein:
the RRC message further comprises a wireless device-specific discontinuous reception (DRX) configuration for the plurality of cells.

7. The method of claim 1, wherein: the configuration parameters of the cell DTX configuration comprise at least one parameter indicating that the cell DTX configuration is at least one of:
activated by DCI; or
deactivated by DCI.

8. The method of claim 1, wherein:
the RRC message further comprises an index of a search space for the DCI associated with the activation of the cell DTX configuration.

9. The method of claim 1, wherein the RRC message further comprises a radio network temporary identifier (RNTI) for the DCI associated with the activation of the cell DTX configuration.

10. The method of claim 1, wherein the configuration parameters of the cell DTX configuration comprise at least one of:
a length of the cell DTX active time period of a cell DTX cycle;
a value of a periodicity of the cell DTX cycle; or
a starting offset of the cell DTX cycle.

11. A method comprising:
receiving, by a wireless device, at least one message comprising:
first parameters of a first cell and a second cell associated with a layer 1/2 triggered mobility (LTM) procedure, wherein the first cell is a serving primary cell (PCell) and the second cell is a candidate PCell; and
second parameters of a cell discontinuous transmission (DTX) operation;
triggering, based on receiving the at least one message, the LTM procedure;
receiving a command indicating to enable the cell DTX operation associated with at least one of:
the first cell; or
the second cell; and
cancelling, based on the enabling the cell DTX operation, the LTM procedure.

12. The method of claim 11, further comprising:
receiving, by the wireless device, a first message comprising a request associated with a wireless device capability;
sending a second message indicating a capability of the wireless device, wherein the second message comprises:
a third parameter indicating whether the wireless device supports a cell DTX configuration by radio resource control (RRC) messaging; and
a fourth parameter indicating whether the wireless device supports an activation of the cell DTX configuration by downlink control information (DCI);
receiving an RRC message comprising configuration parameters of the cell DTX configuration; and
receiving the DCI indicating activation of the cell DTX configuration.

13. The method of claim 11, wherein cancelling the LTM procedure further comprises at least one of:
stopping one or more timers associated with the LTM procedure;
stopping sending a preamble for the second cell;
stopping measuring timing advance for the second cell; or
stopping switching the PCell from the first cell to the second cell.

14. The method of claim 11, further comprising stopping sending uplink signals in a cell DTX off duration of the cell DTX operation.

15. The method of claim 11, wherein:
the at least one message comprises configuration parameters of a search space for sending downlink control information (DCI) indicating to enable the cell DTX operation;
the search space is a type 0 common search space;
the configuration parameters is comprised in a master information block (MIB) message; and
the method further comprises receiving the MIB message via a physical broadcast channel (PBCH), wherein the MIB indicates system information of a base station.

16. The method of claim 11, wherein:
the at least one message comprises configuration parameters of a search space for sending downlink control information (DCI) indicating to enable the cell DTX operation;
the search space is a type 0 common search space;
the configuration parameters is comprised in a system information block 1 (SIB1) message; and
the method further comprises receiving the SIB1 message, wherein the SIB 1 message is scheduled by a physical downlink control channel and indicates at least one of:
information for evaluating whether the wireless device is allowed to access a cell of a base station;
information for scheduling of system information;
radio resource configuration information that is common for a plurality of wireless devices; or
barring information applied to access control.

17. A method comprising:
triggering, by a wireless device, a channel state information (CSI) report procedure based on measurements of at least one reference signal of a first cell and at least one reference signal of a second cell, wherein the first cell is a source cell and the second cell is a candidate cell; and
cancelling, in a non-active time of a cell discontinuous transmission (DTX) period and based on the cell DTX period being enabled, the triggered CSI report procedure.

18. The method of claim 17, further comprising:
receiving, by the wireless device, a first message comprising a request associated with a wireless device capability;
sending a second message indicating a capability of the wireless device, wherein the second message comprises:
a first parameter indicating whether the wireless device supports a cell DTX configuration by radio resource control (RRC) messaging; and
a second parameter indicating whether the wireless device supports an activation of the cell DTX configuration by downlink control information (DCI);
receiving an RRC message comprising configuration parameters of the cell DTX configuration; and
receiving the DCI indicating activation of the cell DTX configuration.

19. The method of claim 17, wherein the cancelling comprises at least one of:
Stopping, based on the second cell being in the cell DTX period, measurement of reference signals of the second cell; or
stopping, based on the second cell being in the cell DTX period, transmission to the first cell the CSI report of the second cell.

20. The method of claim 17, wherein the non-active time of the cell DTX period is an off duration of the cell DTX period.
